(19) United States
(12) Patent Application Publication
(10) Pub. No.: US 2024/0408495 A1
(43) Pub. Date: Dec. 12, 2024

(54) NON-TRANSITORY COMPUTER READABLE MEDIUM, INFORMATION PROCESSING METHOD, GAME DEVICE, AND INFORMATION PROCESSING SYSTEM

(71) Applicant: CYGAMES, INC., Tokyo (JP)

(72) Inventors: Toshiyuki Hibi, Tokyo (JP); Tomoatsu Miyazaki, Tokyo (JP)

(73) Assignee: CYGAMES, INC., Tokyo (JP)

(21) Appl. No.: 18/809,969

(22) Filed: Aug. 20, 2024

Related U.S. Application Data
(63) Continuation of application No. PCT/JP2023/005295, filed on Feb. 15, 2023.

(30) Foreign Application Priority Data
Feb. 22, 2022 (JP) 2022-025479

(51) Int. Cl. A63F 13/58; A63F 13/825

(52) U.S. Cl. CPC A63F 13/58; A63F 13/825

(57) ABSTRACT

A non-transitory computer readable medium stores a program causing a computer to execute: processing for determining whether or not a preset specific condition is satisfied in a prescribed game; processing for setting an action parameter for a character among a plurality of action parameters, each of the plurality of action parameters serving as a parameter for determining autonomous operation of the character, a first action parameter being set for the character among the plurality of action parameters in the case where the specific condition is not satisfied, and a second action parameter associated with the first action parameter being set for the character among the plurality of action parameters in the case where the specific condition is satisfied; and processing for controlling the operation of the character in the prescribed game on the basis of the action parameter set for the character.

### CROSS REFERENCE TO RELATED APPLICATIONS

This application is a continuation application of International Application No. PCT/JP2023/005295, filed on Feb. 15, 2023, which claims priority to Japanese Patent Application No. 2022-025479, filed on Feb. 22, 2022, the entire contents of which are incorporated by reference herein.

### BACKGROUND ART

### Technical Field

The present invention relates to information processing programs, information processing methods, game devices, and information processing systems.

There is a genre of games that have hitherto been known, called nurturing games, as disclosed, for example, in Patent Literature 1. In a nurturing game, a plurality of kinds of nurturing items are provided, and a player can nurture a character to be nurtured while selecting one of the nurturing items. The player can play various kinds of games by using the character nurtured in the nurturing game.

Furthermore, there are cases where a character or the like nurtured by a player acts autonomously in action games, sports games, horseracing games, etc.

### CITATION LIST

### Patent Literature

Patent Literature 1: JP 2021-164725 A

### SUMMARY OF INVENTION

### Technical Problem

In the case where a character performs actions autonomously, as described above, the character is controlled on the basis of parameters that have been set. At this time, there is a problem in that the fun of the game is compromised if the number of action patterns of each character is small.

It is an object of the present invention to provide an information processing program, an information processing method, a game device, and an information processing system that make it possible to enhance the fun of a game.

### Solution to Problem

In order to solve the problem described above, an information processing program causes a computer to carry out: processing for determining whether or not a preset specific condition is satisfied in a prescribed game; processing for setting a first action parameter for a character among action parameters in the case where the specific condition is not satisfied, the action parameters serving as parameters for determining autonomous operation of the character, and for setting a second action parameter associated with the first action parameter for the character in the case where the specific condition is satisfied; and processing for controlling the operation of the character in the prescribed game on the basis of the action parameter set for the character.

The second action parameter may be managed in association with the first action parameter.

The arrangement may be as follows:
the character has set therefor a special operation pattern that can be invoked in the prescribed game; and
in the processing for controlling the operation of the character,
the special operation pattern set for the character is invoked in the case where an invocation condition is satisfied, and
the special operation pattern that can be invoked is shared between the case where the second action parameter is set for the character and the case where the first action parameter is set for the character.

The information processing program may further cause the computer to carry out: processing for making it possible to identify the set second action pattern in the prescribed game in the case where the second action parameter is set for the character.

The arrangement may be as follows:
a plurality of action parameters each serving as the first action parameter are provided;
the program further causes the computer to carry out processing for displaying selecting parts individually corresponding to the plurality of first action parameters so as to allow a player to select one of the selecting parts;
the processing for setting the action parameter for the character includes processing for setting, for the character, the first action parameter corresponding to the selecting part selected by the player; and
in the processing for allowing the player to select the selecting parts,
the selecting part corresponding to the first action parameter is changed to the selecting part corresponding to the second action parameter in the case where the specific condition is satisfied.

The arrangement may be as follows:
the information processing program further causes the computer to carry out processing for executing a nurturing game of nurturing a nurturing subject character while changing an ability parameter of the nurturing subject character on the basis of an operation by a player, and processing for storing the nurturing subject character that has been nurtured in the nurturing game as a nurturing-complete character;
the processing for storing the nurturing-complete character includes processing for associating specific information with the nurturing-complete character in the case where a prescribed acquisition condition is satisfied in the nurturing game;
the character that operates in the prescribed game includes the nurturing-complete character; and
in the processing for determining whether or not the specific condition is satisfied,
it is determined that the specific condition is satisfied in the case where the specific information is associated with the nurturing-complete character.

The arrangement may be as follows:
the processing for storing the nurturing-complete character includes processing for associating factor information with the nurturing-complete character, the factor information being different from the specific information; and
the processing for executing the nurturing game includes processing for setting the nurturing-complete character as a character to inherit, and processing for changing the ability parameter of the nurturing subject character in the nurturing game on the basis of the factor information associated with the character to inherit.

In order to solve the problem described above, an information processing method is an information processing method that is carried out by one or more computers,
wherein the computers carry out: processing for determining whether or not a preset specific condition is satisfied in a prescribed game; processing for setting a first action parameter for a character among action parameters in the case where the specific condition is not satisfied, the action parameters serving as parameters for determining autonomous operation of the character, and for setting a second action parameter associated with the first action parameter for the character in the case where the specific condition is satisfied; and processing for controlling the operation of the character in the prescribed game on the basis of the action parameter set for the character.

In order to solve the problem described above, in a game device, one or more computers carry out: processing for determining whether or not a preset specific condition is satisfied in a prescribed game; processing for setting a first action parameter for a character among action parameters in the case where the specific condition is not satisfied, the action parameters serving as parameters for determining autonomous operation of the character, and for setting a second action parameter associated with the first action parameter for the character in the case where the specific condition is satisfied; and processing for controlling the operation of the character in the prescribed game on the basis of the action parameter set for the character.

In order to solve the problem described above, in an information processing system, one or more computers carry out: processing for determining whether or not a preset specific condition is satisfied in a prescribed game; processing for setting a first action parameter for a character among action parameters in the case where the specific condition is not satisfied, the action parameters serving as parameters for determining autonomous operation of the character, and for setting a second action parameter associated with the first action parameter for the character in the case where the specific condition is satisfied; and processing for controlling the operation of the character in the prescribed game on the basis of the action parameter set for the character.

### Effects of Disclosure

The present invention makes it possible to enhance the fun of a game.

### BRIEF DESCRIPTION OF DRAWINGS

FIG. 1 is an illustration schematically showing the configuration of an information processing system.

FIG. 2A is a diagram for explaining the hardware configuration of a player terminal. FIG. 2B is a diagram for explaining the hardware configuration of a server.

FIG. 3A is an illustration for explaining an example home screen. FIG. 3B is an illustration for explaining an example option setting screen. FIG. 3C is an illustration for explaining an example profile setting screen. FIG. 3D is an illustration for explaining an example home setting screen.

FIG. 4 is a figure for explaining a rough flow of a nurturing game.

FIG. 5A is an illustration for explaining a main-character selection screen. FIG. 5B is a first illustration for explaining a character detail screen. FIG. 5C is a second illustration for explaining the character detail screen.

FIG. 6A is a figure for explaining an ability parameter (initial values) table. FIG. 6B is a figure for explaining an aptitude parameter (initial values) table. FIG. 6C is a figure for explaining a skill table. FIG. 6D is a figure for explaining an exclusive-event table.

FIG. 7A is a first illustration for explaining a character-to-inherit selection screen. FIG. 7B is a first illustration for explaining a nurtured-character list screen.

FIG. 7C is a second illustration for explaining the character-to-inherit selection screen. FIG. 7D is a third illustration for explaining the character-to-inherit selection screen.

FIG. 8 is a figure for explaining the lineage of inheritance.

FIG. 9 is a figure for explaining factor information.

FIG. 10A is a figure for explaining subjects for which compatibility is determined, and FIG. 10B is a figure for explaining items concerning which compatibility is determined.

FIG. 11A is a figure for explaining sort conditions, and FIG. 11B is a figure for explaining narrowing-down conditions.

FIG. 12 is a first illustration for explaining a character detail dialog.

FIG. 13 is a second illustration for explaining the character detail dialog.

FIG. 14 is a third illustration for explaining the character detail dialog.

FIG. 15 is an illustration for explaining a skill display dialog.

FIG. 16A is a first illustration for explaining a support-card incorporation screen. FIG. 16B is an illustration for explaining a support-card selection screen.

FIG. 16C is a second illustration for explaining the support-card incorporation screen.

FIG. 17A is a figure for explaining a support card table.

FIG. 17B is a figure for explaining a support effect table.

FIG. 17C is a figure for explaining a possessed skill table.

FIG. 17D is a figure for explaining a support event table.

FIG. 18A is an illustration for explaining a final confirmation screen. FIG. 18B is an illustration for explaining a preset selection screen.

FIG. 19 is a figure for explaining a selection item table.

FIG. 20A is an illustration for explaining a game screen. FIG. 20B is an illustration for explaining a special race screen.

FIG. 21A is a first illustration for explaining a training screen. FIG. 21B is a second illustration for explaining the training screen. FIG. 21C is an illustration for explaining a training-result report screen. FIG. 21D is an illustration for explaining an event screen.

FIG. 22A is a first illustration for explaining an inheritance event. FIG. 22B is a second illustration for explaining the inheritance event. FIG. 22C is a third illustration for explaining the inheritance event. FIG. 22D is a fourth illustration for explaining the inheritance event.

FIG. 23A is a first illustration for explaining a skill screen. FIG. 23B is a second illustration for explaining the skill screen.

FIG. 24A is a first illustration for explaining an individual-race selection screen. FIG. 24B is an illustration for explaining an individual-race start screen. FIG. 24C is a first illustration for explaining an individual-race result screen. FIG. 24D is a second illustration for explaining the individual-race result screen.

FIG. 25 is an illustration for explaining an example item exchange screen.

FIG. 26 is a figure for explaining a rough flow of a turn start process.

FIG. 27 is a figure for explaining an assign/do-not-assign table.

FIG. 28A is a figure for explaining a training level table. FIG. 28B is a figure for explaining a fixed raising-value (speed) table. Furthermore, FIG. 28C is a figure for explaining a fixed raising-value table (power). FIG. 28D is a figure for explaining a bonus addition rate table.

FIG. 29 is a figure for explaining a second event table.

FIG. 30 is an illustration for explaining a post-reassignment training screen.

FIG. 31 is a figure for explaining a rough flow of a turn start process.

FIG. 32 is a figure for explaining an assign/do-not-assign table.

FIG. 33 is a figure for explaining a bonus-number-of-acquisition table.

FIG. 34A is an illustration for explaining reporting of the assignment of a rival character in the game screen. FIG. 34B is an illustration for explaining reporting of the assignment of a rival character in the individual-race selection screen.

FIG. 35A is a first illustration for explaining a nurturing completion screen. FIG. 35B is a second illustration for explaining the nurturing completion screen.

FIG. 35C is a third illustration for explaining the nurturing completion screen.

FIG. 36A is a first illustration for explaining a special skill, and FIG. 36B is a second illustration for explaining the special skill.

FIG. 37 is a fourth illustration for explaining the nurturing completion screen.

FIG. 38 is a fourth illustration for explaining the character detail dialog.

FIG. 39A is an illustration for explaining an individual-race start screen according to an embodiment. FIG. 39B is an illustration for explaining an individual-race start screen according to a modification.

FIG. 40 is a diagram for explaining the configuration of a memory at the player terminal, as well as the functions thereof as a computer.

FIG. 41 is a diagram for explaining the configuration of a memory at the server, as well as the functions thereof as a computer.

FIG. 42 is a sequence chart for explaining processes at the player terminal and the server, relating to the nurturing game.

FIG. 43 is a flowchart for explaining a nurturing stage process at the server.

FIG. 44 is a flowchart for explaining a turn start process at the server.

FIG. 45 is a flowchart for explaining a nurturing stage process at the player terminal.

FIG. 46 is a flowchart for explaining a turn start process at the player terminal.

FIG. 47 is a flowchart for explaining a display control process at the player terminal.

FIG. 48 is a flowchart for explaining a during-turn process at the server.

FIG. 49 is a flowchart for explaining an individual-race execution process at the server.

FIG. 50 is a flowchart for explaining a simulation execution process at the server.

FIG. 51 is a flowchart for explaining a close competition process at the server.

FIG. 52 is a flowchart for explaining a skill invocation process at the server.

FIG. 53 is a flowchart for explaining a reward granting process at the server.

FIG. 54 is a flowchart for explaining a during-turn process at the player terminal.

FIG. 55 is a flowchart for explaining a display control process at the player terminal.

### DESCRIPTION OF EMBODIMENTS

An aspect of an embodiment of the present invention will be described below in detail with reference to the accompanying drawings. The numerical values, etc. given in this embodiment are merely examples for facilitating understanding, and do not limit the present invention unless otherwise specifically mentioned. In the present description and the drawings, elements having substantially the same functions and configurations have the same reference signs attached thereto and are not described repeatedly, and elements that are not directly relevant to the present invention are not shown.

### (Overall Configuration of Information Processing System S)

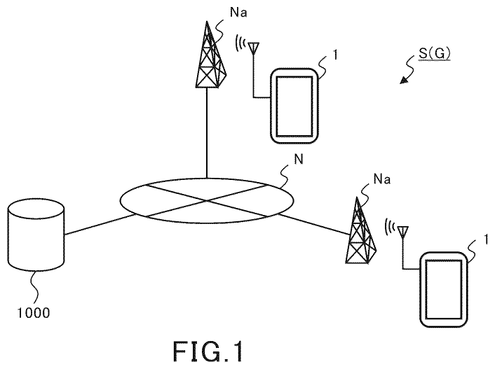

FIG. 1 is an explanatory illustration schematically showing the configuration of an information processing system S. The information processing system S is what is called a client-server system including player terminals 1, which function as clients, i.e., as game terminals, a server 1000, and a communication network N having communication base stations Na.

In the information processing system S in this embodiment, the player terminals 1 and the server 1000 function as game devices G. The player terminals 1 and the server 1000 individually share roles for controlling the proceeding of a game, and it becomes possible to proceed with the game through cooperation between the player terminals 1 and the server 1000.

The player terminals 1 can establish communication with the server 1000 via the communication network N. The player terminals 1 include a wide range of electronic appliances that are capable of communicatively connecting to the server 1000 in a wireless or wired manner. Examples of the player terminals 1 include smartphones, mobile phones, tablet devices, personal computers, and game machines. This embodiment will be described in the context of the case where smartphones are used as the player terminals 1.

The server 1000 is communicatively connected to the plurality of player terminals 1. The server 1000 accumulates various kinds of information for each player who plays the game. Furthermore, the server 1000 mainly carries out processing such as updating the accumulated information and allowing the player terminals 1 to download images and various kinds of information on the basis of operations input from the player terminals 1.

The communication base stations Na are connected to the communication network N, and send information to and receive information from the player terminals 1 in a wireless manner. The communication network N is implemented by a mobile phone network, an Internet network, a local area network (LAN), a special circuit, or the like, and realizes wireless or wired communicative connection between the player terminals 1 and the server 1000.

### (Hardware Configurations of Player Terminals 1 and Server 1000)

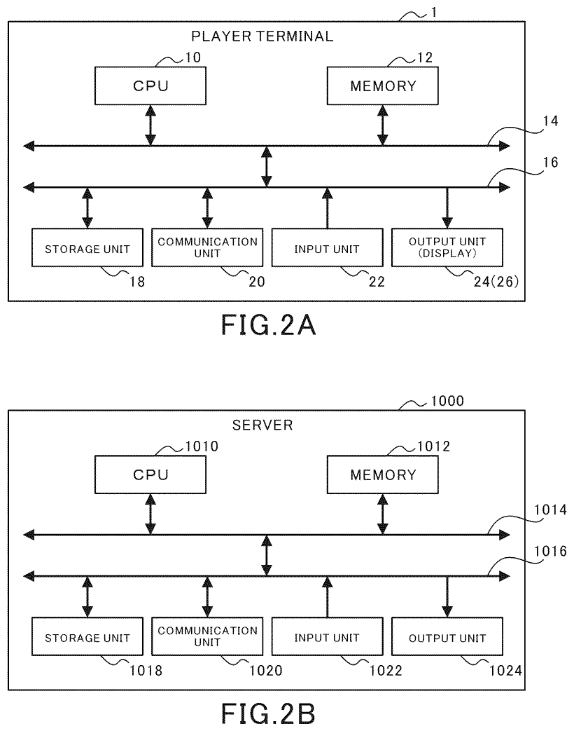

FIG. 2A is a diagram for explaining the hardware configuration of each of the player terminals 1. Furthermore, FIG. 2B is a diagram for explaining the hardware configuration of the server 1000. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

Furthermore, as shown in FIG. 2B, the server 1000 is configured to include a CPU 1010, a memory 1012, a bus 1014, an input/output interface 1016, a storage unit 1018, a communication unit 1020, an input unit 1022, and an output unit 1024.

Note that the configurations and functions of the CPU 1010, the memory 1012, the bus 1014, the input/output interface 1016, the storage unit 1018, the communication unit 1020, the input unit 1022, and the output unit 1024 of the server 1000 are substantially the same as those of the CPU 10, the memory 12, the bus 14, the input/output interface 16, the storage unit 18, the communication unit 20, the input unit 22, and the output unit 24 of the player terminal 1, respectively. Therefore, the following description will be directed to the hardware configuration of the player terminal 1, while omitting a description of the server 1000.

The CPU 10 runs a program stored in the memory 12 to control the proceeding of the game. The memory 12 is configured of a read only memory (ROM) or a random access memory (RAN), and stores the program and various kinds of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory such as a dynamic random access memory (DRAM), and stores various kinds of programs and data. In the player terminal 1, the programs and data stored in the storage unit 18 are loaded into the memory 12 (RAN) by the CPU 10.

The communication unit 20 is communicatively connected to one of the communication base stations Na in a wireless manner, and sends information to and receives information from the server 1000 via the communication network N, such as various kinds of data and programs. In the player terminal 1, programs, etc. received from the server 1000 are stored in the memory 12 or the storage unit 18.

The input unit 22 is configured of a unit via which player operations are input (operations are accepted), such as a touch panel, buttons, a keyboard, a mouse, a cross keypad, or an analog controller. Alternatively, the input unit 22 may be a special controller provided at the player terminal 1 or connected (externally connected) to the player terminal 1. Alternatively, the input unit 22 may be configured of an acceleration sensor that detects tilting or movement of the player terminal 1 or a microphone that detects player's voice. That is, examples of the input unit 22 include a wide range of devices that enable the input of player's intents in distinguishable manners.

The output unit 24 is configured to include a display device and a speaker. Note that the output unit 24 may be an appliance connected (externally connected) to the player terminal 1. In this embodiment, the player terminal 1 includes a display 26 as the output unit 24 and includes a touch panel as the input unit 22, the touch panel being provided so as to be stacked on the display 26.

### (Game Specifics)

Next, the game provided by the information processing system S and the game devices G in this embodiment will be described. Each player can possess characters acquired through lotteries called gacha, as well as characters distributed from the administration side. Furthermore, each player can possess support cards acquired through lotteries as well as support cards distributed from the administration side.

As will be described later in detail, a nurturing game is provided in the game according to this embodiment. In the nurturing game, each player can nurture a character that is possessed by the player. Furthermore, the nurturing game in this embodiment is designed such that a character is nurtured while letting the character participate in races simulating horse racing.

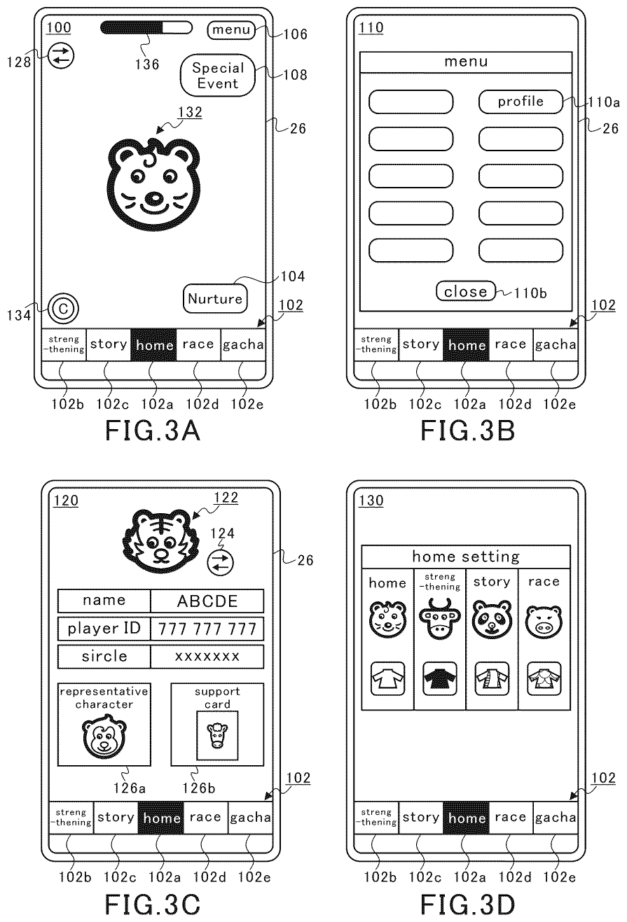

FIG. 3A is an illustration for explaining an example home screen 100. When a game application is started at the player terminal 1, the home screen 100 is displayed on the display 26. A menu bar 102 is displayed in a lower part of the home screen 100. In the menu bar 102, a plurality of operating parts that can be operated (tapped) by the player are provided.

Here, the following operating parts are provided in the menu bar 102: a home-screen selection operating part 102a; a strengthening-screen selection operating part 102b; a story-screen selection operating part 102c; a race-game selection operating part 102d; and a gacha-screen selection operating part 102e. Note that in the menu bar 102, the operating part corresponding to the screen displayed on the display 26 is indicated in a highlighted manner so that the screen displayed can be identified.

When the home-screen selection operating part 102a is tapped, the home screen 100 shown in FIG. 3A is displayed on the display 26.

When the strengthening-screen selection operating part 102b is tapped, a strengthening screen, which is not shown, is displayed. In the strengthening screen, the player can strengthen characters or support cards that are possessed by the player. By strengthening characters or support cards, the player can advance the levels set for the characters or support cards. Each character or support card has various kinds of parameters set thereto, and the parameters are raised as the level becomes advanced. By raising the parameters of a character or a support card, it becomes possible for the player to nurture a character having a stronger status in the nurturing game.

When the story-screen selection operating part 102c is tapped, a story screen, which is not shown, is displayed. Here, story images are provided for individual characters that appear in the game. The player can view the story screen while selecting a character and a story image.

When the race-game selection operating part 102d is tapped, a race-game selection screen, which is not shown, is displayed. In this embodiment, various race games are provided in which nurtured characters nurtured in a nurturing game, which will be described later, can participate. The race-game selection screen allows the player to select a race game in which a nurtured character participates. A type of race game is a team competition game in which a battle is played between a team formed of a plurality of nurtured characters and a team of another player selected by a computer. The team competition game is designed such that the player competes with another player for ranking.

When a gacha-screen selection operating part 102e is tapped, a gacha screen, which is not shown, is displayed. In the gacha screen, the player can perform what is called a gacha lottery, with which the player can acquire a character or a support card through a lottery by consuming an in-game currency.

Furthermore, in the home screen 100, a nurturing-game operating part 104 is provided above the menu bar 102. When the nurturing-game operating part 104 is tapped, a nurturing game screen is displayed, and a nurturing game, which will be described later, is started. The nurturing game is broadly classified into a preparation stage and a nurturing stage. First, in the preparation stage, the player selects one of the characters possessed by the player himself or herself and sets the character as a main character, which is the nurturing subject character.

Furthermore, the player sets a deck that is used when nurturing the main character in the preparation stage. The deck is formed of a plurality of characters to inherit and a plurality of support cards, which will be described later in detail. Therefore, the characters to inherit and the support cards incorporated into the deck are used in the nurturing game.

When the setting of the main character and the deck (characters to inherit and support cards) is finished, a transition from the preparation stage to the nurturing stage occurs, and a game for nurturing the main character is started. In the nurturing game, it is possible to change parameters of the nurturing subject character. The player can possess the character nurtured in the nurturing game as a nurtured character. As mentioned earlier, the player can incorporate the possessed nurtured character into a team and can use the possessed nurtured character in the team competition game, etc.

As described above, the main aims of the game in this embodiment are to nurture a character to be nurtured through the nurturing game and to advance the ranking for the team competition game by using the nurtured character.

Furthermore, this embodiment is provided with a function for sharing nurtured characters or support cards among players as well as a function for sharing information among a plurality of players. The player can set nurtured characters and support cards that can be used by another player in the nurturing game. Specifically, as shown in FIG. 3A, a setting operating part 106 is provided in an upper right part of the home screen 100. When the setting operating part 106 is tapped, an option setting screen 110 is displayed.

FIG. 3B is an illustration for explaining an example of the option setting screen 110. The option setting screen 110 is a screen that makes it possible to confirm and set various kinds of information. The option setting screen 110 has a plurality of operating parts provided therein, and when one of the operating parts is tapped, it becomes possible to confirm or set information corresponding to the operating part.

The operating parts in the option setting screen 110 include a profile setting operating part 110a and a close operating part 110b. When the close operating part 110b is tapped, the option setting screen 110 is closed, and the home screen 100 is displayed. When the profile setting operating part 110a is tapped, a profile setting screen 120 is displayed.

FIG. 3C is an illustration for explaining an example of the profile setting screen 120. In the profile setting screen 120, the player can confirm or set profile information of the player himself or herself. The profile information includes a profile character, a player name, a player ID, a circle to which the player belongs, a representative character, and rental cards.

The profile character functions as a character that is displayed when information concerning the player is viewed by other players. For example, the profile character is displayed when a circle function, which provides a field for sharing information with other players, is being used. In the profile setting screen 120, a profile character image 122 that is currently set is displayed. A change button 124 is provided in the proximity of the profile character image 122. When the change button 124 is tapped, a profile character changing screen, which is not shown, is displayed. The player can change the profile character in the profile character changing screen.

Furthermore, in the profile setting screen 120, a player name set by the player, a player ID assigned to the player, and the name of the circle to which the player belongs are displayed. Furthermore, in the profile setting screen 120, a representative-character setting operating part 126a and a rental-card setting operating part 126b are provided.

When the representative-character setting operating part 126a is tapped, a representative-character setting screen, which is not shown, is displayed. The player can set one of the nurtured characters nurtured by the player himself or herself as a representative character in the representative-character setting screen. In the representative-character setting operating part 126a, an icon image indicating the currently set representative character is displayed. As will be described later in detail, the representative character can be incorporated into a deck as a character to inherit in nurturing games that are played by other players.

When the rental-card setting operating part 126b is tapped, a rental-card setting screen, which is not shown, is displayed. In the rental-card setting screen, the player can set one of the support cards possessed by the player himself or herself as a rental card. In the rental-card setting operating part 126b, an icon image indicating the currently set rental card is displayed. As mentioned earlier, the support card set as a rental card can be incorporated into a deck by other players and are used in nurturing games that are played by the other players.

Although not described in detail, when a change is made to the setting of the profile information in the profile setting screen 120, setting change information is transmitted to the server 1000. In the server 1000, profile information is saved on a per-player basis.

Furthermore, as shown in FIG. 3A, a setting icon 128 is displayed in the home screen 100. When the setting icon 128 is tapped, a home setting screen 130 is displayed.

FIG. 3D is an illustration for explaining an example of the home setting screen 130. In the home setting screen 130, the player can set home-screen setting characters 132 that are displayed in the home screen 100. The player can set four home-screen setting characters 132 that are displayed in the home screen 100.

Although not shown, when a flick operation in the horizontal direction is input in the home screen 100, what is displayed in the screen displayed on the display 26, i.e., the home screen 100, is switched. In the home screen 100, the four currently set home-screen setting characters 132 are displayed. The home-screen setting characters 132 have assigned thereto functions as the individual operating parts displayed in the menu bar 102. Therefore, when one of the home-screen setting characters 132 displayed in the home screen 100 is tapped, the screen is switched like when one of the operating parts in the menu bar 102 is tapped.

In the home setting screen 130, character images individually corresponding to the four currently set home-screen setting characters 132, as well as corresponding operating parts, are displayed in a distinguishable manner. When one of the character images displayed in the home setting screen 130 is tapped, a character selection screen, which is not shown, is displayed. The player can select one of the home-screen setting characters 132 in the character selection screen. Furthermore, the player can set a costume for the home-screen setting character 132 in the home setting screen 130.

Furthermore, as shown in FIG. 3A, a circle icon 134 is displayed in the home screen 100. When the circle icon 134 is tapped, a circle screen is displayed. In the circle screen, the player can exchange information with other players belonging to the same circle.

Furthermore, in this embodiment, various kinds of period-specific events are held at irregular timings. During the period in which a specific event that is a period-specific event is held, a specific-event icon 108 is displayed in the home screen 100. When the specific-event icon 108 is tapped, a specific event screen is displayed. In the specific event screen, for example, the player can exchange specific event points, which are provided only in specific events, for various kinds of rewards. Furthermore, in a period-specific event, there are cases where the player is granted an additional reward, which is different from a base reward, when the player wins a particular race (hereinafter referred to as a specific race). For example, the additional reward is a special item that makes it possible to increase the initial value of an ability parameter of a specific character or to enhance a unique skill provided for a specific character. Here, the specific character refers to, for example, one of the characters that participates in a specific race in a period-specific event. Without limitation thereto, however, the specific character may be any character that can be acquired by the player, and may be a character that does not participate in a specific race.

Here, the specific race is at least one race that is set in advance on the basis of a kind of race among races that can be played during the period in which a specific event is held. Furthermore, the additional reward may be granted on condition of participation in the specific race, regardless of winning or not winning the specific race. The number of times that the additional reward (i.e., a special item) can be acquired in one specific race (one kind of specific race) is limited to a prescribed number of times during a prescribed period. For example, the number of times that a special item can be acquired in one specific race per day is three. However, the number of times that a special item can be acquired may be varied depending on the type of specific race (kind of race). Furthermore, the number of special items that are acquired on each occasion is the sum of the basic number of items that are acquired (e.g., three) and the bonus number of items that are acquired (e.g., one or two). The bonus number of items that are acquired may be granted in the case of winning a specific race. The additional reward acquired as a result of a specific race is associated with the player ID and is stored at the server 1000.

When the nurturing-game operating part 104 is tapped in the home screen 100, a nurturing game screen is displayed, and a nurturing game is started. Note that the player can play the nurturing game by consuming game points. Game points are granted to the player at a rate of a prescribed value (e.g., +1) per prescribed period (e.g., ten minutes). An upper limit value (e.g., 100) is defined for the game points that can be possessed by the player, and the player can possess game points within the range not exceeding the upper limit value. In an upper part of the home screen 100, a game-point indication bar 136 is provided, which visually displays the ratio of currently possessed game points to the upper limit value.

Note that a prescribed value (e.g., −30) is subtracted from the game points when the nurturing game is started. Therefore, the player cannot start the nurturing game in the case where the player does not possess game points required. However, the player can possess an item for recovering the game points and can recover the game points by using the item. For example, this item is granted as a reward for the nurturing game or the team competition game or can be acquired by consuming an in-game currency. The following describes the nurturing game in detail.

### (Nurturing Game)

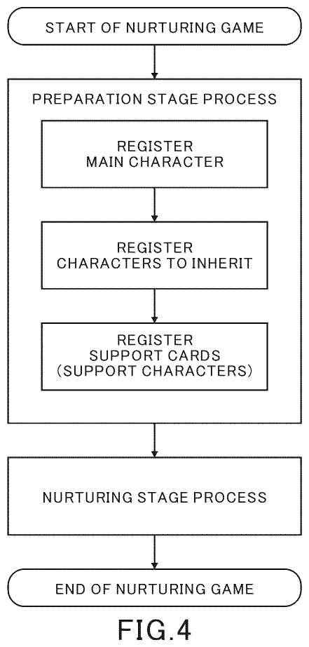

FIG. 4 is a figure for explaining a rough flow of the nurturing game. The nurturing game is broadly classified into a setting game and a main nurturing game. As will be described later, the main nurturing game is a game in which one main character selected from among the characters possessed by the player is nurtured as a nurturing subject character.

Furthermore, the setting game is a game in which the player registers a main character and a deck (characters to inherit and support cards) and that corresponds to the preparation stage of the nurturing game. In the following, processing that is carried out in the setting game will be referred to as a preparation stage process, and processing that is carried out in the main nurturing game will be referred to as a nurturing stage process. Here, in order to facilitate understanding, the rough flows in the preparation stage process and the nurturing stage process will be described first.

### <Preparation Stage Process>

In the preparation stage process, settings are made mainly for the registration of a main character and the registration of a deck (characters to inherit and support cards). Note that the support cards serve as aids for nurturing the main character. Each of the support cards necessarily has one character associated therewith, and the character associated with the support card, registered in the preparation stage process, aids nurturing of the main character. Characters associated with support cards will hereinafter be referred to as support characters.

### <Registration of Main Character>

When the nurturing-game operating part 104 is tapped by the player in the home screen 100, a scenario selection screen, which is not shown, is displayed. In this embodiment, a plurality of scenarios for the main nurturing game are provided. Each of the scenarios for the main nurturing game has set therein a final goal, goals in the middle of the game, etc., and the player has to sequentially clear the set goals. The individual goals, the periods before accomplishing the goals, etc. vary among the individual scenarios. The player can select one of the plurality of scenarios in the scenario selection screen. Here, the case where a prescribed scenario is selected will be described.

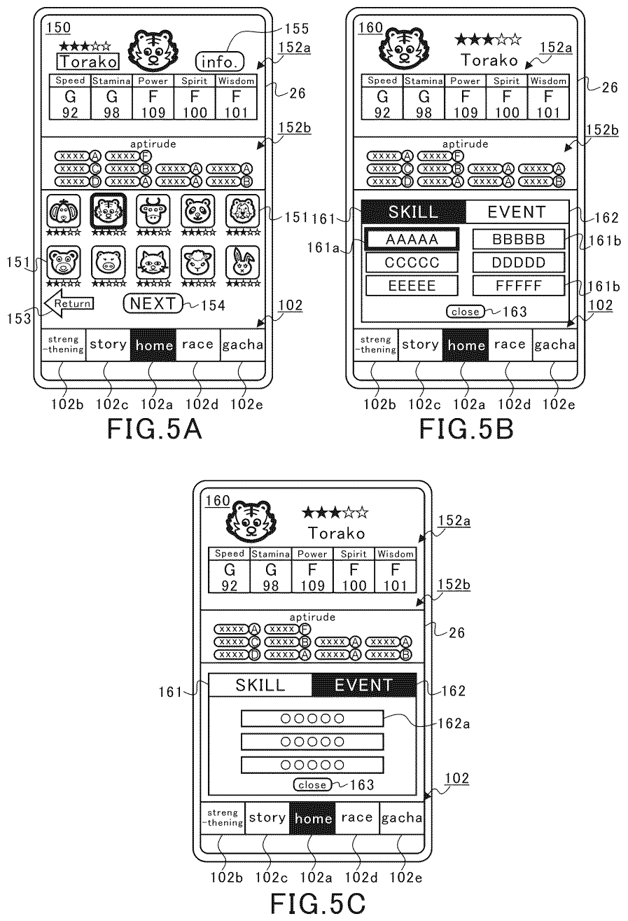

FIG. 5A is an illustration for explaining a main-character selection screen 150. In a central part of the main-character selection screen 150, a plurality of character icons 151 are displayed to display a list of characters possessed by the player. Furthermore, an ability-parameter displaying part 152a and an aptitude-parameter displaying part 152b are displayed in an upper part of the main-character selection screen 150. Furthermore, a return operating part 153 labeled as “Return” and a next operating part 154 labeled as “NEXT” are displayed in a lower part of the main-character selection screen 150.

In this embodiment, initial values of ability parameters are set for each character, and initial values of the ability parameters of the character corresponding to the character icon 151 selected by the player are displayed in the form of numerical values in the ability-parameter displaying part 152a. In this embodiment, greater numerical values of ability parameters indicate higher abilities.

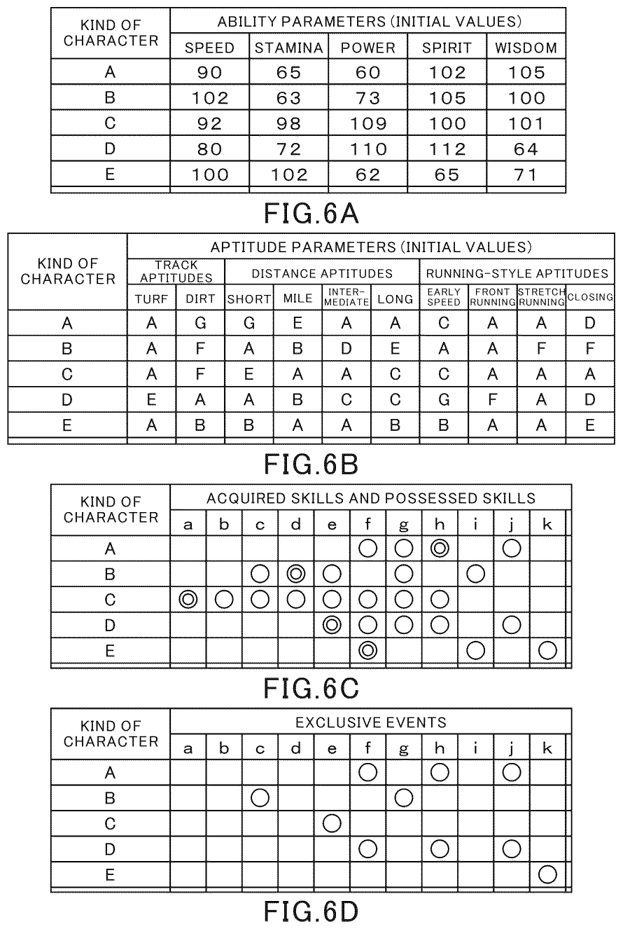

FIG. 6A is a figure for explaining an ability parameter (initial value) table. In this embodiment, as shown in FIG. 6A, initial values of ability parameters for each character are stored in the ability parameter (initial value) table. Initial values of ability parameters are displayed in the ability-parameter displaying part 152a on the basis of the initial values of ability parameters stored in the ability parameter (initial value) table.

In this embodiment, initial values of ability parameters are set individually for a plurality of kinds of abilities for each character. Specifically, the following ability parameters are provided: a speed ability parameter labeled as “Speed” in the ability-parameter displaying part 152a; a stamina ability parameter labeled as “Stamina” in the ability-parameter displaying part 152a; a power ability parameter labeled as “Power” in the ability-parameter displaying part 152a; a spirit ability parameter labeled as “Spirit” in the ability-parameter displaying part 152a; and a wisdom ability parameter labeled as “Wisdom” in the ability-parameter displaying part 152a.

Note that the initial values of ability parameters for each character are raised by player operations or the like. For example, five levels are provided for each character, and the player can advance the level of the character by consuming an in-game currency or a prescribed item. In this case, the initial values of ability parameters are raised as the character level becomes advanced. FIG. 6A shows initial values in the case where the level of the character is a prescribed level. Note that the player can raise the values of ability parameters in the main nurturing game. That is, the aim of the main nurturing game is to nurture a character having greater numerical values of ability parameters.

Furthermore, in this embodiment, each character has aptitude parameters (initial values) set therefor. As shown in FIG. 5A, in the aptitude-parameter displaying part 152b, the initial values of the aptitude parameters of the character corresponding to a character icon 151 selected by the player are displayed by using alphabet letters.

FIG. 6B is a figure for explaining an aptitude parameter (initial value) table. In this embodiment, as shown in FIG. 6, initial values of aptitude parameters for each character are stored in the aptitude parameter (initial value) table. The initial values of aptitude parameters are each set to one of seven levels in the form of alphabetic characters A to G. With the initial values of aptitude parameters, A indicates the highest aptitude, while G indicates the lowest aptitude. The initial values of aptitude parameters are displayed in the aptitude-parameter displaying part 152b on the basis of the initial values of aptitude parameters stored in the aptitude parameter (initial value) table.

In this embodiment, initial values of aptitude parameters are set individually for a plurality of kinds of aptitudes for each character. Specifically, the following aptitude parameters are provided: aptitude parameters concerning individual track aptitudes for turf and dirt; aptitude parameters for individual distance aptitudes for short distance, mile, intermediate distance, and long distance; and aptitude parameters for individual running style aptitudes for early speed, front running, stretch running, and closing.

The player can let the main character participate in various kinds of races in the nurturing game. At this time, the race proceeds advantageously as the aptitudes of the main character matching race specifics become higher.

Note that it may be allowed to raise the initial values of aptitude parameters for each character by consuming an in-game currency. Furthermore, the values of aptitude parameters may be changed in the main nurturing game. Furthermore, there may be cases where an aptitude parameter is set to S, which indicates an aptitude higher than A, in the main nurturing game.

FIG. 5B is a first illustration for explaining a character detail screen 160. Furthermore, FIG. 5C is a second illustration for explaining the character detail screen 160. When one of the character icons 151 in the main-character selection screen 150 is held, the character detail screen 160 is displayed on the display 26. In the character detail screen 160, details of the abilities of the character corresponding to the character icon 151 held in the main-character selection screen 150 are displayed.

In a central part of the character detail screen 160, a skill operating part 161 and an event operating part 162 are displayed. As shown in FIG. 5B, when the character detail screen 160 is displayed, the skill operating part 161 is initially displayed in a highlighted manner, and skills provided for each character are displayed. A skill refers to an ability that may be invoked in the case where a prescribed condition is satisfied during the execution of individual racing, which will be described later. A race proceeds advantageously for each character when a skill is invoked.

FIG. 6C is a figure for explaining a skill table. As shown in FIG. 6C, skills of each character possessed by the player are stored in the skill table. As shown in FIG. 5B, skills are displayed in the character detail screen 160 on the basis of the skills stored in the skill table. Note that a skill is not invoked just by being possessed, and it becomes possible for a skill to be invoked for the first time when the skill is acquired. In the following, a skill in the state where a character is able to invoke that skill is referred to as an acquired skill.

From the beginning of the main nurturing game, each character has one acquired skill set thereto. Furthermore, apart from the acquired skill, each character has a plurality of possessed skills set thereto. The possessed skills are skills that can be acquired after the start of the main nurturing game by consuming skill points, which will be described later. That is, the possessed skills may become acquired skills in exchange for skill points.

In this embodiment, each skill corresponding to a double circle symbol in the skill table shown in FIG. 6C is displayed as an acquired skill in the character detail screen 160 in FIG. 5B. Furthermore, each skill corresponding to a single circle symbol in the skill table shown in FIG. 6C is displayed as a possessed skill in the character detail screen 160 in FIG. 5B. In this embodiment, as shown in the character detail screen 160 in FIG. 5B, the acquired skill is displayed in a highlighted manner so that the acquired skill and the possessed skills can be readily distinguished from each other.

Note that although the case where one acquired skill is displayed in the acquired-skill display field 161a and seven possessed skills are displayed in the possessed-skill display field 161b as skills provided for each character is shown in FIG. 5B, there is no limitation thereto. For example, the number of acquired skills and the number of possessed skills may vary among individual characters. Furthermore, the number of acquired skills and the number of possessed skills of each character may be increased, for example, when the character level is advanced or when an in-game currency or an item is consumed.

Furthermore, when the event operating part 162 in the character detail screen 160 is tapped by the player, as shown in FIG. 5C, the content of the character detail screen 160 is switched, and an exclusive-event display field 162a showing exclusive events 162a provided for each character is displayed. In this case, as shown in FIG. 5C, the event operating part 162 is displayed in a highlighted manner. An exclusive event occurs in the case where a prescribed condition is satisfied in the main nurturing game, with which a story relating to a character that appears in the nurturing game is displayed, or the value of an ability parameter is changed.

FIG. 6D is a figure for explaining an exclusive-event table. As shown in FIG. 6D, in the exclusive-event table, exclusive events are stored for each character possessed by the player. Furthermore, as shown in FIG. 5C, exclusive events are displayed in the character detail screen 160 on the basis of the exclusive events stored in the exclusive-event table. Note that the exclusive events may include hint events that make it possible to possess or acquire skills, ability events that increase or decrease the numerical values of ability parameters of a character, etc.

Note that the exclusive events displayed in the character detail screen 160 shown in FIG. 5C may be arranged such that all the exclusive events are executed during the execution of the main nurturing game, such that at least some of the exclusive events are executed during the execution of the main nurturing game, or such that none of the exclusive events are executed during the execution of the main nurturing game in the case where the prescribed condition is not satisfied. Furthermore, the number of exclusive events provided for each character may be increased, for example, when the character level is advanced, when an in-game currency or an item is consumed, or the like. Furthermore, exclusive events that are not displayed as exclusive events may be executed during the main nurturing game in the case where the prescribed condition is satisfied.

Furthermore, as shown in FIGS. 5B and 5C, in a lower part of the character detail screen 160, a close operating part 163 labeled as “close” is displayed. When the close operating part 163 of the character detail screen 160 is tapped, the displaying of the character detail screen 160 is terminated, and the main-character selection screen 150 is displayed on the display 26.

Furthermore, when the return operating part 153 is tapped in the main-character selection screen 150 shown in FIG. 5A, the home screen 100 shown in FIG. 3A is displayed on the display 26. Furthermore, a nurturing-information display button 155 is provided in the main-character selection screen 150. When the nurturing-information display button 155 is tapped, a nurturing-information displaying screen, which is not shown, is displayed. In the nurturing-information displaying screen, the player can confirm information concerning the character selected in the main-character selection screen 150.

In the nurturing-information displaying screen, a target-to-clear tab is provided. Here, it is an objective of the nurturing game for the player to nurture a character selected as a main character, which is the nurturing subject character, from among characters possessed by the player, thereby generating a stronger nurtured character. As will be described later in detail, the main nurturing game is constituted of a plurality of turns, and the player has to let the main character perform training or to let the main character participate in a race in each turn.

Furthermore, each character has individually set therefor a plurality of targets to clear. When the target-to-clear tab is tapped, a list of targets to clear set for the currently selected character is displayed in the nurturing-information displaying screen. For each turn, a race in which the main character can participate is predefined.

Furthermore, when the main character, which is to be nurtured, participates in a race, the main character can acquire fans, victory points, and a special currency. For each race, the number of fans, victory points, and a base amount of special currency that can be acquired are defined on a per-place basis such that the values of the number of fans, victory points, and the amount of special currency that can be acquired increase as the place becomes higher. Furthermore, each race has a difficulty level set therefor, and it becomes possible to acquire a greater number of fans, greater victory points, and a greater amount of special currency as the difficulty level of the race becomes higher. For example, among races, there are races with grades GI, GII, and GIII, which are called graded races. The grades become higher in order of GIII, GII, and GI. As the grade of the race becomes higher, the difficulty level becomes higher, and it becomes possible to acquire a greater number of fans, greater victory points, and a greater amount of special currency.

Here, the number of fans that can be acquired by participating in a race is calculated by adding a bonus number of acquisition to a base number of acquisition defined on a per-place basis. Specifically, a correction value is determined on the basis of the result of the race, and the bonus number of acquisition is calculated by multiplying the base number of acquisition by the correction value. The total of the bonus number of acquisition and the base number of acquisition is used as the number of fans that are acquired by the main character. For example, in the case where the result of the race was the first place, the correction value becomes greater as the length between the main character and the second place character increases. Furthermore, in the case where the result of the race was the second place to the fifth place, the correction value becomes greater as the length between the main character and the first place character decreases.

Furthermore, the main character invokes skills at a prescribed probability. At this time, the correction value becomes greater as the number of skills invoked becomes greater. As described above, conditions for adding a number of fans are defined for each race, and the number of fans that are acquired increases depending on various results of the race other than the places, as well as interim records of the race. Note, however, that the number of fans that are acquired by the main character is at least not less than the base number of acquisition corresponding to the place.

Note that, depending on the race, the number of fans is specified as a condition for participation. In the case where the number of fans that have been acquired by the main character is less than the number of fans specified as a condition for participation, the player is not allowed to let the main character participate in the race. The number of fans required for participation becomes greater as the difficulty level of the race becomes higher.

As described above, each character has set therefor a plurality of targets to clear. By accomplishing the target to clear, the player can continue the main nurturing game until the final turn. Meanwhile, in the case of a failure to accomplish a target to clear in one turn, the main nurturing game is terminated in that turn.

As described above, in the main-character selection screen 150 shown in FIG. 5A, the player can select a main character while checking various kinds of information concerning individual characters. Furthermore, when the next operating part 154 is tapped in the main-character selection screen 150, the currently selected character is set as the main character, and a character-to-inherit selection screen 170 is displayed on the display 26.

### <Registration of Characters to Inherit>

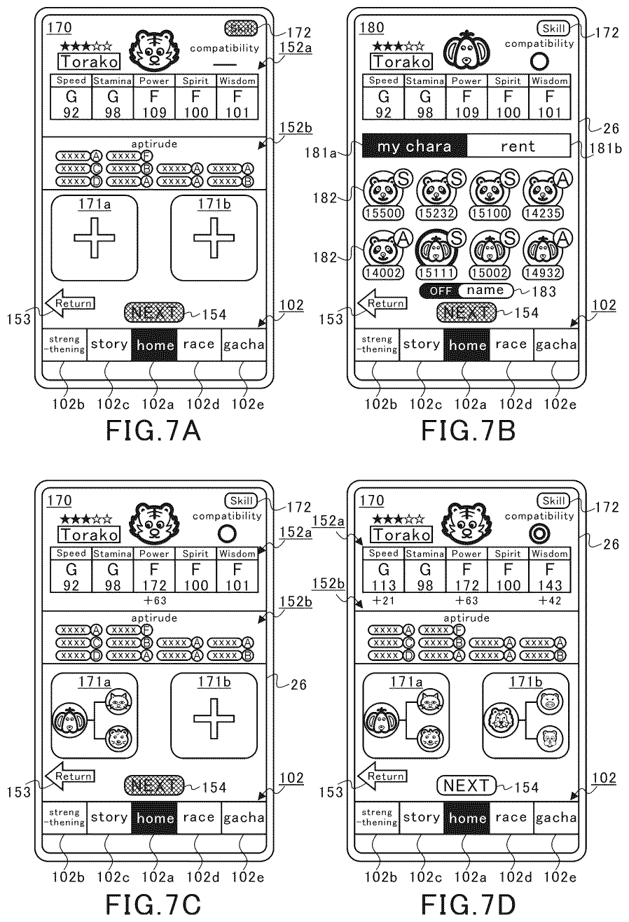

FIG. 7A is a first illustration for explaining a character-to-inherit selection screen 170. FIG. 7B is an illustration for explaining a nurtured-character list screen 180. FIG. 7C is a second illustration for explaining the character-to-inherit selection screen 170. FIG. 7D is a third illustration for explaining the character-to-inherit selection screen 170. The character-to-inherit selection screen 170 is a screen for the player to register characters to inherit.

A character to inherit refers to a character whose ability values, skills, etc. are to be inherited by the main character. The player can select two characters to inherit from among nurtured characters possessed by the player himself or herself and the representative characters of other players extracted according to a prescribed extraction condition, like the representative characters of friends such as followers, and can incorporate and register the two characters to inherit into the deck. Note that in one occasion of the nurturing game, it is possible to incorporate only one representative character of another player into the deck as a character to inherit.

In the character-to-inherit selection screen 170, an ability-parameter displaying part 152a, an aptitude-parameter displaying part 152b, a first character-to-inherit selection area 171a, and a second character-to-inherit selection area 171b are provided. Upon a screen transition from the main-character selection screen 150 to the character-to-inherit selection screen 170, as shown in FIG. 7A, the first character-to-inherit selection area 171a and the second character-to-inherit selection area 171b are displayed as being blank.

When the first character-to-inherit selection area 171a or the second character-to-inherit selection area 171b is tapped, the nurtured-character list screen 180 shown in FIG. 7B is displayed. In the nurtured-character list screen 180, a my character tab 181a and a rental tab 181b are provided. Furthermore, a nurtured-character-list display area is provided under the my character tab 181a and the rental tab 181b. Nurtured-character icons 182 are displayed in the nurtured-character-list display area.

In the state where the my character tab 181a is selected, as shown in FIG. 7B, nurtured-character icons 182a corresponding to the nurtured characters possessed by the player himself or herself are displayed. Furthermore, although not shown, in the state where the rental tab 181b is selected, representative characters of friends, i.e., nurtured-character icons 182 corresponding to nurtured characters nurtured by friends are displayed.

Furthermore, when one of the nurtured-character icons 182 is tapped, the nurtured character corresponding to the nurtured-character icon 182 becomes tentatively selected. Furthermore, when one of the nurtured-character icons 182 is tapped, as shown in FIG. 7C, the character-to-inherit selection screen 170 is displayed. At this time, for example, in the case where the first character-to-inherit selection area 171a is tapped, the nurtured-character list screen 180 is displayed, and one of the nurtured-character icons 182 is tapped in the nurtured-character list screen 180, the image indicating the tentatively selected nurtured character is displayed in the first character-to-inherit selection area 171a.

In this state, for example, when the second character-to-inherit selection area 171b is tapped, the nurtured-character list screen 180 is displayed, and one of the nurtured-character icons 182 is tapped in the nurtured-character list screen 180, as shown in FIG. 7D, the image indicating the tentatively selected nurtured character is displayed in the second character-to-inherit selection area 171b.

Furthermore, information concerning the characters to inherit that were used at the time of nurturing is stored in association with the nurtured character. In the first character-to-inherit selection area 171a, the information concerning the characters to inherit that were used when nurturing the nurtured character is displayed.

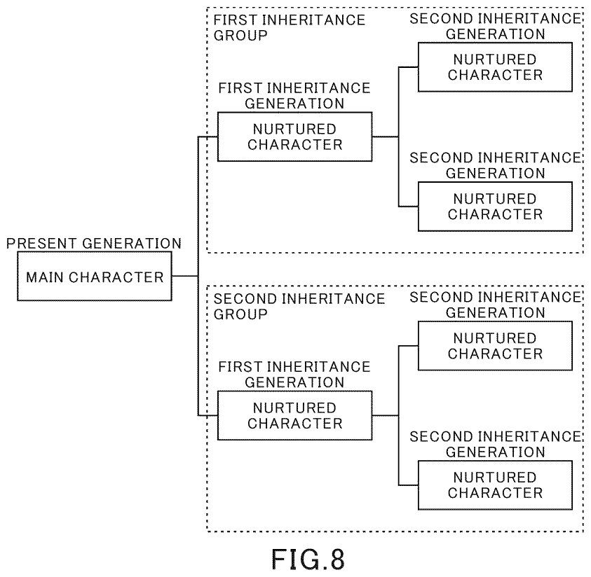

FIG. 8 is a diagram for explaining the lineage of inheritance. In the nurturing game, various advantages are afforded on the basis of factor information of inherited characters; for example, the values of ability parameters or aptitude parameters of the main character are raised. Here, two characters to inherit are set for one main character, and these characters to inherit are nurtured characters generated earlier. Therefore, in generating a nurtured character set as a character to inherit, two characters to inherit were set for that nurtured character.

As shown in FIG. 8, the main character, which is to be nurtured in the main nurturing game that is to start, is considered as the present generation. Furthermore, two nurtured characters set as characters to inherit for the main character are considered as the first inheritance generation. Furthermore, at the start of nurturing of a nurtured character of the first inheritance generation, two nurtured characters were set as characters to inherit. The two nurtured characters set as characters to inherit in generating the nurtured character of the first inheritance generation are considered as the second inheritance generation.

In this case, as shown in FIG. 8, it is the nurtured characters of the first inheritance generation and the second inheritance generation that afford advantages to the main character of the present generation. Since two characters to inherit (the first inheritance generation) are set for one main character, as mentioned above, six nurtured characters in total afford advantages to one main character.

For example, a first inheritance group is constituted of one of the two nurtured characters of the first inheritance generation and two nurtured characters of the second inheritance generation, the latter being characters inherited by the former. Similarly, a second inheritance group is constituted of the other one of the two nurtured characters of the first inheritance generation and two nurtured characters of the second inheritance generation, the latter being characters inherited by the former.

As shown in FIG. 7D, in the first character-to-inherit selection area 171a, icons individually corresponding to the one nurtured character of the first inheritance generation and the two nurtured characters of the second inheritance generation, constituting the first inheritance group, are shown. Similarly, in the second character-to-inherit selection area 171b, icons individually corresponding to the one nurtured character of the first inheritance generation and the two nurtured characters of the second inheritance generation, constituting the second inheritance group, are shown.

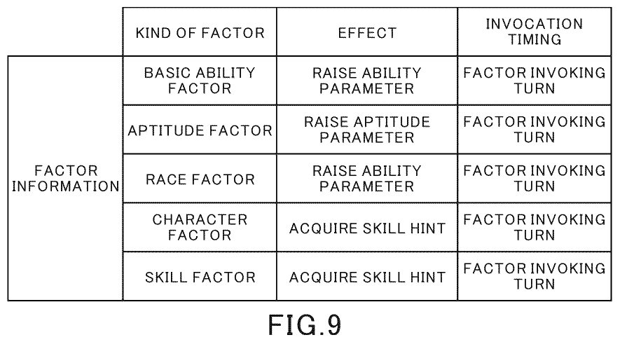

FIG. 9 is a figure for explaining factor information. As will be described later in detail, when the nurturing game is finished, the main character that has been nurtured is registered as a nurtured character, and factor information is stored in association with the nurtured character at this time. Specifically, at the completion of nurturing of a nurtured character, factors to be acquired by the nurtured character are determined through lotteries. Then, factor information indicating the factors won through the lotteries is associated with the nurtured character. In other words, at the completion of the nurturing game, the nurtured character can acquire factors won through lotteries.

Note, however, that the factors acquired by the nurtured character do not affect the abilities themselves of the nurtured character. For example, it is possible to let the nurtured character participate in a race game, such as a team competition game. At this time, in the race, simulation, i.e., computational processing, for determining places and the development of the race is performed on the basis of the ability parameters, the aptitude parameters, the acquired skills, etc. of all the participating nurtured characters. Since the factors acquired by the nurtured character are not used in the computational processing, the race does not proceed advantageously even if the nurtured character has a large number of factors.

The factors acquired by a nurtured character affect only the main character to be nurtured in the case where the nurtured character is set as a character to inherit. The factors that can be acquired by a nurtured character are classified into a plurality of kinds. As the kind of factors, FIG. 9 shows basic ability factors, aptitude factors, race factors, character factors, and skill factors. Each of the factors has set therefor one of a plurality of levels. Here, three factor levels, namely, level 1, level 2, and level 3, are provided as factor levels.

Note that factor levels are determined through lotteries. At this time, factor levels may be determined through lotteries for each acquired factor after factors to be acquired by a nurtured character are determined. Alternatively, the arrangement may be such that winning ratios are set for individual combinatorial patterns of factors and factor levels and one of the combinatorial patterns is determined on the basis of the set winning ratios. In this case, factors to be acquired and the factor levels thereof are determined simultaneously.

With factor levels, level 3 has the highest effect, and level 1 has the lowest effect. In a lottery for determining a factor level, the winning probability of level 3 is set to be the lowest, and the winning probability of level 1 is set to be the highest. Note, however, that the winning probabilities of factors to be acquired and the winning probabilities of factor levels may be changed depending on the result of the nurturing game. In this case, for example, the factor level may be determined so as to be higher as the ability parameters or the evaluation score of the nurtured character become higher.

Basic ability factors serve to raise the ability parameters of the main character. Five basic ability factors are provided, namely, a speed factor, a stamina factor, a power factor, a spirit factor, and a wisdom factor. Each nurtured character necessarily acquires one of the five basic ability factors. The five basic ability factors individually correspond to the five ability parameters of speed, stamina, power, spirit, and wisdom. For example, in the case where a nurtured character of the first inheritance generation or the second inheritance generation has the speed factor, the speed ability parameter of the main character is raised.

At this time, the value by which the speed ability parameter is raised varies depending on the factor level of the speed factor. For example, the speed ability parameter of the main character is raised by “7” in the case where the factor level of the speed factor is level 1, the ability parameter is raised by “13” in the case where the factor level is level 2, and the ability parameter is raised by “21” in the case where the factor level is level 3. Therefore, assuming the case where all of the six nurtured characters in total, including two of the first inheritance generation and four of the second inheritance generation, have the speed factor of level 3, the speed ability parameter of the main character is raised by 126 (the raising value of 21×six characters) at most.

Note that each factor has an invocation timing and an invocation condition set therefor. Therefore, even if an inherited character has a factor, an advantage is not afforded to the main character in the case where the invocation condition thereof is not satisfied at the invocation timing.

As described earlier, the main nurturing game is constituted of a plurality of turns, of which prescribed turns are set as factor invoking turns. Suppose, for example, that three turns of the main nurturing game, namely, the 1st turn, the 30th turn, and the 54th turn, are set as factor invoking turns. In these factor invoking turns, for each factor, it is determined whether or not to invoke that factor, and the invocation condition of the factor is satisfied when it is determined that the factor is to be invoked, whereby an advantage corresponding to the factor is afforded.

Note that whether or not to invoke a basic ability factor is determined through a lottery. At this time, the winning probability in a lottery for determining whether or not to invoke a basic ability factor, i.e., the probability with which a basic ability factor is invoked (hereinafter referred to as the invocation probability), may vary among the three factor invoking turns. Here, the invocation probability of each basic ability factor is set to 100% in the 1st turn irrespective of the factor level. Furthermore, the invocation probability of a basic ability factor varies depending on the factor level in the 30th turn and in the 54th turn. In one example, in the 30th turn and in the 54th turn, the invocation probability of a basic ability factor of level 3 is set to 100%, the invocation probability of a basic ability factor of level 2 is set to 90%, and the invocation probability of a basic ability factor of level 1 is set to 80%.

In the character-to-inherit selection screen 170, a value by which an ability parameter is raised in the 1st turn is displayed. For example, in FIG. 7C, one character to inherit constituting the first inheritance group is tentatively selected. In this case, the kind of ability parameter that is raised in the 1st turn due to the tentatively selected one character to inherit, as well as the value by which the ability parameter is raised, are displayed. Here, “+63” is displayed under the power ability parameter, which indicates that the power ability parameter is raised by 63 points in the 1st turn. Furthermore, a value obtained by adding the value of raising in the 1st turn is displayed in the ability-parameter displaying part 152a.

Meanwhile, in FIG. 7D, two characters to inherit constituting the first inheritance group and the second inheritance group are tentatively selected. In this case, the kinds of ability parameters that are raised in the 1st turn due to the tentatively selected two characters to inherit, as well as the values by which the ability parameters are raised, are displayed. Here, “+21”, “+63”, and “+42” are displayed individually under the speed, power, and wisdom ability parameters, which indicates that the speed, power, and wisdom ability parameters are raised by 21 points, 63 points, and 42 points, respectively, in the 1st turn.

Note that in the character-to-inherit selection screen 170, the values by which ability parameters are raised due to characters to inherit constituting the first inheritance group and the values by which ability parameters are raised due to characters to inherit constituting the second inheritance group are displayed in a distinguishable manner. For example, in FIG. 7D, the indication of “+63” under the power ability parameter and the indications of “+21” and “+42” under the speed and wisdom ability parameters are displayed in different colors.

The aptitude parameters shown in FIG. 9 serve to raise the aptitude parameters of the main character. Six aptitude parameters are provided, namely, a turf factor, a dirt factor, a short-distance factor, a mile factor, an intermediate-distance factor, and a long-distance factor. Each nurtured character necessarily acquires one of the six aptitude factors. The six aptitude factors individually correspond to the turf aptitude, the dirt aptitude, the short-distance aptitude, the mile aptitude, the intermediate-distance aptitude, and the long-distance aptitude. For example, in the case where the nurtured characters of the first inheritance generation or the second inheritance generation include a nurtured character having the turf factor, the aptitude parameter for the turf aptitude of the main character is raised.

Note that each aptitude factor also has an invocation timing and an invocation condition set therefor, and it is determined whether or not to invoke each aptitude factor in the same factor invoking turns as for the basic ability factors. In the case where it is determined to invoke an aptitude factor, the corresponding aptitude parameter is raised by one level. In one example, the invocation probability of each aptitude factor in the 1st turn is set to 100% irrespective of the factor level.

As an example, suppose that the aptitude factors of the three nurtured characters belonging to the first inheritance group are individually the turf factor, the short-distance factor, and the mile factor and that the aptitude factors of the three nurtured characters belonging to the second inheritance group are individually the turf factor, the short-distance factor, and the intermediate-distance factor. In this case, the turf aptitude and short-distance aptitude of the main character are individually raised by two levels, and the mile aptitude and intermediate-distance aptitude thereof are individually raised by one level.

As another example, suppose that the aptitude factors of the three nurtured characters belonging to the first inheritance group are all the turf factor and that the aptitude factors of the three nurtured characters belonging to the second inheritance group are all the short-distance factor. In this case, the turf aptitude and short-distance aptitude of the main character are individually raised by three levels. As yet another example, suppose that the aptitude factors of the three nurtured characters belonging to the first inheritance group are all the turf factor and that the aptitude factors of the three nurtured characters belonging to the second inheritance group are individually the turf factor, the short-distance factor, and the mile factor. In this case, the turf aptitude of the main character is raised by four levels, and the short-distance aptitude and mile aptitude thereof are individually raised by one level.

Note, however, that a limit is set to the value by which an aptitude parameter is raised in the 1st turn. Specifically, the upper limit for all the aptitude parameters is set to A in the 1st turn. Therefore, assuming the case where the initial value of the turf aptitude of the main character is A, the turf aptitude is not raised in the 1st turn even if a character to inherit has the turf factor.

Meanwhile, in the 30th turn and in the 54th turn, for each aptitude factor, a lottery is performed to determine whether or not to invoke the aptitude factor on the basis of the factor level thereof. In one example, in the 30th turn and in the 54th turn, the invocation probability of each aptitude factor of level 3 is set to 5%, the invocation probability of each aptitude factor of level 2 is set to 3%, and the invocation probability of each aptitude factor of level 1 is set to 1%. When it is determined to invoke an aptitude factor through a lottery in the 30th turn or in the 54th turn, the aptitude parameter corresponding to the aptitude factor is raised. Note that in the 30th turn and in the 54th turn, the upper limit for each aptitude is increased from A to S. Therefore, in the 30th turn and in the 54th turn, it is possible to raise the value of an aptitude parameter to S at most by invoking an aptitude factor.

Note that the values of the aptitude parameters that have been raised in the 1st turn are displayed in the aptitude-parameter displaying part 152b of the character-to-inherit selection screen 170.

The race factors serve to raise the ability parameters of the main character. The race factors are provided individually for races having high difficulty levels (hereinafter referred to as factor subject races), such as GI races, among races in which participation is possible in the main nurturing game. At the completion of the nurturing game, for each factor subject race in which the main character won the first place, a lottery is performed to determine whether or not to acquire a race factor. A nurtured character can acquire a race factor by winning such a lottery.

Note that each race factor also has a factor level set therefor, and a factor level is determined through a lottery for each race factor that has been determined to be acquired. Furthermore, here, there is no upper limit to the number of race factors that one nurtured character can acquire, and each nurtured character can acquire a plurality of race factors.

Each race factor has set therefor an ability parameter to be raised as a result of the invocation thereof, as well as a value by which the ability parameter is raised. For example, the race factors include a race factor with which the speed ability parameter is raised and a race factor with which the power ability parameter is raised. At this time, the value by which the ability parameter is raised becomes greater as the factor level becomes higher.

Furthermore, each race factor also has an invocation timing and an invocation condition set therefor, and it is determined whether or not to invoke each race factor in factor invoking turns. In the case where it is determined to invoke a race factor, the ability parameter corresponding to the race factor is raised. Note that the factor invoking turns for race factors are limited to the 30th turn and the 54th turn. Furthermore, the invocation probability of each race factor in the factor invoking turns varies depending on the factor level thereof, and the invocation probability becomes higher as the factor level becomes higher.

The character factors are character-specific factors. For example, only in the case where a character that has been strengthened to a prescribed level is nurtured as the main character, the character factor set to that character is necessarily granted to the nurtured character at the completion of the nurturing game. Note that since only one character factor is set to one character, one nurtured character can acquire one character factor at most. Furthermore, it is not possible to acquire a character factor in the case where a nurtured character is generated on the basis of a character that has not been strengthened to a prescribed level.

Furthermore, a character factor can be invoked in a preset factor invoking turn, and is invoked as a result of winning a lottery executed in the factor invoking turn. When a character factor is invoked, a hint event set for each character factor occurs, and it becomes possible to acquire a hint for a skill, as described earlier.

The skill factors are assigned on the basis of acquired skills that have been acquired by a nurtured character. Specifically, at the completion of the nurturing game, for each acquired skill that has been acquired by the nurtured character, a lottery is performed to determine whether or not to acquire a skill factor. The skill factor is assigned to the nurtured character when the lottery is won. That is, the nurtured character can acquire some or all of the skill factors corresponding to acquired skills that have been acquired. Note that when it is determined to acquire a skill factor, the factor level of the skill factor is determined through a lottery.

Furthermore, each skill factor can be invoked in a preset factor invoking turn, and is invoked as a result of winning a lottery executed in the factor invoking turn. At this time, the winning probability becomes higher as the factor level becomes higher. When a skill factor is invoked, a hint event set for each skill factor occurs, and it becomes possible to acquire a hint for a skill. This makes it possible for the main character to acquire skills similar to acquired skills acquired by characters to inherit, etc.

As described above, whether or not to acquire skill factors is determined within the range of acquired skills that have been acquired by nurtured characters. Therefore, the possibility of acquiring skill factors becomes higher as the number of skills acquired by the nurtured character becomes greater. Note, however, that since whether or not to acquire a skill factor is determined through a lottery, there are cases where it is not possible to acquire a skill factor even if the number of acquired skills is large.

Note that although it is assumed here that a nurtured character acquires skill factors separately from acquired skills, instead of providing skill factors, skills that can be acquired by the main character may be determined on the basis of acquired skills possessed by nurtured characters serving as characters to inherit.

As described above, the ability parameters of the main character considerably vary depending on characters to inherit that are incorporated into the deck. Furthermore, since whether or not to acquire factors are determined through lotteries, even if a nurtured character itself has high abilities, the nurtured character having high abilities is not necessarily suitable as a character to inherit. Meanwhile, even in the case where a nurtured character itself does not have high abilities, the nurtured character may work effectively as a character to inherit as a result of acquiring a large number of factors having high factor levels. As described above, by making it possible to incorporate characters to inherit in the deck, the fun of nurturing nurtured characters that are effective as characters to inherit, in addition to simply nurturing strong nurtured characters, is provided.

Furthermore, in this embodiment, compatibility is determined among the main character, nurtured characters of the first inheritance generation, and nurtured characters of the second inheritance generation. Furthermore, the invocation conditions of factors become advantageous in the case of combinations of characters having high compatibility.

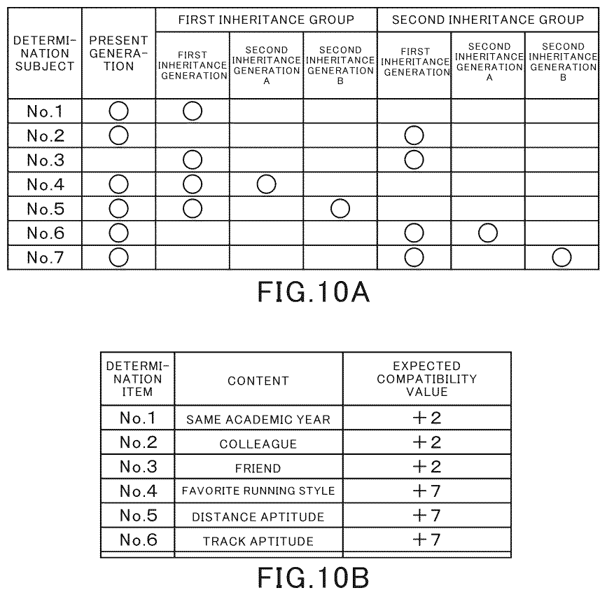

FIG. 10A is a figure for explaining subjects for determining compatibility, and FIG. 10B is a figure for explaining items concerning which compatibility is determined. As shown in FIG. 10A, in this embodiment, seven determination subjects No. 1 to No. 7 are provided. A first determination subject (No. 1) is the main character of the present generation and the nurtured character of the first inheritance generation in the first inheritance group. A second determination subject (No. 2) is the main character of the present generation and the nurtured character of the first inheritance generation in the second inheritance group.

A third determination subject (No. 3) is the nurtured character of the first inheritance generation in the first inheritance group and the nurtured character of the first inheritance generation in the second inheritance group. A fourth determination subject (No. 4) is the main character of the present generation, the nurtured character of the first inheritance generation in the first inheritance group, and one (nurtured character A) of the nurtured characters of the second inheritance generation in the first inheritance group. A fifth determination subject (No. 5) is the main character of the present generation, the nurtured character of the first inheritance generation in the first inheritance group, and the other one (nurtured character B) of the nurtured characters of the second inheritance generation in the first inheritance group.

A sixth determination subject (No. 6) is the main character of the present generation, the nurtured character of the first inheritance generation in the second inheritance group, and one (nurtured character A) of the nurtured characters of the second inheritance generation in the second inheritance group. A seventh determination subject (No. 7) is the main character of the present generation, the nurtured character of the first inheritance generation in the second inheritance group, and the other one (nurtured character B) of the nurtured characters of the second inheritance generation in the second inheritance group.

For each of the above determination subjects, it is determined whether or not a condition is satisfied for each of a plurality of determination items. FIG. 10B shows an example of determination items. In this embodiment, the worldview of the game is set such that characters that can be selected as the main character are students and such that the individual characters perform training in school.

Furthermore, as shown in FIG. 10B, settings are made for each character, such as the academic year, colleagues, and friends. The determination items include, for example, whether or not two or three characters constituting the determination subject are in the same academic year, are colleagues, and are friends. Furthermore, the determination items include whether or not the favorite running styles, distance aptitudes, and track aptitude of the characters constituting the determination subject coincide with each other.

Furthermore, each determination item has an expected compatibility value associated therewith, and the expected compatibility values of determination items that are satisfied among the characters constituting the determination subject are accumulated. Although the expected compatibility values vary among the determination items, an expected compatibility value may be shared among all the determination items.

For example, in the case where compatibility is determined, first, whether or not each of all the determination items is satisfied between the main character of the present generation and the nurtured character of the first inheritance generation in the first inheritance group, constituting the first determination subject. At this time, the expected compatibility values associated with the satisfied determination items are accumulated and calculated. The calculation of the expected compatibility values is performed in the manner described above sequentially for the first determination subject to the seventh determination subject, and the invocation probabilities of factors are corrected on the basis of the expected compatibility value calculated as the final result. That is, the invocation probabilities of all the factors become higher as the expected compatibility value becomes higher, and the invocation probabilities of all the factors become lower as the expected compatibility value becomes lower.

Note that the invocation probabilities may be calculated by using the calculated expected compatibility value as a correction value. Alternatively, for example, the arrangement may be such that correction values for correcting the invocation probabilities of factors are set for individual compatibility levels and such that compatibility levels may be determined by using the calculated expected compatibility value.

Since the invocation probabilities of factors vary depending on the compatibility between the main character and characters to inherit or the compatibility between characters to inherit, as described above, the combination of two characters to inherit considerably affects the nurturing of the main character. That is, compatibility among characters is an important determination criterion in selecting characters to inherit.

As shown in FIGS. 7B, 7C, and 7D, in the state where characters to inherit are selected, a compatibility mark indicating compatibility is displayed in an upper right part of the character-to-inherit selection screen 170 and the nurtured-character list screen 180. Here, the compatibility level depending on the currently selected characters is indicated by using three compatibility marks, namely, a double circle symbol, a single circle symbol, and a triangle symbol. Note that, as shown in FIG. 7A, no compatibility mark is displayed in the state where characters to inherit are not selected.

Furthermore, as shown in FIG. 7B, a display switching button 183 is provided in the nurtured-character list screen 180. When the display switching button 183 is operated, a display-condition setting screen, which is not shown, is displayed. In the display-condition setting screen, the player can make a setting for rearranging the order of the nurtured-character icons 182 displayed in the nurtured-character list screen 180, i.e., the nurtured characters that can be selected as characters to inherit, and can narrow down the nurtured-character icons 182.

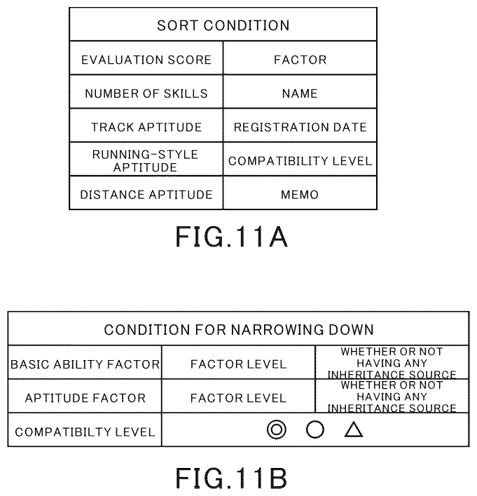

FIG. 11A is a figure for explaining sort conditions. FIG. 11B is a figure for explaining narrow-down conditions. In the display-condition setting screen, the player can select and set the sort conditions shown in FIG. 11A. Here, as a sort condition, it is possible to select and set one of an evaluation score, a factor, the number of skills, a name, a track aptitude, a registration date, a running-style aptitude, a compatibility level, a distance aptitude, and a memo. When a sort condition has been set, the nurtured-character list screen 180 is displayed. At this time, in the nurtured-character list screen 180, the order of display of the nurtured-character icons 182 has been changed according to the sort condition.

Furthermore, in the display-condition setting screen, the player can select and set the narrow-down condition shown in FIG. 11B. Here, a basic ability factor, an aptitude factor, and a compatibility level are provided as narrow-down conditions. Note that when a basic ability factor or an aptitude factor has been set as a narrow-down condition, only the nurtured characters having the factor selected by the player are displayed in the nurtured-character list screen 180.

At this time, the player can set a factor level. For example, when nurtured characters are narrowed down while setting the factor level to level 3, only the nurtured characters having factors with the factor level of level 3 among the factors selected by the player are displayed in the nurtured-character list screen 180. Note that the player can narrow down nurtured characters by selecting whether nurtured characters themselves have factors or inherited characters of nurtured characters have factors.

Furthermore, the player can narrow down nurtured characters on the basis of compatibility levels. Here, it is possible to narrow down nurtured characters to those having the compatibility indicated by a double circle symbol, to those having the compatibility indicated by a single circle symbol, or to those having the compatibility indicated by a triangle symbol. As described above, it is possible to sort or narrow down nurtured characters by using various conditions, which improves convenience for the player.

Furthermore, when one of the nurtured-character icons 182 is held in the nurtured-character list screen 180 shown in FIG. 7B, detailed information concerning the nurtured character corresponding to the nurtured-character icon 182 is displayed.

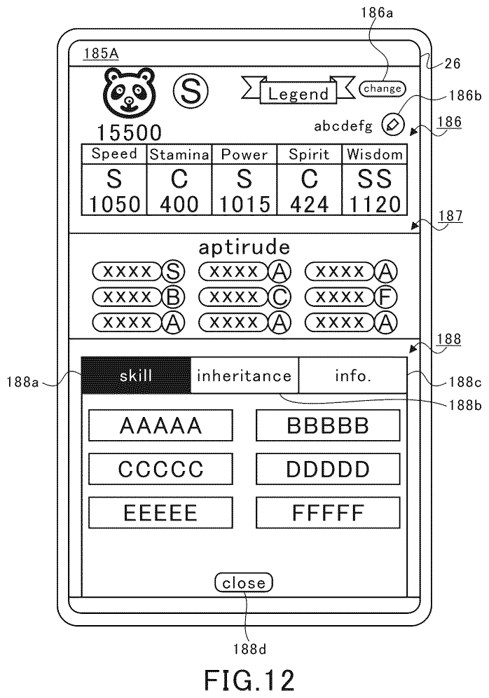

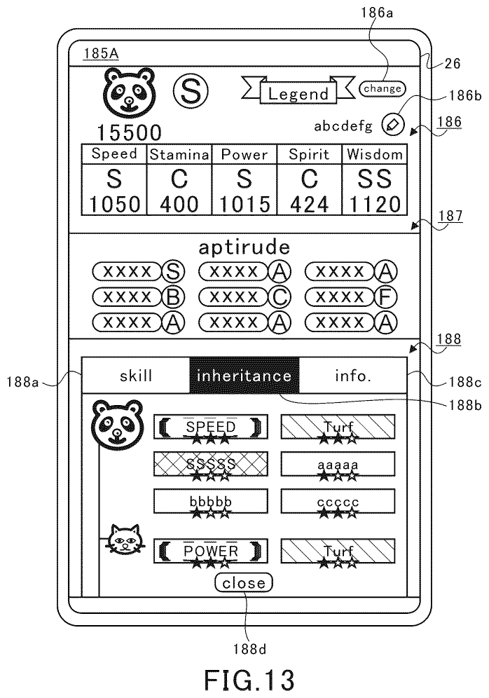

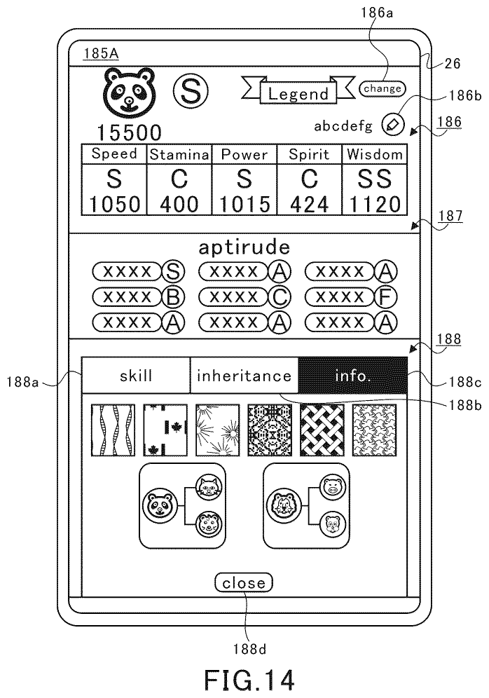

FIG. 12 is a first illustration for explaining a character detail dialog 185A. FIG. 13 is a second illustration for explaining the character detail dialog 185A. FIG. 14 is a third illustration for explaining the character detail dialog 185A. In the character detail dialog 185A, detailed information concerning a nurtured character is displayed. In an upper part of the character detail dialog 185A, an ability-parameter display field 186 indicating the ability parameters of the nurtured character is displayed.

In a left part above the ability-parameter display field 186, an icon indicating the character serving as the basis of the nurtured character, as well as the evaluation score and nurturing rank of the nurtured character, are displayed. Furthermore, in a right part above the ability-parameter display field 186, a nickname change button 186a and a memo input button 186b are provided. When the nickname change button 186a is tapped, a nickname list screen, which is not shown, is displayed. In the nickname list screen, a list of nicknames acquired by nurtured characters is displayed. Note that a large number of nicknames are provided in the main nurturing game, and acquiring conditions are set for all the nicknames.

In the main nurturing game, nicknames for which acquiring conditions are satisfied are assigned to nurtured characters. The player can select one of the nicknames acquired by a nurtured character and set the nickname to the nurtured character. The player can change the nickname set to a nurtured character in the nickname list screen. On the left side of the nickname change button 186a, the currently set nickname (Legend here) is displayed.

Note that example conditions for acquiring nicknames include the condition that the main character has acquired a prescribed number of fans, the condition that an ability parameter or an aptitude parameter is greater than or equal to a prescribed value, the condition that a prescribed skill has been acquired, the condition that the number of races won is greater than or equal to a prescribed number, the condition that a prescribed place (e.g., the first place) has been won in a specific race, etc.

Meanwhile, when the memo input button 186b is tapped, a character input screen, which is not shown, is displayed. In the character input screen, for example, it is possible to input nine characters at most in hiragana, katakana, numerals, Roman letters, etc. The characters input via the character input screen are stored as a memo in association with the nurtured character. In the case where a memo is stored for the nurtured character, a memo (abcdefg here) is displayed on the left side of the memo input button 186b.

Note that the sort conditions for the nurtured-character icons 182 in the nurtured-character list screen 180 include the memo mentioned above. Therefore, it becomes even easier to search for nurtured characters to use as characters to inherit by registering memos in association with nurtured characters.

Furthermore, an aptitude-information display field 187 is displayed under the ability-parameter display field 186. In the aptitude-information display field 187, the aptitude parameters relating to the individual track aptitudes for turf and dirt, the aptitude parameters relating to the individual distance aptitudes for short distance, mile, intermediate distance, and long distance, and the aptitude parameters relating to the individual running-style aptitudes for early speed, front running, stretch running, and closing are displayed.

Under the aptitude-information display field 187, a various-kinds-of-information display field 188 is displayed. In the various-kinds-of-information display field 188, a skill display tab 188a, an inheritance-information display tab 188b, a nurturing-information display tab 188c, and a close operating part 188d are provided. When the skill display tab 188a is tapped, as shown in FIG. 12, the acquired skills of the nurtured character are displayed in the various-kinds-of-information display field 188. Meanwhile, when the inheritance-information display tab 188b is tapped, as shown in FIG. 13, the inheritance information of the nurtured character is displayed.

Note that the inheritance information is displayed in the various-kinds-of-information display field 188 on the basis of nurtured characters that can be set as characters to inherit and the inherited characters used in nurturing the nurtured character. The inheritance information includes information concerning the inherited characters used in nurturing the nurtured character, factor information possessed by the nurtured character, and factor information possessed by the inherited characters. Here, a list of items of inheritance information is displayed for each nurtured character.

Specifically, factor information associated with each nurtured character and factor information associated with the inherited characters of the nurtured character are displayed on a per-character basis. Therefore, by scrolling the various-kinds-of-information display field 188 in the upward or downward direction, the player can confirm the factor information possessed by each of the three characters.

In the various-kinds-of-information display field 188, the basic ability factors, the aptitude factors, and the character factors are displayed in different colors. For example, the basic ability factors are displayed in blue, the aptitude factors are displayed in red, and the character factors are displayed in green. Note that the race factors and the skill factors are individually displayed in white in the various-kinds-of-information display field 188. Furthermore, stars indicating the factor level is displayed in a manner superimposed on each item of factor information.

Meanwhile, when the nurturing-information display tab 188c is tapped, as shown in FIG. 14, nurturing information of the nurtured character is displayed. Note that the nurturing information includes the kinds of support cards used in nurturing the nurtured character, the characters of the first inheritance generation and the second inheritance generation, the records of individual races in the nurturing game, and the evaluation score.

As described above, the player can confirm various kinds of information concerning the nurtured character in the character detail dialog 185A. This makes it easier for the player to recognize information associated with characters to inherit incorporated into the deck, which improves convenience for the player.

Note that when the close operating part 188d is tapped in the character detail dialog 185A, the character detail dialog 185A is closed, and the nurtured-character list screen 180 is displayed on the display 26. Furthermore, as shown in FIGS. 7A, 7B, 7C, and 7D, a skill display button 172 is provided in a right part above the character-to-inherit selection screen 170 and the nurtured-character list screen 180. When the skill display button 172 is tapped, a list of skills that may be acquired by the nurtured character tentatively selected as a character to inherit is displayed.

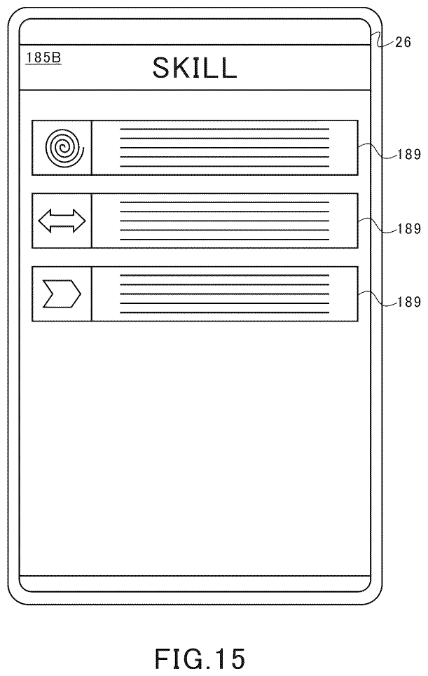

FIG. 15 is an illustration for explaining a skill display dialog 185B. In the skill display dialog 185B, icons corresponding to skills, as well as skill-explanation display fields 189 describing the content of the skills, are displayed. In the skill-explanation display fields 189, a list of skills that may be acquired by the main character in the case where the currently selected nurtured character is used as a character to inherit is displayed.

That is, in the skill display dialog 185B, a list of items of information concerning skills associated with the character factors or skill factors possessed by the nurtured character is displayed. In the case where the skill display button 172 is tapped in the state where one nurtured character is selected as a character to inherit, as shown in FIG. 7C, the skills associated with the character factors and race factors possessed by the one nurtured character (character to inherit) are displayed in the skill display dialog 185B.

Meanwhile, in the case where the skill display button 172 is tapped in the state where two nurtured characters are selected as characters to inherit, as shown in FIG. 7D, the skills associated with the character factors and race factors possessed by the individual two nurtured characters (characters to inherit) are displayed in the skill display dialog 185B.

As described above, in this embodiment, in the character detail dialog 185A, a list of inheritance information (factor information) is displayed for each nurtured character that can be set as a character to inherit. Furthermore, in the skill display dialog 185B, a list of items of information (skills) associated with the inheritance information (factor information) is displayed. At this time, the character detail dialog 185A and the skill display dialog 185B are displayed on the basis of nurtured characters that can be set as characters to inherit as well as inherited characters used in generating the nurtured characters. The displaying of the character detail dialog 185A and the skill display dialog 185B improves convenience for the player.

Note that it is assumed here that skills that can be acquired by invoking factors are shown in the skill display dialog 185B. Alternatively, however, instead of information concerning skills, factor information from which hints for skills can be obtained may be displayed in the skill display dialog 185B. In either case, it suffices that inheritance information (factor information) is classified into a plurality of kinds (factor kinds) and that inheritance information (character factors and race factors) classified into a prescribed kind or information associated with the inheritance information (information concerning skills) is displayed in the skill display dialog 185B. It can be said that a portion of inheritance information is extracted and information concerning the extracted inheritance information is displayed in the skill display dialog 185B, as described above.

Furthermore, when two nurtured characters are tentatively selected, the next operating part 154 provided in the character-to-inherit selection screen 170 becomes enabled. When the next operating part 154 that has become enabled is tapped, the tentatively selected nurtured characters are tentatively registered in the deck as characters to inherit, and a support-card incorporation screen 190, which will be described later, is displayed.

Note that the player has to necessarily select two nurtured characters as characters to inherit in the character-to-inherit selection screen 170. In the case where two characters to inherit are not tentatively selected, as shown in FIGS. 7A and 7C, the next operating part 154 is grayed out, which prohibits player operations from being accepted. Furthermore, the return operating part 153 is provided in the character-to-inherit selection screen 170, and the main-character selection screen 150 is displayed when the return operating part 153 is tapped.

### <Registration of Support Cards>

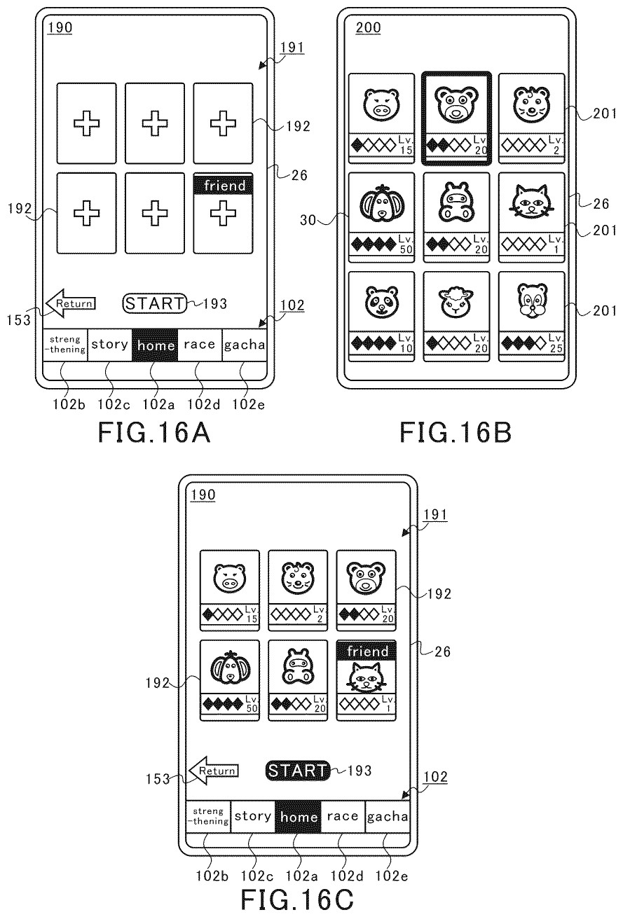

FIG. 16A is a first illustration for explaining a support-card incorporation screen 190. When two characters-to-inherit have been registered in the character-to-inherit selection screen 170, the support-card incorporation screen 190 shown in FIG. 16A is displayed. A support-card display area 191 is provided in a central part of the support-card incorporation screen 190. The support-card display area 191 includes a plurality of support-card display frames 192. Furthermore, in a lower part of the support-card incorporation screen 190, a return operating part 153 labeled as “Return” and a start operating part 193 labeled as “START” are displayed.

In the support-card display area 191, a plurality of (six here) support-card display frames 192 are displayed. The same number of support-card display frames 192 as the number of support cards that can be set by the player are displayed. Note that the support-card display frames 192 are initially displayed as being blank when the support-card incorporation screen 190 is displayed.

In this embodiment, the player can set six kinds of support cards in the deck. Note that some (e.g., five kinds) among the six kinds that can be set by the player can be selected from the support cards possessed by the player. Furthermore, other some (e.g., one kind) among the six kinds that can be set by the player can be selected from the support cards set as rental cards by other players such as friends.

FIG. 16B is an illustration for explaining a support-card selection screen 200. When one of the support-card display frames 192 (except the support-card display frame 192 displayed at the lower right) is tapped in the support-card incorporation screen 190 in FIG. 16A, the support-card selection screen 200 shown in FIG. 16B is displayed on the display 26. In the support-card selection screen 200, a list of card icons 201 corresponding to the support cards possessed by the player is displayed. The player can select a support card by tapping one of the card icons 201 displayed in the support-card selection screen 200.

Note that although not shown, when the support-card display frame 192 displayed at the lower right in the support-card incorporation screen 190 is tapped, support cards set as rental cards by friends or by players extracted on the basis of a prescribed condition, such as a lottery, are displayed in the support-card selection screen 200. At this time, the player can select a support card of a friend by tapping one of the support cards displayed in the support-card selection screen 200. As described above, the player can use support cards possessed by other players in the nurturing game.

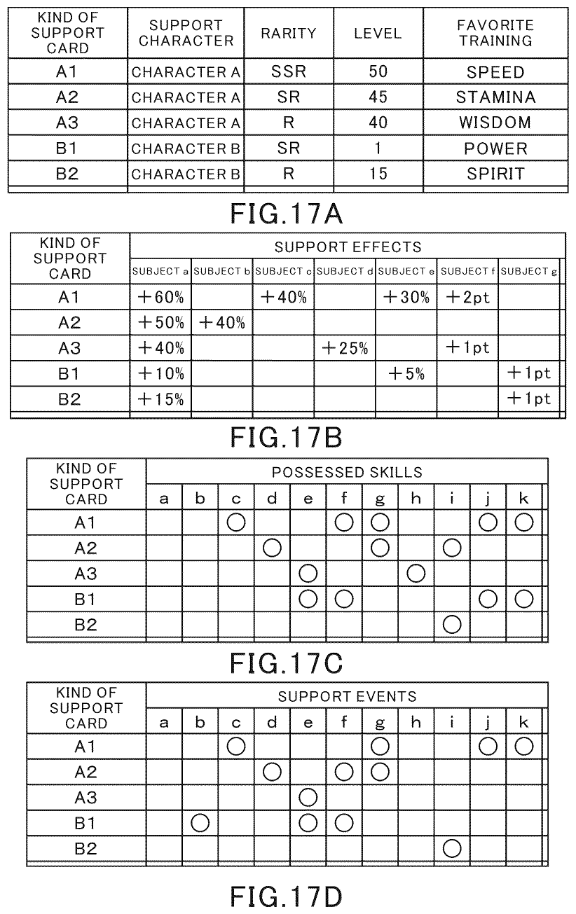

FIG. 17A is an illustration for explaining a support card table. As shown in FIG. 17A, in the support card table, the kinds of support characters (i.e., character IDs), rarities, levels, and favorite kinds of training are stored for individual types of support cards (i.e., support card IDs) possessed by the player. The support characters correspond to the types of support cards one by one. That is, each support card ID necessarily has one character ID associated therewith. In other words, each support card necessarily corresponds to one support character.

In this embodiment, rarities are set for individual support cards. Three levels, namely, R (rare), SR (super rare), and SSR (super special rare), are provided as the rarities. R indicates that the lowest rarity is set, and SSR indicates that the highest rarity is set. In this embodiment, support cards having higher rarities tend to exhibit greater support effects, which will be described later. Furthermore, in this embodiment, the numbers of possessed skills and the numbers of support events, which will be described later, tend to be greater with support cards having higher rarities.

As the levels of support cards, 50 levels, namely, level 1 to level 50, are provided. The player can advance the levels of support cards, and the levels advanced by the player are stored for individual support cards. Note that it is possible to advance the levels of support cards by using an in-game currency, items, or the like. Note that an upper limit is set for the level of each support card depending on the rarity.

For example, level 20 is defined as an upper limit for support cards with the rarity R, level 25 is defined as an upper limit for support cards with the rarity SR, and level 30 is defined as an upper limit for support cards with the rarity SSR.

Note that the level upper limits can be progressively raised in the case where prescribed conditions are satisfied. For example, the upper limit for support cards with the rarity R can be raised up to level 40 at most, the upper limit for support cards with the rarity SR can be raised up to level 45 at most, and the upper limit for support cards with the rarity SSR can be raised up to level 50 at most.

FIG. 17B is a figure for explaining a support effect table. As shown in FIG. 17B, in the support effect table, support effects are stored for the individual kinds of support cards possessed by the player.

Support effects raise various kinds of statuses in the main nurturing game. Support cards have a plurality of kinds of support effects. Example kinds of support effects include physical energy, speed, stamina, power, spirit, and wisdom.

FIG. 17C is a figure for explaining a possessed skill table. As shown in FIG. 17C, in the possessed skill table, possessed skills are set for the individual support cards possessed by the player. In this embodiment, possessed skills are set for individual support cards such that the character set by the player as the main character possesses the possessed skills. It becomes possible for the main character selected by the player to acquire each of the possessed skills set for the individual support cards when a hint event occurs during the main nurturing game.

FIG. 17D is a figure for explaining a support event table. As shown in FIG. 17D, in the support event table, support events that may occur are stored for the individual support cards possessed by the player. Support events refer to events that may occur during the execution of the main nurturing game. In the case where a support event has occurred, there are cases where the value of one of the various kinds of statuses in the main nurturing game increases or decreases.

For example, a support event that occurs may be determined depending on the number of turns, or a support event that occurs may be determined through a prescribed lottery. Furthermore, a plurality of support events that occur may be selected for one turn. In either case, it suffices to determine a support event that occurs according to a prescribed determination method set in advance.

Note that support events include first hint events, which may occur at the start of a turn in the nurturing game, second hint events, which may occur after the execution of training in the nurturing game, which will be described later, first ability events, which may occur at the start of a turn in the nurturing game, second ability events that may occur after the execution of training in the nurturing game, etc. The first hint events and second hint events are events that make it possible to possess or acquire skills. Furthermore, the first ability events and second ability events are events in which the numerical values of ability parameters of characters are increased or decreased. Hereinafter, the first hint events and first ability events will be collectively referred to as first events, and the second hint events and second ability events will be collectively referred to as second events.

FIG. 16C is a second illustration for explaining the support-card incorporation screen 190. In this embodiment, when all the six support cards have been selected, as shown in FIG. 16C, it becomes possible to operate the start operating part 193. Meanwhile, in the case where all the six support cards have not been selected, as shown in FIG. 16A, it is prohibited to operate the start operating part 193.

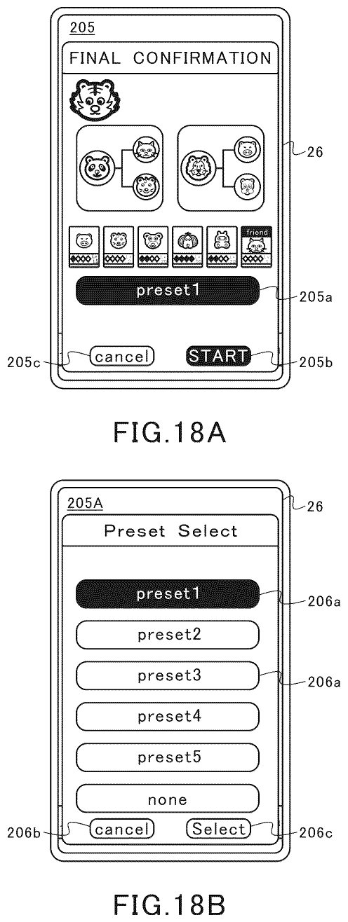

Note that when the return operating part 153 is operated in the support-card incorporation screen 190, the character-to-inherit selection screen 170 shown in FIG. 7D is displayed on the display 26. Furthermore, as shown in FIG. 16C, when the start operating part 193 is tapped in the support-card incorporation screen 190, the selected support cards are tentatively registered, and a final confirmation screen 205 (FIG. 18A) is displayed on the display 26.

FIG. 18A is an illustration for explaining the final confirmation screen 205. FIG. 18B is an illustration for explaining a preset selection screen 205A. In the final confirmation screen 205, the main character selected by the player, the nurtured characters constituting the first inheritance group, the nurtured characters constituting the second inheritance group, and support cards are displayed. Furthermore, in the final confirmation screen 205, a preset displaying part 205a is displayed. In the preset displaying part 205a, the number of the currently selected preset is shown.

Here, a preset refers to reservation information for a race in which the main character is to participate in the main nurturing game. The player can create a preset by selecting an arbitrary race from all races. It is possible to save a plurality of presets, and it is possible to select one of the saved presets in the final confirmation screen 205. Specifically, when the preset displaying part 205a is tapped, the preset selection screen 205A shown in FIG. 18B is displayed.

In the preset selection screen 205A, preset read-out buttons 206a corresponding to saved presets are displayed. The player can set a preset by tapping one of the preset read-out buttons 206a and then tapping a select operating part 206c. Note that when the select operating part 206c is tapped, the preset selection screen 205A is closed, and the final confirmation screen 205 is displayed. Meanwhile, when a cancel operating part 206b in the preset selection screen 205A is tapped, the preset selection screen 205A is displayed without changing presets.

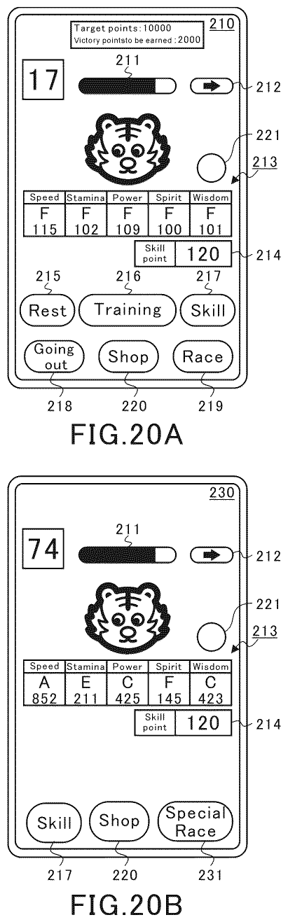

Note that when a cancel operating part 205c is tapped in the final confirmation screen 205, the support-card incorporation screen 190 is displayed. Meanwhile, when a start operating part 205b is tapped, the game screen 210 (FIG. 20A) is displayed on the display 26.

Note that in this embodiment, a restriction is imposed such that when support cards are registered, there is no overlapping between the kinds of characters set as the main character and the kinds of characters set as support characters.

When the main character, characters to inherit, and support cards are registered, as described above, the preparation stage process is finished.

### <Nurturing Stage Process>

When the preparation stage process is finished, a nurturing stage process is started. In the nurturing stage process, it becomes possible to nurture a main character. Note that in the following, in order to facilitate understanding, the basic flow of the main nurturing game will be described first.

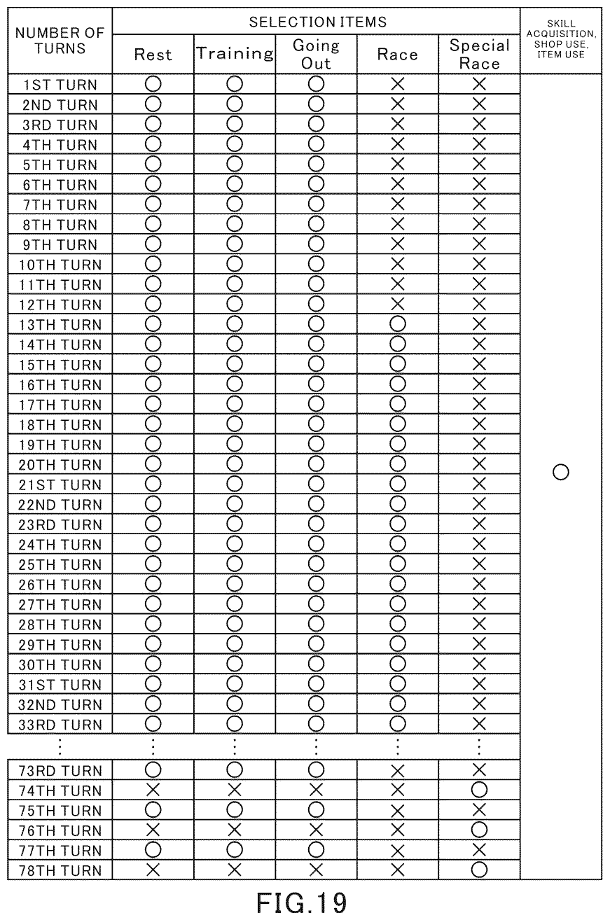

FIG. 19 is a figure for explaining a selection item table. Note that a selection item table is provided for each type of main character here. Alternatively, however, a shared selection item table may be provided irrespective of the type of main character. As shown in FIG. 19, the nurturing game consists of the 1st turn to the 78th turn, and is designed such that various kinds of parameters are updated in accordance with the results of player selections in the individual turns. Furthermore, with the selection item table, items that can be selected by the player are set in advance for each turn.

FIG. 20A is an illustration for explaining a game screen 210. FIG. 20B is an illustration for explaining a special-race screen 230. Upon a transition to the nurturing stage process, the game screen 210 shown in FIG. 20A is displayed on the display 26. In an upper part of the game screen 210, a physical-energy displaying part 211 and a character-condition displaying part 212 are displayed. The main character has a “physical energy” parameter set thereto. The “physical energy” parameter is mainly used to calculate a failure rate, which is the probability of failure in training, which will be described later. The physical-energy displaying part 211 is displayed so that the current remaining amount of “physical energy” of the main character can be recognized visually in relation to an upper limit value of “physical energy”.

Furthermore, the main character has a “character condition” parameter set thereto. The character-condition displaying part 212 is displayed so that the current “character condition” of the main character can be recognized visually in terms of one of a plurality of levels (five levels consisting of terrible, poor, average, good, and great). As the “character condition” parameter becomes greater, the main character can proceed with a race advantageously, and the value by which an ability parameter is increased through training becomes greater.

Furthermore, as shown in FIG. 20A, in a central part of the game screen 210, an image of the main character, a status displaying part 213, and a skill-point displaying part 214 are displayed. In the status displaying part 213, the current statuses of the main character are displayed in terms of numerical values and ranks among a plurality of levels (sixteen levels consisting of G⁺, F, F⁺, E, E⁺, D, D⁺, C, C⁺, B, B⁺, A, A⁺, S, SS, and SS⁺). Specifically, in this embodiment, numerical values and ranks of the following individual ability parameters are displayed: “speed”, “stamina”, “power”, “spirit”, and “wisdom”. Furthermore, in the skill-point displaying part 214, the remaining amount of skill points possessed by the main character in the nurturing game is indicated in terms of a numerical value.

Furthermore, as shown in FIG. 20A, in a lower part of the game screen 210, the following operating parts are displayed: a rest operating part 215 labeled as “Rest”; a training operating part 216 labeled as “Training”; a skill operating part 217 labeled as “Skill”; a going-out operating part 218 labeled as “Going Out”; an individual-race operating part 219 labeled as “Race”; and a shop operating part 220 labeled as “Shop”. Furthermore, the current number of turns is displayed in an upper part of the game screen 210. Furthermore, an item operating part 221 is displayed in a central part of the game screen 210.

As shown in FIG. 19, the player can select one of “Rest” (the rest operating part 215), “Training” (the training operating part 216), “Going Out” (the going-out operating part 218), “Race” (the individual-race operating part 219), and “Special Race” (a special-race operating part 231), which will be described later, in each turn. At this time, as shown in FIG. 19, items that can be selected in each turn are set in advance.

The physical energy is recovered when the item “Rest” is selected, whereas the character condition is improved when the item “Going Out” is selected. Meanwhile, it becomes possible to execute training described later when the item “Training” is selected, it becomes possible to let the main character participate in an individual race when the item “Race” is selected, and it becomes possible to let the main character participate in a special race described later when the item “Special Race” is selected. After one of these items “Rest”, “Training”, “Going Out”, “Race”, and “Special Race” is selected and a game result is derived, the current turn comes to an end, and the game proceeds to the next turn.

In this embodiment, turns in which it is not possible to select the rest operating part 215, the training operating part 216, the going-out operating part 218, or the individual-race operating part 219 are set, like the 74th turn, the 76th turn, and the 78th turn shown in FIG. 19. In such turns, as shown in FIG. 20B, the special-race screen 230 is displayed on the display 26.

In the special-race screen 230, a special-race operating part 231 labeled as “Special Race”, a skill operating part 217, a shop operating part 220, and an item operating part 221 are displayed, and the player can select one of these operating parts. When the special-race operating part 231 is selected, a special race is executed, which is different from an individual race that is executed in the case where the individual-race operating part 219 is selected. In the special race, three races in total are executed, specifically, one race in each of the 74th turn, the 76th turn, and the 78th turn, and the champion is determined on the basis of the cumulative value of victory points described later.

Meanwhile, settings are made such that it is constantly possible to select the skill operating part 217, the shop operating part 220, and the item operating part 221 in all turns. As will be described later in detail, even if a skill is acquired, a shop is used, or an item is used by operating the skill operating part 217, the shop operating part 220, or the item operating part 221, the current turn is not finished.

In this embodiment, when an individual race or a special race is executed, the main character can acquire victory points or an amount of a special currency depending on the place in the race. For each race, victory points and the amounts of the special currency that can be acquired are defined for individual places. Victory points and the numerical value of the special currency that are acquired become greater as the place becomes higher.

Furthermore, it is possible to acquire greater victory points and a greater amount of the special currency as the difficulty level of the race becomes higher. For example, it is possible to acquire greater victory points and a greater amount of the special currency as grade of the race becomes higher among grades such as GI, GII, and GIII.

In the nurturing game in this embodiment, predefined target points are set for each specified turn segment. As described earlier, the nurturing game is constituted of the 1st turn to the 78th turn. Here, the 1st turn to the 24th turn are referred to as an initial turn segment, the 25th turn to the 48th turn are referred to as a middle turn segment, the 49th turn to the 72nd turn are referred to as a late turn segment, and the 73rd turn to the 78th turn are referred to as a final turn segment.

The target points are set for each of the initial turn segment, the middle turn segment, and the late turn segment. The target points set for the individual turn segments may be the same or may vary. The player can proceed with the nurturing game to the final turn segment by making the cumulative value of victory points acquired in each of the turn segments sequentially reach the target points.

Furthermore, the target points are set on the basis of the aptitude parameters concerning the track aptitudes and the aptitude parameters concerning the distance aptitudes of the main character to be nurtured. As an example, the target points for a main character with which the turf aptitude parameter is higher than the dirt aptitude parameter are set to be higher than the target points for a main character with which the dirt aptitude parameter is higher than the turf aptitude parameter. As another example, different target points may be set depending on the kind of parameter that is the highest among the short-distance, mile, intermediate-distance, and long-distance aptitude parameters. Alternatively, different target points may be set depending on combinations of aptitude parameters concerning track aptitudes and distance aptitudes. As described above, there are cases where the target points set for individual main characters vary depending on aptitude parameters concerning track aptitudes or distance aptitudes. Note that the target points may be set on the basis of aptitude parameters concerning running-style aptitudes in addition to track aptitudes and distance aptitudes of the main character.

In an upper part of the game screen 210 shown in FIG. 20A, the target points in the current turn segment as well as remaining victory points, which are remaining victory points needed for reaching the target points, are displayed. With the target points and the remaining victory points displayed, the player can recognize victory points to be acquired in the current turn segment.

Note that the victory points acquired by the player are reset in each of the initial turn segment, the middle turn segment, and the late turn segment. Alternatively, however, the victory points acquired by the player may be accumulated sequentially without being reset in each turn segment.

When the target points are reached in all of the initial turn segment, the middle turn segment, and the late turn segment, it is possible to proceed to the nurturing game in the final turn segment. In the final turn segment, a special race consisting of three races in total (the first race, the second race, and the third race) is executed, and the champion is determined on the basis of the cumulative values of victory points depending on the race results.

With the progress of the special race, the value of victory points that can be acquired increases. Specifically, among the three races in total, the value of victory points that can be acquired for the first place in the second race is greater than the value of victory points that can be acquired for the first place in the first race, and the value of victory points that can be acquired for the first place in the third race is greater than the value of victory points that can be acquired for the first place in the second race.

Furthermore, what are called non-player characters (hereinafter referred to as NPCs) that participate in all the three races in order to compete with the main character for victories are NPCs having the same character IDs. However, settings are made such that the parameters of the NPCs become higher as the special race progresses. For example, the correction values that are applied to the ability parameters of the NPCs are increased in order of the first race, the second race, and the third race, thereby raising the ability parameters of the NPCs. Note that in the final turn segment, even if the place in the special race is a prescribed place or lower (e.g., the second place or lower), it is possible to continue the special race instead of finishing the nurturing game.

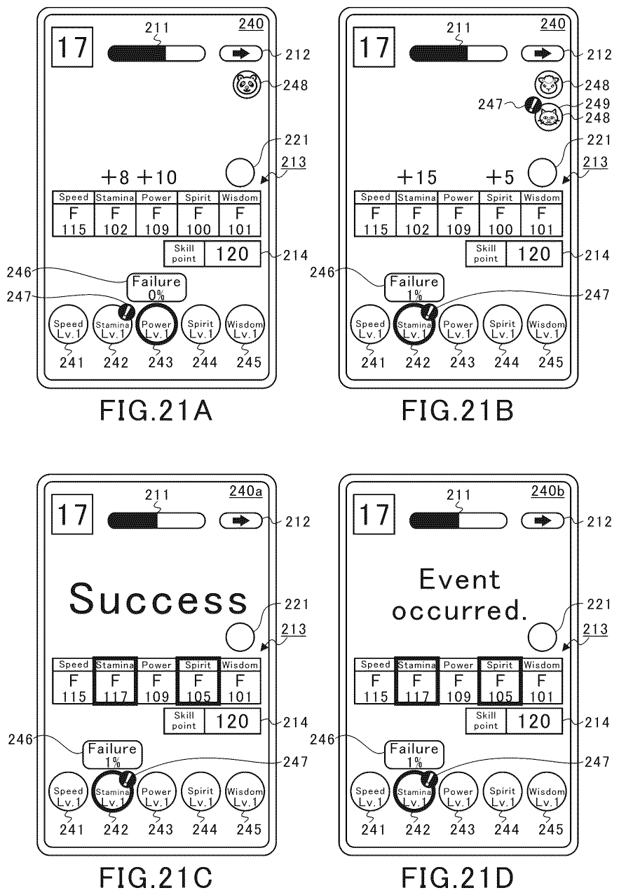

FIG. 21A is a first illustration for explaining a training screen 240. FIG. 21B is a second illustration for explaining the training screen 240. When the training operating part 216 in the game screen 210 is operated, the training screen 240 is displayed on the display 26.

As shown in FIG. 21A, training items are displayed in a lower part of the training screen 240. Here, the following operating parts are displayed: a speed operating part 241 labeled as “Speed”; a stamina operating part 242 labeled as “Stamina”; a power operating part 243 labeled as “Power”; a spirit operating part 244 labeled as “Spirit”; and a wisdom operating part 245 labeled as “Wisdom”.

When the player taps one of the individual operating parts 241 to 245 once, the training item corresponding to the tapped one of the operating parts 241 to 245 is tentatively selected, and the one of the operating parts 241 to 245 corresponding to the tentatively selected training item is displayed in a highlighted manner. FIG. 21A shows the state where the power operating part 243 is tentatively selected. Meanwhile, FIG. 21B shows the state where the stamina operating part 242 is tentatively selected.

Furthermore, in the individual operating parts 241 to 245, training levels for the individual training items are also displayed. A training level is a parameter that is raised on the basis of the number of times that each training item has been selected, and as the training level becomes higher, the value by which an ability parameter is raised when training is executed becomes greater. Each training level is initially set to 1, and is raised up to level 5 at most.

Furthermore, in tentatively selected one of the operating parts 241 to 245, a failure-rate displaying part 246 labeled as “Failure” is displayed. The failure rate displayed in terms of a numerical value in the failure-rate displaying part 246 is set so as to increase in inverse proportion to the remaining physical energy displayed in the physical-energy displaying part 211.

Furthermore, in the status displaying part 213, the values by which an ability parameter is raised when training corresponding to the tentatively selected one of the operating parts 241 to 245 is executed and is successful are displayed. For example, in the example shown in FIG. 21A, the power operating part 243 is tentatively selected, and “+8” is displayed for “Stamina” and “+10” is displayed for “Power” in the status displaying part 213. Meanwhile, in the example shown in FIG. 21B, the stamina operating part 242 is tentatively selected, and “+15” is displayed for “Stamina” and “+5” is displayed for “Spirit” in the status displaying part 213.

Furthermore, an event-report indication 247 is displayed in each one of the operating parts 241 to 245 corresponding to a training item with which a prescribed event occurs in the case where a training is executed and is successful. Note that the mode of displaying the event-report indication 247 may be varied depending on the kind of event.

Furthermore, as shown in FIG. 21B, in an upper right part of the training screen 240, for each of the tentatively selected operating parts 241 to 245, an assigned character icon 248 of a character assigned for training is displayed. Furthermore, in the case where a prescribed event occurs in association with a character displayed in an assigned character icon 248 in the case where the training is successful, the event-report indication 247 is displayed in the corresponding assigned character icon 248. In the following, an assigned character icon 248 in which the event-report indication 247 is displayed will be referred to as an event-assigned character icon 249. Note that in the following, training in which a character is assigned will be referred to as joint training.

In this embodiment, characters that are assigned in training are support characters. When training in which a support character is assigned is executed, there are cases where a second event associated with the assigned support character occurs. In the case where such a second event occurs, the event-report indication 247 is displayed in the assigned character icon 248. The value by which a parameter of the main character is raised is greater in the case where training in which a support character is assigned is successful than in the case where training in which no support character is assigned is successful.

Note that without limitation to the above, characters other than support characters corresponding to support cards registered by the player in the preparation stage process may be assigned in training. For example, characters that are assigned in training may be characters selected through random lotteries from among all the support characters implemented in the game. In that case, character icons 248 indicating characters other than the support characters registered by the player are displayed in the training screen 240. Furthermore, when training in which a character icon 248 is displayed is executed, an event associated with a character other than the support characters registered by the player may occur. Here, the rate of occurrence of an event associated with a character not registered by the player is lower than the rate of occurrence of an event associated with a support character registered by the player. Also in this case, the event-report indication 247 may be displayed in the character icon 248 displayed in the training screen 240.

FIG. 21C is an illustration for explaining a training-result report screen 240a. When one of the tentatively selected operating parts 241 to 245 is tapped again, training corresponding to the tapped one of the operating parts 241 to 245 is executed. After the training is executed, the training-result report screen 240a reporting a success or failure of the training is displayed on the display 26. Here, the text “Success” is displayed, reporting a success of the training to the player.

Furthermore, at this time, the ability parameters in the status displaying part 213 are updated and displayed on the basis of the success of training. That is, ability parameters (ability information) of the main character, corresponding to the training item (kind of nurturing) selected by the player, are updated.

Here, the values by which ability parameters are raised in the case of successful training, displayed in the status displaying part 213 in FIG. 21A or FIG. 21B, are added. Furthermore, what is displayed in the physical-energy displaying part 211 is updated in accordance with the training item executed. The physical energy decreases in the case where training for speed, stamina, power, or spirit has been performed and has been successful. Meanwhile, the physical energy is recovered when training for wisdom has been performed and has been successful.

Meanwhile, in the case of a failure in training, a prescribed penalty is assigned. Specifically, the content of the penalty includes a reduction in physical energy, a decrease in the numerical value of an ability parameter, worsening of the character conditions, or the like. Note that, for example, a penalty that is assigned in the case of a high failure rate may be more disadvantageous (e.g., a greater numerical value of reduction in physical energy, a greater numerical value of decrease in an ability parameter, or a greater level of worsening in the character conditions) than a penalty that is assigned in the case of a low failure rate.

Furthermore, the content of the penalty may be determined depending on the training item. For example, the content of the penalty may be such that the value of the speed ability parameter is decreased in the case of a failure in speed training, while the value of the power ability parameter is decreased in the case of a failure in power training. Furthermore, the content of the penalty may be such that no penalty is assigned for some training items (e.g., wisdom) even in the case of a failure in training.

FIG. 21D is an illustration for explaining an event screen 240b. When the displaying of the training-result report screen 240a is quit, there are cases where the event screen 240b is displayed on the display 26. Various events are executed in the event screen 240b. Note that there are cases where a plurality of events occur during a single turn.

For example, in the case where a first hint event or a second hint event has occurred, it is possible to obtain a hint for a skill. After obtaining a hint for a skill, the player can acquire the skill by consuming skill points. A plurality of kinds of skills are provided, and a prescribed ability may be invoked for each skill. Each skill has an invocation condition and an effect defined therefor, and the predefined effect is invoked in the case where the invocation condition for each skill is satisfied. There are cases where a skill is invoked during the execution of individual racing, which will be described later.

In addition to first hint events and second hint events for possessing skills, events include events in which physical energy is recovered, events in which physical energy is decreased, first ability events and second ability events, in which ability parameters are raised or lowered, events in which the character conditions become better, events in which the character conditions become worse, etc. As will be described later, events include events for which turns in which the events occur are predefined, as well as events that occur in the case where a prescribed lottery is won. Furthermore, events include events that occur when turns are started as well as events that occur before turns are finished. When all events that have occurred are finished, the game screen 210 for the next turn is displayed.

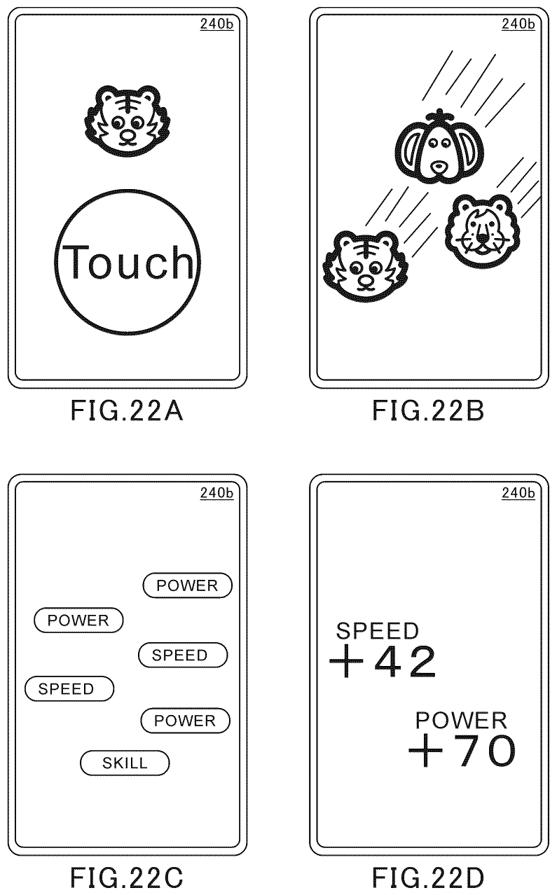

FIG. 22A is a first illustration for explaining an inheritance event. FIG. 22B is a second illustration for explaining an inheritance event. FIG. 22C is a third illustration for explaining an inheritance event. FIG. 22D is a fourth illustration for explaining an inheritance event. In a factor invoking turn, described earlier, an inheritance event occurs upon the start of the turn. Note that the inheritance event is a scenario-common event, which will be described later, and necessarily occurs in the same turn regardless of the scenario selected by the player. In this embodiment, the 30th turn and the 54th turn are set as factor invoking turns. Here, the case where an inheritance event occurs in the 30th turn will be described.

Upon the start of the 30th turn, first, as shown in FIG. 22A, the main character, as well as an operating part labeled as “Touch”, are displayed in the event screen 240b. When the operating part displayed in the event screen 240b is tapped, as shown in FIG. 22B, an animation image including the main character and two characters to inherit is displayed. Furthermore, when the operating part is tapped, lotteries are performed to determine whether or not to invoke factors for all the factors possessed by the six nurtured characters in total, including the first inheritance generation and the second inheritance generation.

Furthermore, as shown in FIG. 22C, factors for which the lotteries for determining invoking or not invoking have been won and thus invocation has been determined are displayed. Then, as shown in FIG. 22D, the kinds of ability parameters or aptitude parameters that are raised due to the invocation of the factors, as well as the values by which the parameters are raised, are displayed, and the parameters are updated. When the inheritance event is finished, the game screen 210 shown in FIG. 20A, and it becomes possible for the player to select one of the items. At this time, the values for raising the ability parameters or aptitude parameters displayed in the inheritance event have been added in the status displaying part 213.

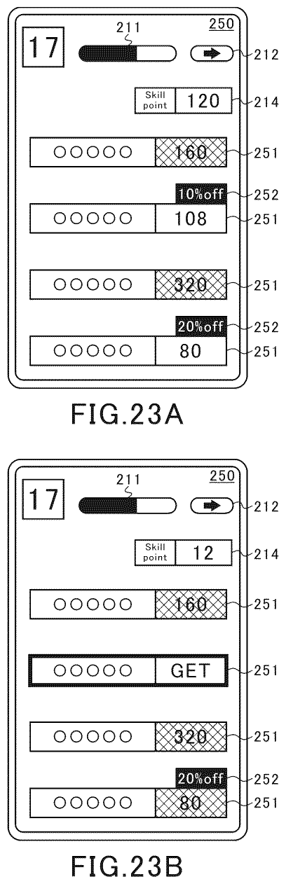

FIG. 23A is a first illustration for explaining a skill screen 250. FIG. 23B is a second illustration for explaining the skill screen 250. When the skill operating part 217 in the game screen 210 is operated, the skill screen 250 shown in FIG. 23A is displayed on the display 26.

In the skill screen 250, a skill display field 251 is displayed. In the skill display field 251, acquired skills, possessed skills set in advance to the main character, possessed skills possessed as the results of the occurrence of various kinds of evets, etc. are displayed. Furthermore, in the case where a first hint event or a second hint event has occurred in relation to a possessed skill, skill points to be consumed in order to acquire that possessed skill are discounted. Here, with each possessed skill for which a hint has been acquired, discounted skill points that are needed for the acquisition thereof are displayed. At this time, a discount-rate displaying icon 252 indicating the discount rate is displayed together with the skill display field 251.

Furthermore, with each skill displayed in the skill screen 250, the invocation condition and the effect of invocation of that skill are displayed.

Furthermore, in an upper part of the skill screen 250, the physical-energy displaying part 211, the character-condition displaying part 212, and the skill-point displaying part 214 are displayed. Furthermore, in an upper part of the skill screen 250, the current number of turns is displayed.

When a possessed skill has been acquired by consuming skill points on the basis of a player's operation, as shown in FIG. 23B, “GET” is displayed with the acquired skill, reporting the acquisition of the possessed skill, and the consumed skill points are subtracted from the skill points displayed in the skill-point displaying part 214, and what is displayed is updated.

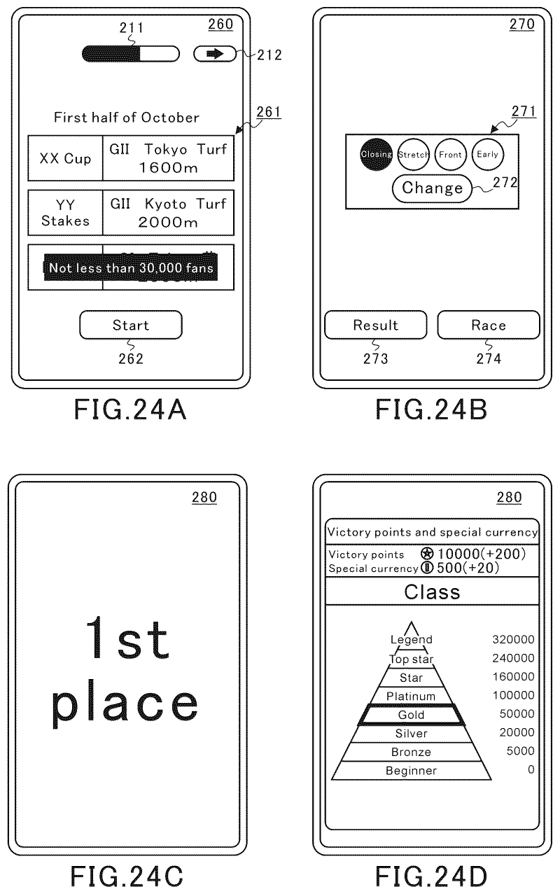

FIG. 24A is a first illustration for explaining an individual-race selection screen 260. When the individual-race operating part 219 in the game screen 210 is operated, the individual-race selection screen 260 shown in FIG. 24A is displayed. An individual race is designed such that the main character participates in a race against NPCs.

In an upper part of the individual-race selection screen 260, the physical-energy displaying part 211 and the character-condition displaying part 212 are displayed. Furthermore, in a central part of the individual-race selection screen 260, an individual-race selection operating part 261 for selecting the kind of race in which the main character is to participate is displayed. In the case where a plurality of individual-race selection operating parts (subcommands) 261 are displayed in the individual-race selection screen 260, mutually different individual races are set to the plurality of individual-race selection operating parts 261. Furthermore, in a lower part of the individual-race selection screen 260, a start operating part 262 labeled as “Start” is displayed. Note that the races that can be selected via the individual-race selection operating part 261 in the individual-race selection screen 260 are set in advance for each turn.

Furthermore, each race has a participation condition set therefor, and the player can let the main character participate only in races that satisfy the participation conditions. As described earlier, there are races for which the number of fans is specified as a participation condition. For each race that does not satisfy the specified number of fans, as shown in FIG. 24A, the participation condition is displayed in the individual-race selection operating part 261, notifying that it is not allowed to select the race. Furthermore, in each turn in which a target race to be cleared is set, only the target race is displayed in a selectable manner in the individual-race selection screen 260.

FIG. 24B is an illustration for explaining an individual-race start screen 270. When the start operating part 262 is operated in the state where the kind of individual race to participate in has been selected via the individual-race selection operating part 261, the individual-race start screen 270 shown in FIG. 24B is displayed. In a central part of the individual-race start screen 270, a strategy displaying part 271 is displayed. Furthermore, in the strategy displaying part 271, the currently selected strategy (closing, stretch running, front running, or early speed) is displayed in a highlighted manner, and a change operating part 272 labeled as “Change” is displayed. When the change operating part 272 is operated, a strategy changing screen, which is not shown, is displayed on the display 26. The player can change the strategy in the individual race to an arbitrary strategy by performing an operation in the strategy changing screen.

Furthermore, in a lower part of the individual-race start screen 270, a result operating part 273 labeled as “Result” and a race operating part 274 labeled as “Race” are displayed.

In the case where the race operating part 274 has been operated, a race screen, which is not shown, is displayed on the display 26. On the display 26, a video showing the proceeding of the race (hereinafter referred to as a race video) is displayed.

FIG. 24C is a first illustration for explaining an individual-race result screen 280. FIG. 24D is a second illustration for explaining the individual-race result screen 280. The individual-race result screen 280 is displayed on the display 26 in the case where the playing of the race video mentioned above has been finished and in the case where the result operating part 273 has been operated. In the individual-race result screen 280, as shown in FIG. 24C, the place of the main character in the individual race is displayed. Furthermore, in the individual-race result screen 280, as shown in FIG. 24D, the current class of the main character is displayed.

In this embodiment, the main character is classified depending on the number of fans acquired. Each class has a range of the number of fans set therefor, and here, the main character is classified into one of eight classes depending on the number of fans. In the individual-race result screen 280, the number of fans, victory points, and the amount of special currency acquired in the current individual race are displayed. Furthermore, in the individual-race result screen 280, the cumulative number of fans obtained by adding the number of newly acquired fans to the number of previously acquired fans is displayed. Furthermore, the current class corresponding to the cumulative number of fans is displayed in a distinguishable manner. Furthermore, in the individual-race result screen 280, the cumulative victory points obtained by adding the newly acquired victory points to the previously acquired victory points, as well as the cumulative numerical value of special currency obtained by adding the newly acquired amount of special currency to the previously acquired amount of special currency, are displayed.

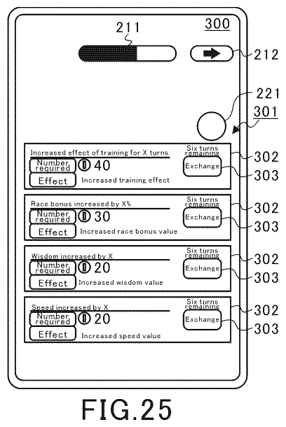

FIG. 25 is an illustration for explaining an example item exchange screen 300. For example, when the shop operating part 220 in the game screen 210 shown in FIG. 20A is tapped, the item exchange screen 300 shown in FIG. 25 is displayed. In the item exchange screen 300, the player can consume the special currency acquired by the player and exchange the special currency for a prescribed item displayed in the item exchange screen 300. Note that in the game screen 210 shown in FIG. 20A, the total amount of special currency possessed by the player may be displayed in a superimposed manner in a lower part of the shop operating part 220.

As shown in FIG. 25, in the item exchange screen 300, an item operating part 221 and an item exchange list 301 are displayed. In the item exchange list 301, one or more item exchange tabs 302 are displayed.

In each of the item exchange tabs 302, the name of an item available for exchange by the player (an item name), the effect of the item, the amount of special currency necessary for exchange, an indication of the exchange period, and an item-exchange operating part 303 are displayed. The exchange period is indicated in each item exchange tab 302, and is indicated, for example, in terms of the number of remaining turns during which exchange is possible from the current turn. In the item exchange screen 300, items are replaced per certain period (prescribed number of turns). The exchange period is the number of turns remaining before the replacement of items is performed. Furthermore, in exchanging items, a lottery may be performed in each turn during the nurturing game, and a sale may occur at a certain probability. The period during which a sale occurs is the period between a turn in which a sale occurred and a turn in which the next replacement of items is performed. The amount of special currency necessary for item exchange becomes smaller in the sale period than in non-sale periods.

Examples of items available for exchange by the player include a parameter change item, a status assignment item, a training-level change item, a skill-hint acquisition item, a character reassignment item, a training-effect change item, a physical-energy consumption item, a failure-rate change item, an event-parameter change item.

The parameter change item is an item for changing a parameter of the main character. For example, with the parameter change item, the value of a target parameter among the speed, the stamina, the power, the spirit, the wisdom, the physical energy, the upper-limit value of physical energy, the character conditions, the skill points, and the number of fans of the main character is increased by a prescribed value.

The status assignment item is an item for assigning a status to the main character. For example, with the status assignment item, an advantageous status or a disadvantageous status is assigned to the main character. Examples of the advantageous status include a status with which the amounts of raising various kinds of parameters of the main character are increased and a status with which the amount of consumption of skill points necessary for skill acquisition is decreased. Meanwhile, examples of the disadvantageous status include a status with which an event such as an event in which various kinds of parameters of the main character are lowered occurs and a status with which raising of individual various kinds of parameters is hindered.

The training-level change item is an item for changing the training level of each training item. For example, with the training-level change item, the training level of a target training item among speed, stamina, power, spirit, and wisdom is increased by a prescribed value.

The skill-hint acquisition item is an item with which a skill event occurs to let the main character possess or acquire a skill. For example, with the skill-hint acquisition item, it is possible to let the main character possess or acquire various kinds of skills shown in FIG. 6C.

The character reassignment item is an item for reassigning a character assigned in prescribed training in other training, as shown in FIGS. 21A and 21B. Character reassignment will be described later.

The training-effect change item is an item for changing the training effect due to training during a certain period. Specifically, with the training-effect change item, the fixed raising value for raising an ability parameter of the main character as a result of training, which will be described later, is increased by a prescribed value during a certain period. For example, with the training-effect change item, the fixed raising value for raising an ability parameter as a result of target training among the individual training items (speed, power, spirit, stamina, and wisdom) is increased by X % during turn X.

The physical-energy consumption item is an item for increasing the amount of physical energy that is consumed in training, whereby the effect of training is enhanced. Specifically, with the physical-energy consumption item, the fixed raising value for raising an ability parameter of the main character as a result of training, which will be described later, is increased by a prescribed value. It is possible to increase the effect of enhancing training by using the physical-energy consumption item in combination with the training-effect change item.

The failure-rate change item is an item for changing the failure rate of the target training item. For example, with the failure-rate change item, the failure rate of target training among the individual training items (speed, power, spirit, stamina, and wisdom) is decreased by a prescribed value.

The event-parameter change item is an item for changing the value of changing a parameter of the main character, which is assigned when an event occurs after a race. For example, with the event-parameter change item, the change value for a target parameter among the speed, the stamina, the power, the spirit, the wisdom, the physical energy, the upper-limit value of physical energy, the character conditions, the skill points, and the number of fans of the main character is increased by a prescribed value.

In the item exchange list 301 shown in FIG. 25, an example of the training-effect change item, the event-parameter change item, and the parameter change item is displayed. When the item-exchange operating part 303 of each item exchange tab 302 is tapped, subtraction processing for subtracting the necessary amount of special currency indicated in the item exchange tab 302 from the cumulative value of special currency acquired by the player, as well as assignment processing for assigning the item indicated in the item exchange tab 302 to the player, are executed. Note that at least some of the items available for exchange via the item exchange tabs 302 are limited items, for which the number of times of exchange (i.e., the number of purchases) is limited to within a prescribed number of times. In the case where the number of limited items assigned has reached the upper limit, the player is not allowed to exchange the special currency for the limited items even if the player has the special currency.

Meanwhile, when the item operating part 221 is tapped, an item usage screen, which is not shown, is displayed on the display 26. In the item usage screen, a list of items possessed by the player is displayed. The item list includes items acquired through exchange in the item exchange screen 300. That is, in the item usage screen, items assigned to the player in exchange for special currency are displayed. Note that items acquired in various kinds of events may be displayed in the item usage screen. The player can use various kinds of items by performing an operation to tap one of the items displayed in the item usage screen.

In this embodiment, by operating the item operating part 221, the player can use various kinds of items (the parameter change item, the status assignment item, the training-level change item, the skill-hint acquisition item, the character reassignment item, the training-effect change item, the physical-energy consumption item, the failure-rate change item, and the event-parameter change item) exchanged for the special currency in each screen. When each item is used, for example, in the training screen 240 shown in FIG. 21A, an icon indicating the effect currently being exhibited as a result of usage of the item may be displayed. At this time, the number of effect exhibiting turns, in which the effect is exhibited as a result of usage of the item, may be displayed together in a lower part of the icon. Note that as shown in FIG. 25, each item has set therefor a period during which exchange is possible. The player can exchange each item for the special currency during the exchangeable period set for that item. Note that an exchangeable period need not be set for each item.

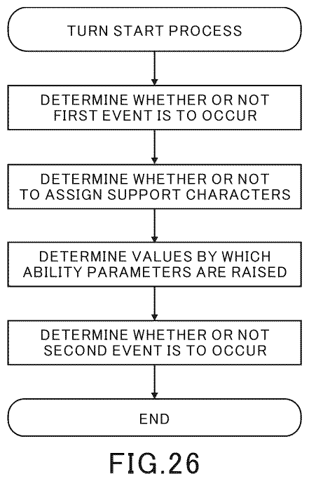

FIG. 26 is a figure for explaining a rough flow of a turn start process. The nurturing stage process includes the turn start process, which is executed when each turn in the nurturing game is started. While the turn start process will be described later in detail, here, the rough flow of the turn start process will be described.

During the main nurturing game, processing for determining whether or not various kinds of events are to occur is performed in each turn. Events are broadly classified into three kinds, namely, scenario events, the exclusive events mentioned earlier, which are provided for individual main characters, and support events. Note that each scenario has predefined therefor a scenario event, an exclusive event, and a support event that may occur during the main nurturing game.

Scenario events are events set for individual scenarios of the main nurturing game. In this embodiment, a plurality of scenarios are provided, allowing the player to select one of the scenarios. A scenario event occurs for each scenario selected by the player. In other words, a scenario event that occurs in the main nurturing game is determined on the basis of a scenario selected by the player.

Note that scenario-specific events and scenario-common events may be provided among the scenario events. A scenario-specific event is an event associated with only one scenario. For example, a scenario-specific event associated with a first scenario occurs only in the case where the first scenario has been selected, while never occurring in the case where another scenario has been selected.

Meanwhile, a scenario-common event is an event that occurs commonly in a plurality of scenarios. Therefore, a scenario-common event occurs both in the case where the first scenario has been selected and in the case where a second scenario has been selected.

Here, it is assumed that scenario-specific events and scenario-common events are provided as scenario events. Alternatively, however, only either scenario-specific events or scenario-common events may be provided.

The exclusive events are events set in advance for individual characters, as mentioned earlier. In the main nurturing game, the exclusive event for the character registered by the player as the main character in the setting game, i.e., in the preparation stage process.

Support events are events set in advance for individual support cards, as mentioned earlier. In the main nurturing game, the support events associated with the support cards registered by the player in the setting game occur. Support events include first events, which may occur at the start of a turn, and second events, which may occur after the execution of training. Whether or not a first event is to occur is determined at the start of a turn on the basis of a randomly obtained random number and a first event table.

Whether or not a second event is to occur is determined on the basis of a randomly obtained random number and a second event table after processing for determining individual support characters to be assigned in training is executed. Note that only in the case where a support character is assigned in training, whether or not a second event is to occur is determined for the assigned support character.

Note that it is assumed in this embodiment that first events are selected through lotteries from among the support events associated with the support cards registered in the deck by the player in the preparation stage process. Without limitation to the above, however, the arrangement may be such that the support events associated with support cards selected through lotteries from all the support cards implemented in the game can be selected. In this case, the probabilities of selection of the support events associated with the support cards registered in the deck should be higher than the probabilities of selection of the support card events associated with the support cards not registered in the deck.

As described above, with a scenario event, whether or not the scenario event occurs, etc. are determined on the basis of a scenario. Furthermore, with the exclusive events and support events, whether or not the events occur, etc. are determined on the basis of the main character and support cards, respectively. These kinds of events are classified on the basis of information that is referred to when determining whether or not the events occur, etc.

Meanwhile, in this embodiment, each event is classified into one of six event classes depending on what results from the occurrence of that event. Here, each event is classified into one of the following event classes: first hint events, second hint events, first ability events, second ability events, aptitude events, and story events.

As mentioned earlier, a first hint event or a second hint event is an event that makes it possible to possess or acquire a skill. A first ability event or a second ability event is an event for raising or lowering an ability parameter of the main character. An aptitude event is an event for raising or lowering an aptitude parameter of the main character. A story event is an event for displaying a story relating to a character that appears in the nurturing game. Note that story events include events in which an ability parameter or an aptitude parameter is changed in addition to displaying a story.

Here, scenario events include first hint events, second hint events, first ability events, second ability events, aptitude events, and story events. Furthermore, exclusive events and support events include first hint events, second hint events, first ability events, and second ability events. Note that exclusive events may include story events.

In this embodiment, in addition to processing for determining a scenario event and processing for determining an exclusive event, the turn start process includes “processing for determining whether or not a first event is to occur”, “processing for determining whether or not to assign support characters”, “processing for determining values by which ability parameters are raised”, and “processing for determining whether or not a second event is to occur”. Processing is executed in order of the processing for determining a scenario event, the processing for determining an exclusive event, the “processing for determining whether or not a first event is to occur”, the “processing for determining whether or not to assign support characters”, the “processing for determining values by which ability parameters are raised”, and the “processing for determining whether or not a second event is to occur”. Although various other kinds of processing are executed in the turn start process, here, the kinds of processing shown in FIG. 26 will be described in order.

### <Processing for Determining Whether or not a First Event is to Occur>

A first event is selected through a lottery from among the support events (first events) associated with the support cards registered by the player in the preparation stage process. Specifically, at the start of a turn, a random number is obtained at random, and whether or not a first event is to occur, as well as the content of the first event, are determined on the basis of the random number obtained and the first event table. The first event table has set therein selection ratios as to whether a first event “occurs” or “does not occur”. In this embodiment, first events include four kinds of events, namely, event a, event b, event c, and event d. For example, in the first event table, the probability that each event (event a to d) “occur” is set to 20%, and the probability that a first event “does not occur” is set to 20%. Note that the selection ratios of first events may be set individually for individual support cards, i.e., for individual support characters.

### <Processing for Determining Whether or not to Assign Support Characters>

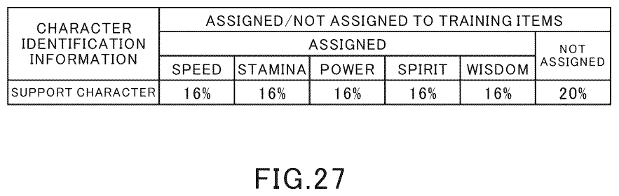

FIG. 27 is a figure for explaining an assign/do-not-assign table. As shown in FIG. 27, the assign/do-not-assign table has set therein selection ratios as to whether or not support characters are assigned to training items (“assigned to one of the training items” or “not assigned”). In this embodiment, on the basis of the assign/do-not-assign table shown in FIG. 27, whether or not to assign is determined for all the support characters corresponding to all the support cards registered by the player in the preparation stage process. Specifically, at the start of a turn, a random number is obtained at random, and whether or not each support character is to be assigned to a training item is determined on the basis of the random number obtained and the assign/do-not-assign table. Without limitation to the above, however, whether or not each support character is to be assigned to a training item may be selected through a lottery from among all the support characters corresponding to all the support cards implemented in the game.

Specifically, as shown in FIG. 27, in this embodiment, for each support character, “assigned” to one of the training items of speed, stamina, power, spirit, and wisdom is selected with a probability of 16%, and “not assigned” to any of the training items is selected with a probability of 20%. Note that, as shown in FIG. 17A, a plurality of kinds of favorite training are set to support characters. Thus, for example, the selection ratios of assignment of each support character to the individual training items may be set such that the selection ratio for a training item corresponding to favorite training is higher than the selection ratio for training items corresponding to the other training. In the case where lotteries are performed, a lottery table in which selection ratios in the lotteries are defined may be stored in advance, or a lottery table may be created on each occasion of a lottery.

Note that when the training items to which support characters are assigned have been determined, the support characters that have been determined to be assigned, as well as the training items, may be stored in association with each other in the server 1000. More specifically, association information may be stored in the server 1000, in which training IDs indicating the kinds of training items are associated with the character IDs of support characters or the support card IDs of support cards associated with support characters.

<Processing for Determining Values by which Ability Parameters are Raised>

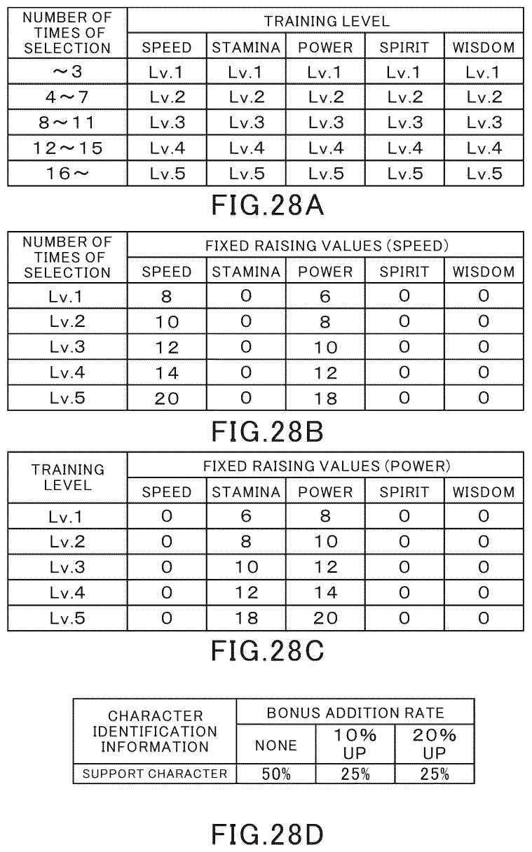

FIG. 28A is an illustration for explaining a training level table. As shown in FIG. 28A, training levels are set so as to be raised in accordance with the number of times that each training item has been selected. Specifically, the individual training levels for “Speed”, “Stamina”, “Power”, “Spirit”, and “Wisdom” are set to “level 1” in the case where the number of times that each training item has been selected is less than or equal to three, the individual training levels are set to “level 2” in the case where the number of times that each training item has been selected is greater than or equal to four and is less than or equal to seven, the individual training levels are set to “level 3” in the case where the number of times that each training item has been selected is greater than or equal to eight and is less than or equal to eleven, the individual training levels are set to “level 4” in the case where the number of times that each training item has been selected is greater than or equal to twelve and is less than or equal to fifteen, and the individual training levels are set to “level 5” in the case where the number of times that each training item has been selected is greater than or equal to sixteen.

In this embodiment, in the case where training selected by the player has been executed and has been successful, the values of prescribed ability parameters are raised depending on the training item executed.

Specifically, in this embodiment, in the case where training for “Speed” has been executed and has been successful, the values of “Speed” and “Power” ability parameters are raised.

Meanwhile, in the case where training for “Stamina” has been executed and has been successful, the values of “Stamina” and “Spirit” ability parameters are raised.

Meanwhile, in the case where training for “Power” has been executed and has been successful, the values of “Stamina” and “Power” ability parameters are raised.

Meanwhile, in the case where training for “Spirit” has been executed and has been successful, the values of “Speed”, “Power”, and “Spirit” ability parameters are raised.

Meanwhile, in the case where training for “Wisdom” has been executed and has been successful, the values of “Speed” and “Wisdom” ability parameters are raised.

In this embodiment, the value of an ability parameter that is raised in the case of successful training is calculated by adding a value obtained by multiplying a fixed raising value by a bonus addition rate to the fixed raising value, where the fixed raising value is determined correspondingly to the executed training item and the training level, and the bonus addition rate will be described later.

FIG. 28B is a figure for explaining a fixed raising value (speed) table. Furthermore, FIG. 28C is a figure for explaining a fixed raising value (power) table. That is, FIG. 28B shows fixed raising values in the case where the training item is “Speed”. Furthermore, FIG. 28C shows fixed raising values in the case where the training item is “Power”.

As shown in FIGS. 28B and 28C, in the fixed raising-value tables, fixed raising values that are determined correspondingly to the executed training item and the training level are stored. Furthermore, in this embodiment, as shown in FIGS. 28B and 28C, settings are made such that ability parameters are raised by greater values as the training level becomes higher.

Note that although not described here, fixed raising-value tables for the cases where “Stamina”, “Spirit”, and “Wisdom” are selected as the training items are also provided individually.

Furthermore, a bonus addition rate is determined on the basis of a support character assigned to each training item in addition to the fixed raising value described above.

FIG. 28D is a figure for explaining a bonus addition rate table. In this embodiment, a bonus addition rate is determined on the basis of a support character determined to be assigned to each item of training.

Specifically, as shown in FIG. 28D, in the bonus addition rate table, whether or not there is a bonus addition rate, as well as a selection ratio of the addition rate (10% up or 20% up), are set for each support character.

As the bonus addition rate, “none” is selected with a probability of 50%, “10% up” is selected with a probability of 25%, and “20% up” is selected with a probability of 25%.

Furthermore, a value obtained by multiplying the fixed raising value determined on the basis of a fixed raising-value table by a bonus addition rate is derived as a bonus additional value. The value obtained by adding the bonus additional value to the fixed raising value is determined as the amount of raising the value of an ability parameter in the case of successful training. Note that for training to which a plurality of support characters are assigned, the individual bonus additional values for the plurality of assigned support characters are added to the fixed raising values. As described above, the amounts of raising the ability parameters of the main character in the case of successful training are determined for all the kinds of training.

### <Processing for Determining Whether or not a Second Event is to Occur>

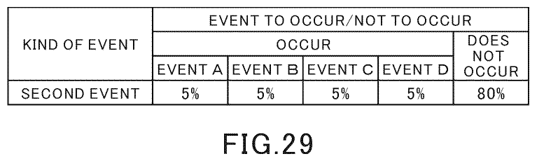

FIG. 29 is a figure for explaining a second event table. A second event is selected through a lottery from among the support events (second events) associated with the support cards corresponding to the support characters assigned to each training item. Specifically, after the “processing for determining whether or not to assign support characters”, a random number is obtained at random, and whether or not a second event is to occur is determined on the basis of the random number obtained and the second event table. The second event table has set therein selection ratios as to whether a second event “occurs” or “does not occur”.

For example, as shown in FIG. 29, second events include four kinds of events, namely, event A, event B, event C, and event D. For example, in the second event table, the probabilities that the individual events (events A to D) “occur” are set to 5%, and the probability that a second event “does not occur” is set to 80%. Note that the selection ratios for second events may be set individually for individual support cards, i.e., for individual support characters.

In this embodiment, after the “processing for determining whether or not to assign support characters”, processing for determining whether or not a second event is to occur is executed for all the support characters assigned to the individual training items. Then, on the basis of the determination as to whether or not a second event is to occur, the event-report indication 247 is displayed in the training screen 240. In the case where the player selects training having assigned thereto a character for which it has been determined that a second event is to occur, the second event occurs after the execution of training. For example, in the case where it has been determined that a second hint event is to occur for a support character assigned to speed training, when the speed training has been executed, the second hint event necessarily occurs after the execution of training. However, the second hint event does not occur after the execution of training when training other than speed training has been executed. At this time, in the case where it has been determined that second events are to occur for two or more characters, which of the second events is to occur is determined through a lottery or on the basis of preset priority levels or the like of support events. For example, which of the plurality of second events is to occur is determined with equal probabilities. Without limitation to the above, however, the arrangement may be such that weights are set depending on the kinds of second events and which of the plurality of second events is to occur is determined depending on the set weights. Alternatively, the arrangement may be such that all the second events determined occur in the case where it has been determined that second events are to occur for two or more characters.

Here, for example, when it has been determined that a second event is to occur, occurrence information indicating whether or not a support event is to occur may be stored in the server 1000 in association with a support card or support character associated with the second event. More specifically, association information may be stored in the server 1000, in which occurrence information is associated with the character ID of a support character or a support card ID of a support card associated with a support character.

After the “processing for determining whether or not a first event is to occur”, the “processing for determining whether or not to assign support characters”, the “processing for determining values by which ability parameters are raised”, and the “processing for determining whether or not a second event is to occur”, described above, are executed, when the training operating part 216 is operated, for example, the training screen 240 shown in FIG. 21B is displayed on the display 26.

As described earlier, in the training screen 240 shown in FIG. 21B, two kinds of assigned character icons 248 assigned to the training item of stamina through the “processing for determining whether or not to assign support characters” are displayed.

Furthermore, in the training screen 240, the raising values for ability parameters, determined through the “processing for determining values by which ability parameters are raised”, are displayed in the status displaying part 213. Furthermore, in the training screen 240, the event-report indication 247 for reporting the second event determined through the “processing for determining whether or not a second event is to occur” is displayed.

At this time, when the item operating part 221 is tapped and the character reassignment item is used, “processing for determining a training item for reassignment” is executed.

### <Processing for Determining a Training Item for Reassignment>

In the “processing for determining a training item for reassignment”, for each support character that has been determined to be assigned through the “processing for determining whether or not to assign support characters”, which training item among “Speed”, “Stamina”, “Power”, “Spirit”, and “Wisdom” the support character is to be reassigned is determined through a lottery.

Here, when the character reassignment item is used, one random number is determined by performing a re-lottery, and the assignment of the individual support characters to the individual training items are redetermined on the basis of the random number determined through the re-lottery and the assign/do-not-assign table shown in FIG. 27. That is, a re-lottery is performed to determine the assignment of the individual support characters to the individual training items. At this time, in the case where how the support characters are assigned to the training items after the re-lottery is the same as how the support characters are assigned to the training items before the re-lottery (i.e., the assignment determined through the “processing for determining whether or not to assign support characters”), a random number is determined by a re-lottery again. Then, the assignment of the individual support characters to the individual training items is redetermined on the basis of the random number determined by performing the re-lottery again and the assign/do-not-assign table shown in FIG. 27. This processing is executed repeatedly until how the support characters are assigned to the training items after the re-lottery becomes different from how the support characters are assigned to the training items before the re-lottery (i.e., the assignment determined through the “processing for determining whether or not to assign support characters”). Alternatively, the arrangement may be such that a special reassignment table is used such that the result of determining training items for reassignment becomes different, which prohibits support characters from being reassigned to the same training items. Accordingly, the assignment of the individual support characters to the individual training items after the “processing for determining training items for reassignment” varies from the assignment of the individual support characters to the individual training items as determined through the “processing for determining whether or not to assign support characters”.

Furthermore, when the character reassignment item is used, a re-lottery is performed to determine whether or not a second event is to occur on the basis of the random number selected through a lottery in the “processing for determining whether or not a second event is to occur”, as well as the second event table. Here, since the re-lottery is performed by using the same random number as the random number used in the “processing for determining whether or not a second event is to occur, as well as the same second event table, the second event determined through a re-lottery after the character reassignment item is used is the same as the second event determined to occur in the “processing for determining whether or not a second event is to occur”.

That is, even when the assignment of the support characters to the individual training items is changed, whether or not a second event is to occur, as well as the kind of second event determined to occur, are maintained without being changed. Note that although a re-lottery for a second event is performed by using the same random number in this embodiment, instead of performing a re-lottery, the second event determined through the “processing for determining whether or not a second event is to occur” may be used as it is. Note that the re-lottery for the assignment of the individual support characters to the individual training items, as well as the re-lottery as to whether or not a second event is to occur, are executed each time the character reassignment item is used.

Note that in the re-lottery processing at the time when the character reassignment item is used, a re-lottery may be performed for the association of the training IDs indicating the kinds of training items with the character IDs of support characters or the support card IDs of support cards associated with support characters. At this time, association information may be maintained, in which occurrence information indicating whether or not support events are to occur is associated with the character IDs of support characters or the support card IDs of support cards associated with support characters.

The re-lottery may be arranged, for example, such that the individual training items are selected with equal probabilities. Alternatively, the re-lottery may be arranged such that the training items are selected with different probabilities individually set therefor. Alternatively, for example, a lottery may be performed so that each support character tends to be assigned to the favorite training thereof (see FIG. 17A). In the case where lotteries are performed, a lottery table defining selection ratios in the lotteries may be stored in advance, or a lottery table may be created on each occasion of a lottery.

After the “processing for determining training items for reassignment” is executed, a post-reassignment training screen 310 is displayed on the display 26.

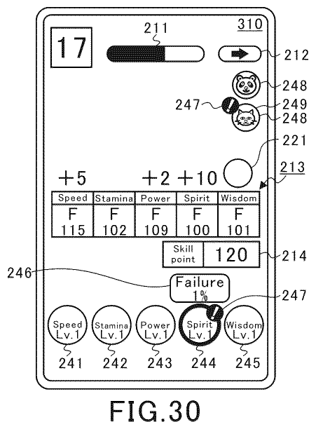

FIG. 30 is an illustration for explaining the post-reassignment training screen 310. As shown in FIG. 30, in the post-reassignment training screen 310, the two kinds of assigned character icons 248 assigned to the spirit training item through the “processing for determining training items for reassignment” are displayed.

One assigned character icon 248 of the two kinds of assigned character icons 248 is an event-assigned character icon 249 with which the event-report indication 247 is displayed. The event-assigned character icon 249 shown in FIG. 30 is the same as the event-assigned character icon 249 shown in FIG. 21B.

That is, the event-assigned character icon 249 shown in FIG. 21B has been reassigned from the stamina training item to the spirit training item, as shown in FIG. 30, through the “processing for determining training items for reassignment”.

Here, as described above, the second event determined through a re-lottery after the character reassignment item is used is the same as the second event determined to occur through the “processing for determining whether or not a second event is to occur”. As a result, as shown in FIG. 30, in the post-reassignment training screen 310, the event-assigned character icon 249 is displayed, with which the event-report indication 247 is displayed, reporting the second event determined through the “processing for determining whether or not a second event is to occur” before the “processing for determining training items for reassignment” is executed.

This makes it possible to perform reassignment only for training items in which support characters are assigned, while maintaining the occurrence of a second event for a support card, which makes it more likely for a second event to occur in a training item desired by the player, thereby improving convenience for the nurturing game.

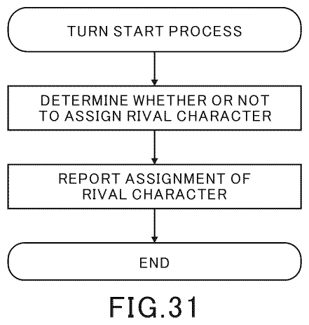

Furthermore, the turn start process in this embodiment includes “processing for determining whether or not to assign a rival character” and “processing for reporting the assignment of a rival character” shown in FIG. 31. FIG. 31 is a figure for explaining a rough flow of the turn start process. A rival character is an NPC that participates in an individual race and that competes with the main character for victory in the individual race.

The rival character is constituted of a character having the same character ID as an ordinary NPC (hereinafter referred to as a normal NPC) that appears in a normal individual race in which a rival character does not appear. Note, however, that a rival character is a character having higher parameters than a normal NPC. For example, a rival character has ability parameters obtained by multiplying the ability parameters of a normal NPC having the same character ID by a prescribed factor (e.g., ×1.1). Thus, in an individual race in which a rival character appears, basically, the game is designed such that the rival character and the main character compete for a place (the first place).

### <Processing for Determining Whether or not to Assign a Rival Character>

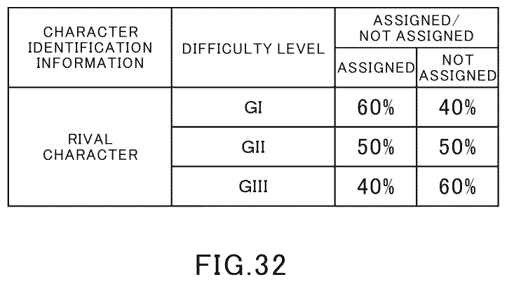

FIG. 32 is a figure for explaining an assign/do-not-assign table. As shown in FIG. 32, the assign/do-not-assign table has set therein selection ratios as to whether or not to assign a rival character (“assigned” or “not assigned”). In this embodiment, whether or not to assign rival character is determined on the basis of the assign/do-not-assign table shown in FIG. 32.

In this embodiment, the assignment of a rival character is executed in the case where there is a race with which the aptitude parameters concerning the track aptitude and the distance aptitude of the current main character are greater than or equal to a prescribed value (e.g., greater than or equal to C) among individual races that occurs in the current turn. Thus, in the “processing for determining whether or not to assign a rival character”, it is determined first whether or not there is a race with which the aptitude parameters concerning the track aptitude and the distance aptitude of the current main character are greater than or equal to a prescribed value (hereinafter referred to as a matching race) among individual races (kinds of races) that occur in the current turn.

As shown in FIG. 32, in this embodiment, the selection ratios for a rival character are varied depending on the difficulty level of the matching race. Specifically, as shown in FIG. 32, in the case where the difficulty level (grade) of the matching race for a rival character is GI, “assigned” is selected with a probability of 60%, while “not assigned” is selected with a probability of 40%.

Meanwhile, in the case where the difficulty level of the matching race for a rival character is GII, “assigned” is selected with a probability of 50%, while “not assigned” is selected with a probability of 50%. Meanwhile, in the case where the difficulty level of the matching race for a rival character is GIII, “assigned” is selected with a probability of 40%, while “not assigned” is selected with a probability of 60%. Note, however, that the selection ratios for a rival character need not be varied depending on the difficulty level of the matching race. For example, the selection ratios for a rival character may be uniform regardless of the difficulty level of the matching race.

When it has been determined to assign a rival character, the kind (character ID) of rival character to be assigned is selected at random through a lottery. At this time, one of the characters with which the aptitude parameters concerning the track aptitude and the distance aptitude for the track such as turf or dirt and the distance such as short distance, mile, intermediate distance, or long distance, set as the matching race, are greater than or equal to a prescribed value (e.g., greater than or equal to C) is selected at random through a lottery as a rival character. Note that in the case where a plurality of matching races are included in a single turn, random lotteries are performed such that the same rival character (character ID) is not selected among the plurality of matching races. Furthermore, a random lottery for a rival character is performed while excluding the main character to be nurtured.

Here, the parameters of a rival character may be varied depending on the difficulty level of the matching race. For example, a rival character may have higher parameters as the difficulty level of the matching race becomes higher. Alternatively, the parameters of a rival character may have the same values regardless of the difficulty level of the matching race.

The parameters of a rival character are set so as to become higher as the turn of the nurturing game advances. Specifically, the parameters of a rival character may be set so as to become higher in order of the initial turn segment, the middle turn segment, and the late turn segment. More specifically, the ability parameters of a rival character are obtained by multiplying the ability parameters of the normal NPC having the same character ID by 1.1 in the case of the initial turn segment, by multiplying the ability parameters of the normal NPC having the same character ID by 1.3 in the case of the middle turn segment, and by multiplying the ability parameters of the normal NPC having the same character ID by 1.5 in the case of the late turn segment.

When the main character participates in a matching race, a base reward is granted to the player. Furthermore, when the main character defeats a rival character in the matching race, an additional reward is granted to the player in addition to the base reward. Alternatively, the additional reward may be granted for the participation in a matching race regardless of whether or not a rival character is defeated. The base reward is a reward that the player can receive regardless of whether a rival character is defeated. The additional reward is granted to the main character to be nurtured, separately from the base reward. For example, the additional reward is a skill hint relating to the track of a matching race, a skill hint relating to the distance of a matching race, or a skill hint relating to the running style of the main character. Furthermore, the additional reward may be a prescribed event that is displayed on the display 26. In the prescribed event, for example, a rival character is displayed. Furthermore, examples of the additional reward include a skill hint or parameter associated with the main character to be nurtured. The skill hint may be determined on the basis of a parameter such as the track aptitude, the distance aptitude, or the running-style aptitude of the main character to be nurtured.

This embodiment has been described in the context of examples in which an event is displayed or a skill hint or a parameter is granted as the additional reward. Without limitation to the above, however, the additional reward may include a special item that makes it possible to raise the initial value of an ability parameter of a specific character or to enhance a unique skill provided for a specific character. Here, the specific character is a character having the same character ID as a rival character. Alternatively, the specific character may be the main character or any character that participates in a matching race. Without limitation to the above, however, the specific character may be any character that can be acquired by the player, or may be any character that does not participate in a matching race. Furthermore, for each matching race, one kind of special item is granted to the player as the additional reward.

In this embodiment, no limitation is set to the number of times that an additional reward that can be acquired in a matching race may be granted. However, for example, the number of times that a special item can be acquired in one matching race during a prescribed period may be limited to a prescribed number of times. For example, the number of times that a special item can be acquired in one matching race in one day may be limited to three. However, the number of times of acquisition of a special item may be varied depending on the kind of matching race (kind of race). In this case, the additional reward acquired as a result of a matching race is associated with the player ID and is stored in the server 1000.

Furthermore, the number of special items acquired in one occasion of acquisition is the sum of a basic number of acquisition (e.g., three) and a bonus number of acquisition. The bonus number of acquisition may be granted in the case where the main character defeats a rival character.

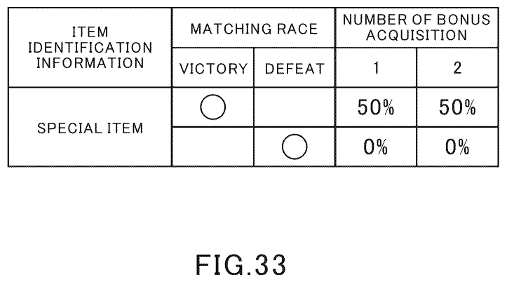

FIG. 33 is a figure for explaining a bonus-number-of-acquisition table. In this embodiment, the bonus number of acquisition is determined on the basis of the bonus-number-of-acquisition table. Specifically, as shown in FIG. 33, in the bonus-number-of-acquisition table, whether or not a bonus can be acquired, as well as selection ratios for the bonus number of acquisition, are set for special items.

As shown in FIG. 33, the bonus number of acquisition of special items is set so as to vary depending on the outcome of a matching race (i.e., whether or not a rival character is defeated). Specifically, the bonus number of acquisition is zero in the case where the main character is defeated by a rival character. Meanwhile, in the case where the main character defeats a rival character, as the bonus number of acquisition, “1” is selected with a probability of 50%, while “2” is selected with a probability of 50%.

### <Processing for Reporting the Assignment of a Rival Character>

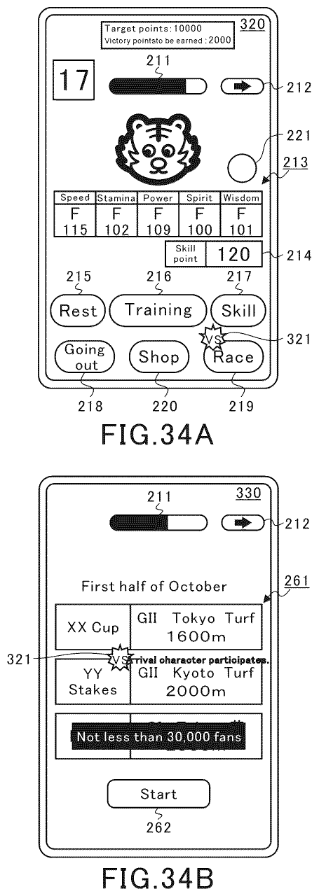

FIG. 34A is an illustration for explaining reporting of the assignment of rival character in a game screen 320. FIG. 34B is an illustration for explaining reporting of the assignment of a rival character in an individual-race selection screen 330.

When it has been determined to assign a rival character through the “processing for determining whether or not to assign a rival character”, as shown in FIG. 34A, a rival-character report indication 321 is displayed in a manner superimposed on the individual-race operating part 219 of the game screen 320.

When the individual-race operating part 219 with which the rival-character report indication 321 is displayed is tapped, the individual-race selection screen 330 shown in FIG. 34B is displayed on the display 26. A rival-character report indication 321 saying “a rival character participates” is displayed in a manner superimposed on the kind of race (matching race) in which it has been determined to assign a rival character among the kinds of races in the individual-race selection operating parts 261 in the individual-race selection screen 330.

By confirming the rival-character report indication 321, the player can choose to play a game of nurturing the main character to be nurtured or to acquire an additional reward by competing with the rival character, which serves to enhance the fun of the nurturing game. This embodiment has been described in the context of an example where the rival-character report indication 321 shown in FIGS. 34A and 34B is displayed on the display 26 in the case where it has been determined to assign a rival character. Without limitation to the example, however, for example, the rival-character report indication 321 may include text or an image that makes it possible to identify the character kind of the rival character.

In this embodiment, a bonus event occurs in the case where the main character has satisfied prescribed conditions at the end of the final turn in each of the initial turn segment, the middle turn segment, and the late turn segment. Examples of the prescribed conditions include gaining victory points exceeding target points by not less than a prescribed value, winning the first place not less than a prescribed number of times in races of a prescribed difficulty level (e.g., GI), and defeating a rival character not less than a prescribed number of times.

Bonus events include low-bonus events and high-bonus events, and the kind of bonus event that occurs changes depending on the status of accomplishment of the prescribed conditions. An example low-bonus event is an event with which the level of a unique skill set to the main character is enhanced. Example high-bonus events include an event with which a parameter of the main character is raised by a prescribed value and an event with which skill points are increased by a prescribed value, as well as an event with which the level of a unique skill set to the main character is enhanced.

In this embodiment, a low-bonus event occurs in the case where only a basic condition among the prescribed conditions has been accomplished, while a high-bonus event occurs in the case where a specific condition in addition to the basic condition have been accomplished among the prescribed conditions. The content of the high-bonus event changes depending on the kind of turn segment.

For example, in the case where the kind of turn segment is the initial turn segment, with the high-bonus event that occurs, the level of a unique skill set to the main character is enhanced, one kind of parameter selected at random from among the parameters of the main character is raised by a prescribed value (e.g., +10), and the skill points are increased by a prescribed value (e.g., +20).

Meanwhile, in the case where the kind of turn segment is the middle turn segment, with the high-bonus event that occurs, the level of a unique skill set to the main character is enhanced, all the parameters of the main character are raised by a prescribed value (e.g., +5), and the skill points are increased by a prescribed value (e.g., +30).

Meanwhile, in the case where the kind of turn segment is the late turn segment, with the high-bonus event that occurs, the level of a unique skill set to the main character is enhanced, all the parameters of the main character are raised by a prescribed value (e.g., +10), and the skill points are increased by a prescribed value (e.g., +30).

Furthermore, in this embodiment, separately from the bonus event that occurs at the end of each turn segment, described above, a bonus event also occurs in the case where the main character has accomplished a special condition. An example of the special condition is for the main character to win the first place in a specific race among individual races. Specifically, the specific condition is winning the first place a prescribed number of times in individual races for which a specific track or a specific distance is set, winning the first place a prescribed number of times in individual races in a specific region, winning the first place in a specific race among GI races with high difficulty levels, etc. The bonus event is, for example, an event with which a parameter of the main character is raised by a prescribed value.

When all the turns are finished in the main nurturing game described above, the nurturing game is finished. Meanwhile, in the case of a failure to accomplish a target set for each character or target points set for each specified turn segment in the middle of the main nurturing game, the nurturing game is finished at that timing.

Here, when the nurturing game is finished, the main character nurtured in the nurturing game is stored as a nurtured character. More strictly, information concerning the nurtured character nurtured in the nurturing game (hereinafter referred to as nurtured character information) is stored in association with the player ID. Note that the nurtured character information is stored both at the player terminal 1 and at the server 1000. The nurtured character information stored in association with the player ID includes ability parameters, aptitude parameters, acquired skills, inheritance information, etc.

Furthermore, when the nurturing game is finished, an evaluation score of the nurtured character that has been nurtured is calculated. Here, the evaluation score is calculated on the basis of the ability parameters, the aptitude parameters, the acquired skills, the records in individual races, etc. at the end of the nurturing game. Note that the method of calculating the evaluation score, i.e., a formula for calculating the evaluation score, is prepared in advance, and the evaluation score is calculated on the basis of the prescribed formula. Note that there is no specific limitation to the method of calculating the evaluation score or the formula for calculating the evaluation score. For example, the evaluation score may be calculated on the basis of only the parameters that affect race results when the nurtured character participates in races in the team competition game or other race games, such as the ability parameters, the aptitude parameters, and the acquired skills at the end of the nurturing game.

Furthermore, each nurtured character has a nurturing rank set therefor on the basis of the evaluation score. The nurturing rank is an index indicating the strength of the nurtured character, and ranges of evaluation scores are associated with individual nurturing ranks. For example, nurturing rank “A+” is assigned to nurtured characters with evaluation scores of 13000 to 14499, and nurturing rank “S” is assigned to nurtured characters with evaluation scores of 14500 to 15499. With the nurturing rank assigned on the basis of the evaluation score, as described above, it becomes easier to recognize the approximate strength of each nurtured character. Note that the nurtured character information also includes the evaluation score and the nurturing rank.

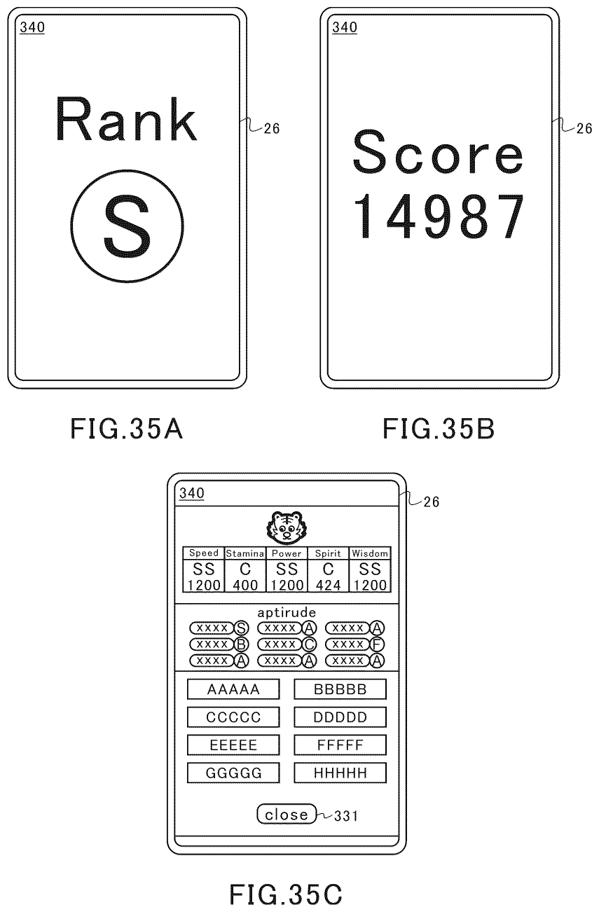

FIG. 35A is a first illustration for explaining a nurturing completion screen 340. FIG. 35B is a second illustration for explaining the nurturing completion screen 340. FIG. 35C is a third illustration for explaining the nurturing completion screen 340. When the nurturing game is finished, as shown in FIG. 35A, the nurturing completion screen 340 is displayed on the display 26. In the nurturing completion screen 340, the nurturing rank of the nurtured character that has been nurtured is first displayed, and the evaluation score is then displayed, as shown in FIG. 35B.

Furthermore, after the elapse of a prescribed time since the evaluation score is displayed, as shown in FIG. 35C, the ability parameters, the aptitude parameters, and the acquired skills of the nurtured character are displayed in the nurturing completion screen 340. At this time, a close operating part 331 is provided in the nurturing completion screen 340. When the close operating part 331 is tapped, the nurturing completion screen 340 becomes no longer displayed, and the home screen 100 is displayed on the display 26.

Note that when the nurturing game is finished, a lottery is performed to determine a factor to be acquired by the main character, and factor information is stored in association with the nurtured character. Although not shown, in the nurturing completion screen 340, the player can display the factor information acquired by the nurtured character.

Here, in this embodiment, the player can incorporate the nurtured character generated in the nurturing game into a team and can play a team competition game. In the team competition game, a race is simulated by using various kinds of parameters of the nurtured character that participates in the race. Furthermore, also in an individual race in the nurturing game, the result of the race is derived by way of simulation.

Furthermore, in the case where the player lets a nurtured character or the main character participate in a race, the player necessarily has to determine a strategy for the participating character. As described earlier, four strategies, namely, “early speed”, “front running”, “stretch running”, and “closing”, are provided here, from among which the player determines one strategy in consideration of the running-style aptitude of the participating character. Then, the race is simulated on the basis of the strategy determined by the player.

As an example, for a participating character that adopts the strategy “early speed”, simulation is performed such that the participating character constitutes the top group from the beginning of the race. As another example, for a participating character that adopts the strategy “closing”, simulation is performed such that the participating character stays behind until the final stretch of the race.

Specifically, in simulation for deriving the proceeding and result of a race, parameters that can be recognized by the player, such as speed and stamina, as well as parameters that cannot be recognized by the player, such as the top speed and the endurance consumed, are used. In simulation, these parameters are determined in association with the strategy, and the actions of the character are determined on the basis of the parameters determined. Therefore, it can be said that the strategy that is determined on the basis of the input of an operation by the player is a parameter that is used in simulation for deriving the proceeding and result of a race. As described above, in simulation, other parameters are set on the basis of a strategy selected by the player, and character actions are determined on the basis of the other parameters, whereby a participating character acts autonomously. Accordingly, the proceeding and result for the same participating character may vary considerably when the strategy is changed.

Here, in order to further increase variety in the proceeding of a race, it is conceivable to further divide strategies that can be set for a participating character. However, when strategies are finely divided, the design work becomes extremely laborious. Furthermore, with too many strategies that can be selected, it becomes rather difficult for the player to select an optimal strategy, which might compromise the fun of the game.

In this embodiment, main attributes and sub-attributes are provided as attributes of strategies, and each strategy belongs to either main attributes or sub-attributes. The abovementioned four strategies “early speed”, “front running”, “stretch running”, and “closing” all belong to main attributes. Meanwhile, each sub-attribute is associated with one of the main attributes. In other words, a strategy that belongs to sub-attributes is managed in association with one of the main attributes or a strategy that belongs to main attributes.

For example, with the strategy “early speed”, which belongs to main attributes, a strategy “super early speed”, which belongs to sub-attributes, is associated. Furthermore, in the case where the specific condition is not satisfied, it is possible to set the strategy “early speed”, which is a main attribute. Meanwhile, when the specific condition is satisfied, instead of the strategy “early speed”, which belongs to main attributes, it is possible to set the strategy “super early speed” which belongs to the sub-attribute associated with the main attribute.

However, the arrangement may be such that the player can set the strategy “early speed” in the case where the specific condition is not satisfied and such that the player can select the strategy “early speed” or “super early speed” in the case where the specific condition is satisfied. Alternatively, the arrangement may be such that it is possible to set the strategy “early speed” in the case where the specific condition is not satisfied and such that either the strategy “early speed” or “super early speed” is set through a lottery in the case where the specific condition is satisfied. The following describes strategies that belong to sub-attributes.

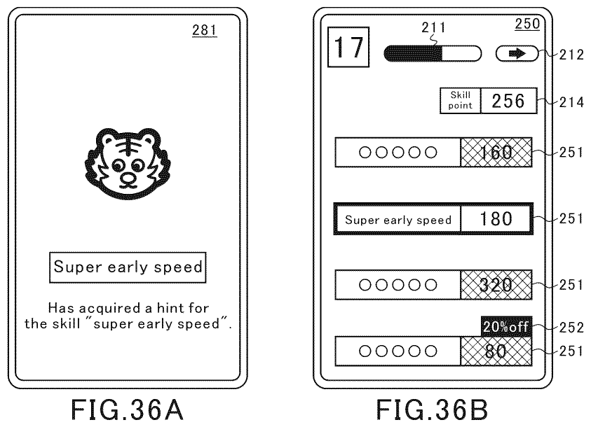

FIG. 36A is a first illustration for explaining a special skill, and FIG. 36B is a second illustration for explaining the special skill. In this embodiment, special skills are provided as skills that are possessed by specific characters. In the case where the nurturing game is started by using such a specific character as the main character, it becomes possible for the main character to acquire special skills in the nurturing game. Here, a skill “super early speed” is provided as a special skill.

In order to acquire the special skill, thereby making it an acquired skill, it is necessary to first acquire a hint for the special skill. An acquisition condition is set for a hint for the special skill, and the main character acquires a hint for the special skill when the acquisition condition is satisfied. Here, seven victories in GI races by the specific character in the nurturing game is set as the condition for acquiring a hint for the special skill.

As described earlier, when the main character participates in an individual race, the individual-race result screen 280 shown in FIGS. 24C and 24D is displayed. At this time, when the number of victories in GI races in a single session of the nurturing game reaches seven as a result of winning the first places in races, a special hint event occurs after the displaying of the individual-race result screen 280 is finished. In the special hint event, as shown in FIG. 36A, an event screen 281 is displayed. In the event screen 281, it is reported to the player that a hint for the skill “super early speed”, which is a special skill, has been acquired.

When the hint for the special skill has been acquired, the main character possesses the special skill. In the state where the special skill is possessed, as shown in FIG. 36B, a skill display field 251 corresponding to the special skill is displayed in the skill screen 250. The player can acquire the special skill by consuming skill points in the skill screen 250.

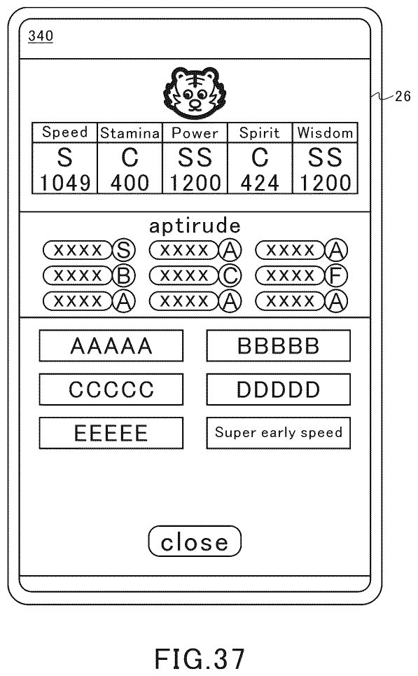

FIG. 37 is a fourth illustration for explaining the nurturing completion screen 340. When the main character has acquired a special skill in the nurturing game, a nurtured character having the special skill associated therewith as an acquired skill is generated. In this case, at the completion of the nurturing game, it is reported in the nurturing completion screen 340 that the nurtured character has acquired the special skill. Here, an icon labeled as “super early speed” corresponding to the special skill is displayed in a list of acquired skills.

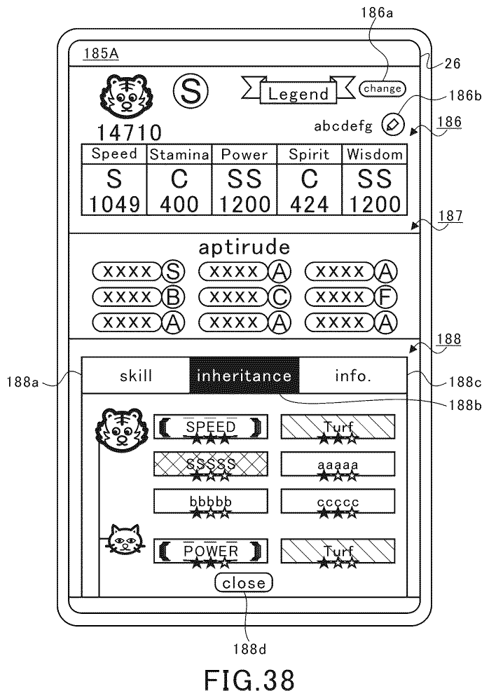

FIG. 38 is a fourth illustration for explaining the character detail dialog 185A. As described earlier, upon the completion of the nurturing game, lotteries are performed to determine factors to be acquired by the main character, and factor information is stored in association with the nurtured character. The factors include a skill factor, and whether or not to acquire a skill factor corresponding to a skill acquired by the main character is determined through a lottery. In the nurturing game, the factors possessed by each nurtured character registered in the deck as an inherited character are invoked with prescribed probabilities. When a skill factor is invoked, the main character to be nurtured can acquire a hint for the skill.

However, no skill factor is set to a special skill. Therefore, even if the main character acquires a special skill in the nurturing game, a skill factor corresponding to the special skill is not assigned at the completion of nurturing of the main character. Therefore, as shown in FIG. 38, when the character detail dialog 185A is displayed for a nurtured character having a special skill, a skill factor corresponding to the special skill is not displayed.

Note that in a screen in which detail information concerning a nurtured character is displayed, such as the nurturing completion screen 340 shown in FIG. 37, information indicating that no factor is assigned may be displayed in association with the icon labeled as “super early speed” corresponding to the special skill.

As described above, no factor is set to a special skill. Therefore, in this embodiment, there is no way for acquiring a special skill other than acquiring a special skill by consuming skill points after the condition for acquiring a hint for the special skill is satisfied. Furthermore, as described above, the condition for acquiring a hint for the special skill is for a specific character to win seven GI races. Thus, it is not possible to acquire the special skill in the case where a character other than the specific character is used as the main character. That is, it can be said that the special skill is a skill that is exclusive for the specific character.

Note that the condition for acquiring a special skill is not limited to the above. For example, the arrangement may be such that a skill factor corresponding to a special skill is provided and such that the main character acquires the special skill by invoking the skill factor possessed by an inherited character. Furthermore, for example, a first hint event or a second hint event that makes it possible to possess a special skill may be set to a support card. Furthermore, a hint event that makes it possible to possess a special skill may be provided among scenario events and exclusive events that are set for individual characters. Furthermore, for example, the player may be allowed to acquire a special skill or a hint that makes it possible to possess a special skill by consuming the special currency acquired by the player.

When a special skill has been acquired, the special skill is invoked in individual races in the nurturing game or in team competition races in which the nurtured character participates after the completion of nurturing. Although each skill is usually invoked in the case where a lottery as to whether or not to invoke is won, the special skill is necessarily invoked in the case where a prescribed invocation condition is satisfied.

Specifically, it is set as the condition for invoking a special skill that the participating character possesses the special skill as an acquired skill and that the strategy of the participating character is “early speed”. When the invocation condition is satisfied, the strategy of the participating character is changed from “early speed” to “super early speed”. However, the condition for invoking a special skill is not limited to the above. For example, the arrangement may be such that a special skill is invoked in the case where a lottery is won and the strategy of the participating character is set to “super early speed”.

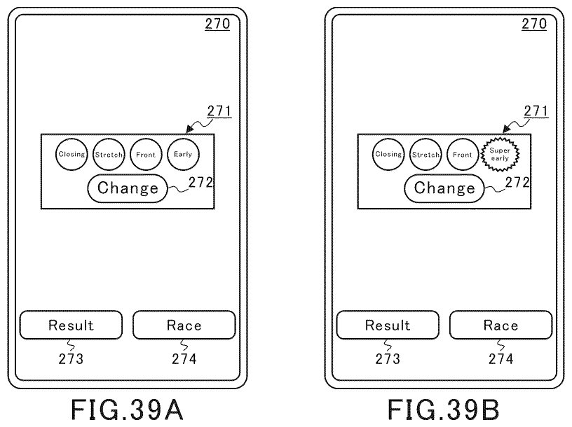

FIG. 39A is an illustration for explaining an individual-race start screen 270 in the embodiment. FIG. 39B is an illustration for explaining an individual-race start screen 270 in a modification. As described above, the strategy being set to “super early speed” is attributable to nothing but the invocation of a skill. Therefore, in this embodiment, even if a special skill is possessed, the strategies that the player can select are limited to the four strategies that belong to main attributes. Therefore, as shown in FIG. 39A, in the strategy displaying part 271 of the individual-race start screen 270, four selecting parts that make it possible to distinguish among the four strategies “early speed”, “front running”, “stretch running”, and “closing” are provided.

Note that in this embodiment, in the case where a special skill is possessed, when the strategy “early speed” is selected, the special skill is necessarily invoked, and the strategy is changed to “super early speed”. Therefore, as in the modification shown in FIG. 39B, in the state where the special skill has been acquired, “super early speed” may be displayed in the selecting part corresponding to the strategy “early speed”. That is, in the individual-race start screen 270, selecting parts corresponding to the individual strategies that belong to main attributes are displayed so that the player can select one of the selecting parts. Furthermore, in the case where a strategy that belongs to main attributes, corresponding to the selecting part selected by the player, is set and a specific condition is satisfied (the special skill has been acquired), the selecting part corresponding to “early speed”, which belongs to main attributes, may be changed to a selecting part corresponding to “super early speed”, which belongs to sub-attributes.

Note that although the individual-race start screen 270 that is displayed in the nurturing game has been described here, as shown in FIG. 39B, the strategy displaying part 271 may be displayed also in the case where a nurtured character participates in a race such as a team competition game.

Next, the functional configurations of the player terminal 1 and the server 1000 for executing the nurturing game described above will be described.

### (Functional Configuration of Player Terminal 1)

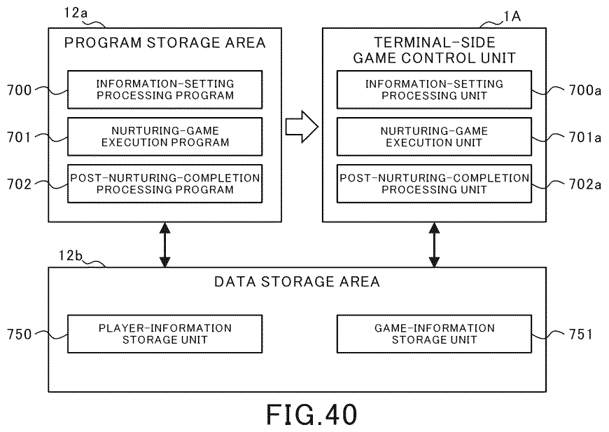

FIG. 40 is a diagram for explaining the configuration of the memory 12 at the player terminal 1, as well as the functions thereof as a computer. In the memory 12, a program storage area 12a and a data storage area 12b are provided. Upon the start of the game, the CPU 10 stores terminal-side game control programs (modules) in the program storage area 12a.

The terminal-side game control programs include an information-setting processing program 700, a nurturing-game execution program 701, and a post-nurturing-completion processing program 702. Note that the programs listed in FIG. 40 are examples, and the terminal-side game control programs include a large number of other programs.

In the data storage area 12b, a player-information storage unit 750 and a game-information storage unit 751 are provided as storage units for storing data. Note that a large number of other storage units are provided in the data storage area 12b. Here, information directly relating to games (hereinafter referred to as game information), such as the nurturing game, is stored in the game-information storage unit 751.

Note that various kinds of information are also tentatively stored in the game-information storage unit 751 while each game such as the nurturing game is in progress. Therefore, all information relating to nurtured characters nurtured in the nurturing game is stored in the game-information storage unit 751. Meanwhile, all information other than game information, such as information concerning the player or other player, as well as setting information of the player terminal 1, is considered as player information. The player information is stored in the player-information storage unit 750.

The CPU 10 runs the individual programs stored in the program storage area 12a to update the data in the individual storage units in the data storage area 12b. Then, by running the individual programs stored in the program storage area 12a, the CPU 10 causes the player terminal 1 (computer) to function as a terminal-side game control unit 1A. The terminal-side game control unit 1A includes an information-setting processing unit 700a, a nurturing-game execution unit 701a, and a post-nurturing-completion processing unit 702a.

Specifically, the CPU 10 runs the information-setting processing program 700, thereby causing the computer to function as the information-setting processing unit 700a. Similarly, the CPU 10 runs the nurturing-game execution program 701 and the post-nurturing-completion processing program 702, thereby causing the computer to function as the nurturing-game execution unit 701a and the post-nurturing-completion processing unit 702a, respectively.

The information-setting processing unit 700a stores information concerning settings in the player-information storage unit 750 as player information in the case where various kinds of information have been set at the player terminal 1. Furthermore, in the case where the information in the player-information storage unit 750 has been updated, the information-setting processing unit 700a transmits update information to the server 1000.

Furthermore, the nurturing-game execution unit 701a executes all processing relating to the nurturing game. Specifically, the nurturing-game execution unit 701a executes the preparation stage process and the nurturing stage process.

The post-nurturing-completion processing unit 702a stores nurtured character information upon completion of the nurturing game, the nurtured character information including the ability parameters, the aptitude parameters, the acquired skills, the inheritance information, and the factor information of the nurtured character, the kinds of characters used for nurturing, etc.

### (Functional Configuration of Server 1000)

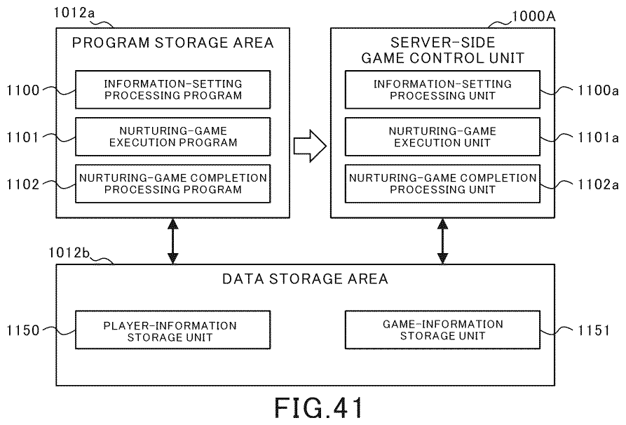

FIG. 41 is a diagram for explaining the configuration of the memory 1012 at the server 1000, as well as the functions thereof as a computer. In the memory 1012, a program storage area 1012a and a data storage area 1012b are provided. Upon the start of the game, the CPU 1010 stores server-side game control programs (modules) in the program storage area 1012a.

The server-side game control programs include an information-setting processing program 1100, a nurturing-game execution program 1101, and a nurturing-game completion processing program 1102. Note that the programs listed in FIG. 41 are examples, and the server-side game control programs include a large number of other programs.

In the data storage area 1012b, a player-information storage unit 1150 and a game-information storage unit 1151 are provided as storage units for storing data. Note that a large number of other storage units are provided in the data storage area 1012b. Here, the game information of all the players is stored in the game-information storage unit 1151 in association with player IDs. Furthermore, the player information of all the players is stored in the player-information storage unit 1150 in association with player IDs.

The CPU 1010 runs the individual programs stored in the program storage area 1012a to update the data in the individual storage units in the data storage area 1012b. Then, by running the individual programs stored in the program storage area 1012a, the CPU 1010 causes the server 1000 (computer) to function as a server-side game control unit 1000A. The server-side game control unit 1000A includes an information-setting processing unit 1100a, a nurturing-game execution unit 1101a, and a nurturing-game completion processing unit 1102a.

Specifically, the CPU 1010 runs the information-setting processing program 1110, thereby causing the computer to function as the information-setting processing unit 1100a. Similarly, the CPU 1010 runs the nurturing-game execution program 1101 and the nurturing-game completion processing program 1102, thereby causing the computer to function as the nurturing-game execution unit 1101a and the nurturing-game completion processing unit 1102a, respectively.

In the case where various kinds of information have been set at the player terminal 1, the information-setting processing unit 1100a updates the player information in the player-information storage unit 1150 on the basis of update information received from the player terminal 1. Furthermore, the information-setting processing unit 1100a measures time and updates the game points of individual players.

The nurturing-game execution unit 1101a executes all processing relating to the nurturing game.

The nurturing-game completion processing unit 1102a derives an evaluation score, a nurturing rank, etc. for the nurtured character that has been nurtured upon completion of the nurturing game. Furthermore, the nurturing-game completion processing unit 1102a determines factors to be acquired by the nurtured character through lotteries. Furthermore, nurtured character information is stored in the game-information storage unit 1151 in association with the player ID, the nurtured character information including the ability parameters, the aptitude parameters, the acquired skills, the inheritance information, and the factor information of the nurtured character, the kinds of characters used for nurturing, etc.

Note that the information-setting processing unit 700a in the player terminal 1 and the information-setting processing unit 1100a in the server 1000 are common in that both store player information, but the kinds of specific processing and the range of player information to store therein differ from each other. Furthermore, the nurturing-game execution unit 701a in the player terminal 1 and the nurturing-game execution unit 1101a in the server 1000 are common in that both execute processing relating to the nurturing game, but these units have different roles, i.e., these units are in charge of different ranges.

The processes that are carried out by the individual functional units in the player terminal 1 and the server 1000 described above will be described with reference to flowcharts.

### (Processes at Player Terminal 1 and Server 1000)

### <Processes Relating to Nurturing Game>

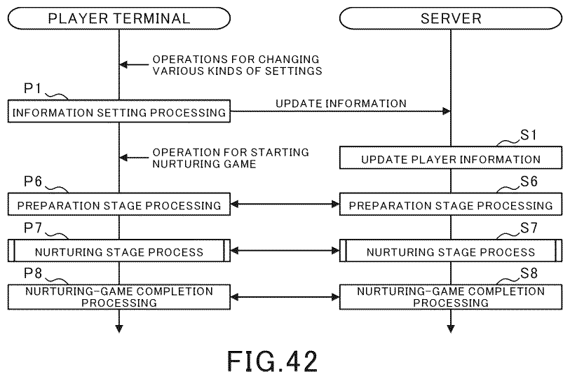

FIG. 42 is a sequence chart for explaining processes at the player terminal 1 and the server 1000, relating to the nurturing game. Note that in the following description, processes at the player terminal 1 will be signified by Pn (n is an arbitrary integer). Furthermore, processes at the server 1000 will be signified by Sn (n is an arbitrary integer).

When the player has performed an operation to change various kinds of settings at the player terminal 1, the information-setting processing unit 700a of the player terminal 1 performs information setting processing (P1) for updating the player-information storage unit 750 on the basis of the operation input by the player. In the information setting processing, update information is transmitted to the server 1000. At the server 1000, upon receiving the update information, the information-setting processing unit 1100a updates the player information in the player-information storage unit 1150 (S1).

Note that the player information that is updated in P1 and S1 includes, for example profile information that can be set by the player. Furthermore, for example, when an operation for adding another player as a friend or unregistering another player who has been a friend is input as a setting changing operation, friend information, which is information concerning friends, is updated. Note that in P1 and S1, the information-setting processing unit 700a and the information-setting processing unit 1100a each manage game points that are consumed for the execution of the nurturing game. In the case where the game points are less than an upper-limit value, the information-setting processing units 700a and 1100a measure time and grant game points to the player at prescribed intervals by a prescribed value each time.

When a nurturing-game start operation for starting the nurturing game is input at the player terminal 1, the nurturing-game execution unit 701a executes a preparation stage process (P6). Furthermore, during the preparation stage process, communication processing is carried out between the player terminal 1 and the server 1000. At the server 1000, the nurturing-game execution unit 1101a executes preparation stage processing (S6) on the basis of information received from the player terminal 1. In the preparation stage process (P6 and S6), a deck including characters to inherit and support cards is set and registered on the basis of operations performed by the player.

When the preparation stage process (P6) is finished, the nurturing-game execution unit 701a executes the nurturing stage process (P7). Furthermore, during the nurturing stage process, communication processing is carried out between the player terminal 1 and the server 1000. At the server 1000, the nurturing-game execution unit 1101a executes nurturing stage processing (S7) on the basis of information received from the player terminal 1. Note that actually, the player terminal 1 and the server 1000 share roles such that the main nurturing game proceeds through the nurturing stage process (P7) at the player terminal 1 and the nurturing stage process (S7) at the server 1000.

Note that some or all of the individual processing steps in the nurturing stage process (P7) at the player terminal 1 may be carried out in the nurturing stage process (S7) at the server 1000 and that some or all of the individual processing steps in the nurturing stage process (S7) at the server 1000 may be carried out in the nurturing stage process (P7) at the player terminal 1.

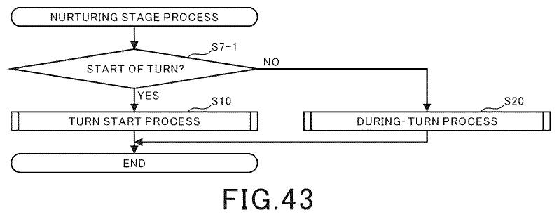

FIG. 43 is a flowchart for explaining the nurturing stage process at the server 1000. The nurturing-game execution unit 1101a of the server 1000 executes a turn start process (S10) when the current timing is the start of a turn (YES in S7-1), while executing a during-turn process (S20) when the current timing is not the start of a turn.

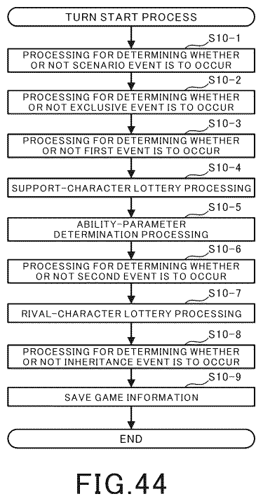

FIG. 44 is a flowchart for explaining the turn start process at the server 1000. As shown in FIG. 44, first, the nurturing-game execution unit 1101a of the server 1000 executes processing for determining whether or not a scenario event is to occur (S10-1). Here, in the case where there is a scenario event that is necessarily to occur in the current number of turns, the nurturing-game execution unit 1101a determines that the scenario event is to occur. Meanwhile, in the case where there is no scenario event that is necessarily to occur in the current number of turns, the nurturing-game execution unit 1101a determines whether or not a scenario event is to occur, as well as the kind of scenario event that is to occur, through a lottery.

Furthermore, the nurturing-game execution unit 1101a executes processing for determining whether or not an exclusive event is to occur (S10-2). Here, in the case where there is an exclusive event that is necessarily to occur in the current number of turns, the nurturing-game execution unit 1101a determines that the exclusive event is to occur. Meanwhile, in the case where there is no exclusive event that is necessarily to occur in the current number of turns, the nurturing-game execution unit 1101a determines whether or not an exclusive event is to occur, as well as the kind of exclusive event that is to occur, through a lottery.

Furthermore, the nurturing-game execution unit 1101a executes processing for determining whether or not a first event is to occur (S10-3). Here, at the start of a turn, a random number is obtained at random, and whether or not a first event is to occur, as well as the kind of first event that is to occur, are determined on the basis of the random number obtained and the first event table.

Furthermore, the nurturing-game execution unit 1101a executes support-character lottery processing (S10-4). Specifically, the nurturing-game execution unit 1101a determines whether or not to assign a support character to each training item through a lottery with reference to the assign/do-not-assign table shown in FIG. 27. This processing is executed for each support character.

Note that in the case where it has been determined to assign a support character to a training item, the nurturing-game execution unit 1101a may execute processing for associating the support character ID or the support card (used game medium) ID corresponding to the support character with the training ID corresponding to the training item (parameter changing element).

Furthermore, the nurturing-game execution unit 1101a executes ability-parameter determination processing (S10-5). In the ability-parameter determination processing, values by which the ability parameters of the main character are raised in the case where the individual items of training have been executed and have been successful are determined. Specifically, the nurturing-game execution unit 1101a determines values by which the ability parameters of the main character are raised in the case of successful training for all the training items with reference to the training level table shown in FIG. 28A, the fixed raising-value tables shown in FIGS. 28B and 28C, and the bonus addition rate table shown in FIG. 28D. Furthermore, the nurturing-game execution unit 1101a determines the amounts of decrease in physical energy or the amounts of recovery of physical energy in the case where the individual items of training have been executed with reference to a physical energy table, which is not shown. Furthermore, the nurturing-game execution unit 1101a calculates failure rates of training for the individual training items on the basis of the physical energy of the main character.

Furthermore, the nurturing-game execution unit 1101a executes processing for determining whether or not a second event is to occur (S10-6). Specifically, the nurturing-game execution unit 1101a determines whether or not a second event is to occur through a lottery with reference to the second event table shown in FIG. 29. Specifically, after the support-character lottery processing (S10-4), a random number is obtained at random, and whether or not a second event is to occur is determined on the basis of the random number obtained and the second event table. Here, for example, the nurturing-game execution unit 1101a performs assignment lotteries for determining whether or not to make it possible to assign support events preset for the support cards associated with the training items in S10-4.

Furthermore, the nurturing-game execution unit 1101a executes rival-character lottery processing (S10-7). Specifically, the nurturing-game execution unit 1101a determines whether or not to assign a rival character in each matching race through a lottery with reference to the assign/do-not-assign table shown in FIG. 32.

Furthermore, the nurturing-game execution unit 1101a executes processing for determining whether or not an inheritance event is to occur (S10-8). Specifically, the nurturing-game execution unit 1101a determines that an inheritance event is to occur in the case where the current turn is a factor invoking turn. In this case, the nurturing-game execution unit 1101a determines whether or not each factor is to be invoked on the basis of the factor information of the characters to inherit registered in the deck in the preparation stage process in S6. Thus, ability parameters or aptitude parameters are raised or skill hints are acquired in accordance with the factors determined to be invoked.

The nurturing-game execution unit 1101a saves game information in the game-information storage unit 1151 so that the player terminal 1 can receive the game information, the game information including information concerning the results of lotteries in S10-1 to S10-8 (S10-9).

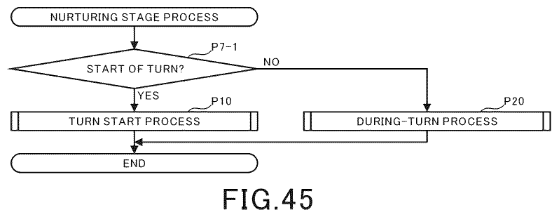

FIG. 45 is a flowchart for explaining the nurturing stage process at the player terminal 1. The nurturing-game execution unit 701a of the player terminal 1 executes a turn start process (P10) when the current timing is the start of a turn (YES in P7-1), while executing a during-turn process (P20) when the current timing is not the start of a turn.

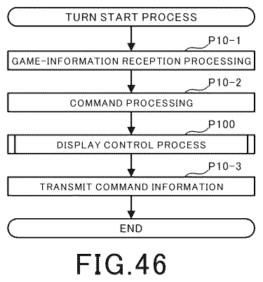

FIG. 46 is a flowchart for explaining the turn start process at the player terminal 1. As shown in FIG. 46, the nurturing-game execution unit 701a accesses the game-information storage unit 1151 of the server 1000 and receives the game information saved in S10-9 from the server 1000 (P10-1).

Then, the nurturing-game execution unit 701a executes command processing for making it possible for the player to select various kinds of commands relating to the nurturing stage process (P10-2). Specifically, for example, with reference to the selection item table shown in FIG. 19, the nurturing-game execution unit 701a performs processing, on the basis of the current number of turns, for making it possible for the player to select various kinds of commands such as the rest operating part 215, the training operating part 216, the skill operating part 217, the going-out operating part 218, the individual-race operating part 219, the shop operating part 220, and the item operating part 221. Furthermore, the nurturing-game execution unit 701a performs processing that makes it possible for the player to select a plurality of individual-race selection operating parts 261 associated with the individual-race operating part 219.

Furthermore, in the command processing, the nurturing-game execution unit 701a makes it possible for the player to select commands corresponding to the individual training items, namely, the speed operating part 241, the stamina operating part 242, the power operating part 243, the spirit operating part 244, and the wisdom operating part 245. The nurturing-game execution unit 701a performs processing for making it possible for the player to select one command from among these plurality of commands.

Upon the completion of the command processing, the nurturing-game execution unit 701a executes display control process (P100).

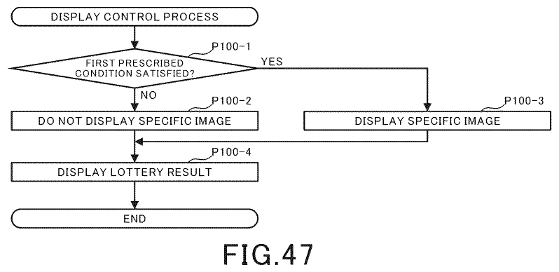

FIG. 47 is a flowchart for explaining the display control process at the player terminal 1. As shown in FIG. 47, the nurturing-game execution unit 701a executes first-prescribed-condition determination processing for determining whether or not a first prescribed condition is satisfied (P100-1). The first-prescribed-condition determination processing is processing in which whether or not to assign rival character is determined on the basis of the result of the rival-character lottery processing in S10-7. The nurturing-game execution unit 701a determines that the first prescribed condition is satisfied in the case where it is determined to assign a rival character, while determining that the first prescribed condition is not satisfied in the case where it is not determined to assign a rival character.

Furthermore, the first-prescribed-condition determination processing is processing in which it is determined whether or not a specific race is included among races that can be selected in the current turn. The specific race is, for example, a race in which it is possible to acquire a special item, described earlier, when a period-specific event is held. That is, in the first-prescribed-condition determination processing, whether or not the first prescribed condition is satisfied is determined on the basis of the kinds of races that can be selected in the current turn. The nurturing-game execution unit 701a determines that the first prescribed condition is satisfied in the case where a specific race is included in the races that can be selected, while determining that the first prescribed condition is not satisfied in the case where no specific race is included.

In the case where the first prescribed condition is not satisfied (NO in P100-1), the nurturing-game execution unit 701a does not display the rival-character report indication 321, performing control such that the rival-character report indication 321 is not displayed on the display 26 (P100-2).

Meanwhile, in the case where the first prescribed condition is satisfied (YES in P100-1), the nurturing-game execution unit 701a performs control such that the rival-character report indication 321 is displayed on the display 26 (P100-3). Specifically, on the basis of the satisfaction of the first prescribed condition, the nurturing-game execution unit 701a executes processing for displaying the rival-character report indication 321 associated with the individual-race operating part 219. Here, the nurturing-game execution unit 701a determines whether or not to display the rival-character report indication 321 in a manner superimposed on the individual-race operating part 219 on the basis of the result of the lottery in the rival-character lottery processing in S10-7 executed on a per-turn basis at the server 1000.

Furthermore, the nurturing-game execution unit 701a, on the basis of the satisfaction of the first prescribed condition, executes processing for displaying the rival-character report indication 321 in association with the individual-race selection operating parts 261 corresponding to one or more individual races. Specifically, the nurturing-game execution unit 701a determines whether or not to display the rival-character report indication 321 for the individual kinds of races of the individual-race selection operating parts 261 on the basis of the parameters (e.g., the aptitude parameters concerning the track aptitude and the distance aptitude) of the main character.

Furthermore, the nurturing-game execution unit 701a displays the results of lotteries on the display 26 on the basis of the results of lotteries in the support-character lottery processing in S10-4 executed at the server 1000 (P100-4). Here, the nurturing-game execution unit 701a displays the support cards associated with the individual training items, as well as information concerning the results of lotteries for assigning support events, on the display 26.

Referring back to FIG. 46, in the case where the player performs an operation to select one of the various kinds of commands after the display control process, the nurturing-game execution unit 701a transmits command information indicating the selected command to the server 1000 (P10-3).

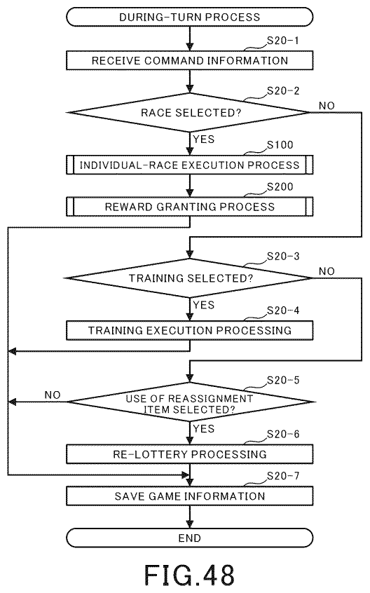

FIG. 48 is a flowchart for explaining the during-turn process at the server 1000. As shown in FIG. 48, when the command information is transmitted from the player terminal 1, the nurturing-game execution unit 1101a receives the transmitted command information (S20-1).

Upon receiving the command information, the nurturing-game execution unit 1101a determines whether or not the command of the individual-race operating part 219 is selected by the player (S20-2). In the case where the command of the individual-race operating part 219 is selected (YES in S20-2), the nurturing-game execution unit 1101a performs an individual-race execution process for letting the main character participate in an individual race (S100).

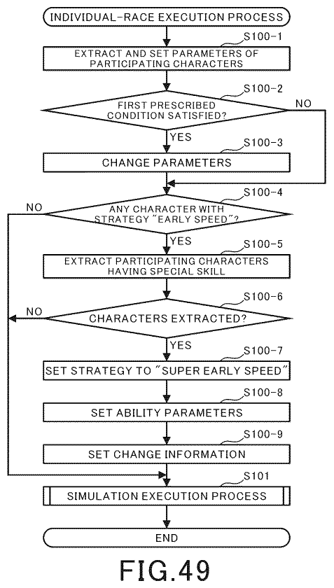

FIG. 49 is a flowchart for explaining the individual-race execution process at the server 1000. As shown in FIG. 49, the nurturing-game execution unit 1101a extracts and sets the parameters of all the participating characters that participate in the race (S100-1). Here, the ability parameters as well as the aptitude parameters concerning the distance aptitudes and running-style aptitudes of the individual participating characters, as well as the strategies set for NPCs and the strategy selected by the player, are set. Furthermore, in the case where the first prescribed condition is satisfied in the individual race in which the main character participates (YES in S100-2), the nurturing-game execution unit 1101a executes processing for changing the parameters of the NPC having the same character ID as the rival character (S100-3).

For example, the nurturing-game execution unit 1101a multiplies the ability parameters of the normal NPC having the same character ID as the rival character by a prescribed factor (e.g., ×1.1) and lets the NPC having the parameters changed in the individual race as the rival character.

Furthermore, in the case where there are participating characters with the strategy “early speed” (YES in S100-4), the nurturing-game execution unit 1101a extracts participating characters having a special skill from among the participating characters with the strategy “early speed” (S100-5). Note that a special skill may be provided for NPCs, without limitation to the main character. Furthermore, NPCs that participate in an individual race have strategies preset therefor.

In the case where participating characters having a special skill have been extracted (YES in S100-6), the nurturing-game execution unit 1101a sets the strategy of the extracted participating characters to “super early speed” (S100-7).

Furthermore, the nurturing-game execution unit 1101a sets the ability parameters of the participating characters having the strategy “super early speed” set therefor (S100-8). Note that here, some of the ability parameters are changed so as to be advantageous than before the changes, and the other some of the ability parameters are changed so as to be disadvantageous than before the changes. In one example, parameters that are not displayed to the player are set, such as the total amount of endurance, the amount of decrease in endurance per unit time, the amount of increase in speed per unit time while accelerating, an upper-limit value of the top speed, and the differences in distance from other participating characters, referred to when adjusting the own position in a pack of horses. Note that how the ability parameters are changed may be designed as appropriate. For example, in the case of the strategy “super early speed”, changes may be made such that all the ability parameters become advantageous compared with the strategy “early speed”.

Furthermore, the nurturing-game execution unit 1101a sets change information indicating that the strategy has been changed to “super early speed” so that the change information will be received by the player terminal 1 (S100-9).

Then, the nurturing-game execution unit 1101a carries out a simulation execution process for deriving the proceeding of the race and the result of the race by way of simulation on the basis of the various kinds of parameters set in S100-1 to S100-9 (S101). Through the simulation execution process, autonomous action modes of the participating characters are determined.

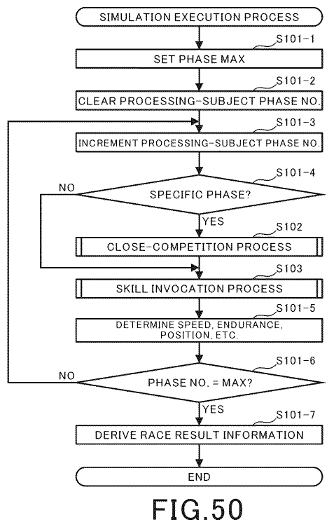

FIG. 50 is a flowchart for explaining the simulation execution process at the server 1000. Each race, from start to goal, is divided into a plurality of phases. In a race simulation, for each participating character, the speed, endurance, positioning, whether or not a skill is to be invoked, etc. are computed on a per-phase basis from the start to the goal. The nurturing-game execution unit 1101a sets the number of phases of the goal (phase max) on the basis of the distance of an individual race that is executed (S101-1). Furthermore, the nurturing-game execution unit 1101a clears a processing-subject phase No. indicating the phase number of the processing subject (S101-2).

Then, the nurturing-game execution unit 1101a increments the processing-subject phase No. (S101-3). In the case where the processing subject phase is a specific phase according to the processing-subject phase No. updated in S101-3 (S101-4), the nurturing-game execution unit 1101a executes a close competition process (S102). Note that the specific phase is, for example, a phase from the beginning to the middle of the race, and participating characters perform a close competition during the race in the case where a prescribed condition is satisfied.

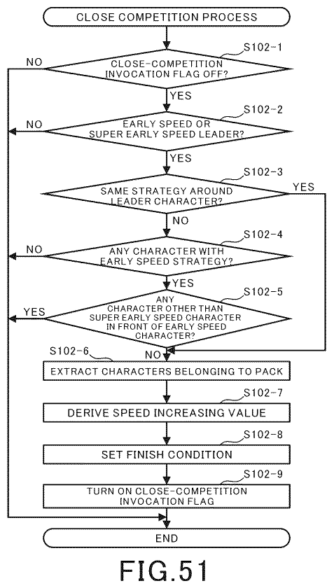

FIG. 51 is a flowchart for explaining the close competition process at the server 1000. The nurturing-game execution unit 1101a determines whether a close-competition invocation flag is off (S102-1). Note that the close-competition invocation flag is turned on in S102-9, which will be described later, when a close competition is invoked.

In the case where the close-competition invocation flag is off (YES in S102-1), i.e., in the case where a close competition is not invoked, the nurturing-game execution unit 1101a determines whether or not the strategy of the currently leading participating character is “early speed” or “super early speed” (S102-2). In the case where the strategy of the leading participating character is “early speed” or “super early speed” (YES in S102-2), the nurturing-game execution unit 1101a determines whether or not there is any participating character with the same strategy as the leading participating character in a prescribed range around the leading participating character.

Here, in the case where the strategy of the leading participating character is “early speed”, it is determined whether or not there is any participating character with the strategy “early speed” in the prescribed range around the leading participating character. Meanwhile, in the case where the strategy of the leading participating character is “super early speed”, it is determined whether or not there is any participating character with the strategy “super early speed” within the prescribed range around the leading participating character.

In the case where there is no participating character with the same strategy as the leading participating character (NO in S102-3), the nurturing-game execution unit 1101a determines whether or not there are participating characters with the strategy “early speed” among the participating characters (S102-4). In the case where there are participating characters with the strategy “early speed” (YES in S102-4), the nurturing-game execution unit 1101a determines whether or not there is any participating character with a strategy other than “super early speed” in front of the leading participating character among the participating characters with the strategy “early speed” (S102-5).

In the case where there is no participating character with a strategy other than “super early speed” in front of the leading participating character (NO in S102-5), or in the case where there is a participating character with the same strategy as the leading participating character around the leading participating character (YES in S102-3), the nurturing-game execution unit 1101a extracts participating characters that belong to a pack (S102-6).

Here, the nurturing-game execution unit 1101a determines the leading participating character among all the participating characters, or the leading participating character among the participating characters with the strategy “early speed” identified in S102-4, as a target character. Then, the nurturing-game execution unit 1101a extracts the target character as well as participating characters located around the prescribed range of the target character and having the same strategy as the target character as participating characters belonging to a pack.

For example, in the case where a participating character with the strategy “super early speed” is leading and there is another participating character with the strategy “super early speed” within the prescribed range around the leading participating character, these two participating characters with the strategy “super early speed” are extracted as participating characters belonging to a pack. Meanwhile, in the case where a participating character with the strategy “early speed” is leading and there are two other participating characters with the strategy “early speed” within the prescribed range around the leading participating character, these three participating characters with the strategy “early speed” are extracted as participating characters belonging to a pack.

As another example, suppose that a participating character with the strategy “super early speed” is leading, the strategies of all the three participating characters at the second to fourth positions are all “early speed”, and these three participating characters are mutually located within the prescribed range. At this time, the participating character at the second position is determined as the target character, and the participating characters at the second to fourth positions are extracted as participating characters belonging to a pack.

The nurturing-game execution unit 1101a derives a speed adding value for the participating characters extracted in S102-6 (S102-7). Here, the speed adding value is derived while inputting the values of “spirit” to a prescribed formula among the ability parameters of the individual participating characters. The formula is designed such that the speed becomes faster as the value of “spirit” becomes greater. However, there is no particular limitation to the method of calculating the speed adding value or parameters that are input to the formula.

Furthermore, for example, in the case where a close competition occurs, the endurance of the participating characters belonging to a pack may be decreased in inverse proportion to increasing speeds of the participating characters. The endurance is a parameter that is calculated, for example, from the stamina, and the speed of a participating character is decreased when the endurance becomes less than or equal to a prescribed value. That is, the arrangement may be such that when a close competition occurs, the development of the race becomes partially advantageous, such as an increase in the speed of a participating character, while the development of the race becomes partially disadvantageous, such as a decrease in the endurance of the participating character.

Then, the nurturing-game execution unit 1101a sets a finish condition for finishing the close competition (S102-8). Here, for example, the elapse of a prescribed time, the progress of the phase by a prescribed number, or the like is set as the finish condition. Then, the nurturing-game execution unit 1101a turns on the close-competition invocation flag to finish the close competition process (S102-9).

Since a close competition occurs as a result of a prescribed condition being satisfied in a race, as described above, the development of the race becomes varied, which enhances the fun of the game. Furthermore, as a result of the strategy being changed from “early speed” to “super early speed”, participating characters involved in the close competition, the position of the pack of participating characters involved in the close competition, etc. change. This further increases variety in the development of the race.

Note that it is assumed here that a close competition occurs among participating characters with the strategy “early speed” or “super early speed”. Alternatively, similarly to the above, for example, a close competition may occur among participating characters with other strategies, such as participating characters with “front running” or participating characters with “stretch running”. As another example, a close competition may occur similarly to the above while considering that participating characters with different strategies belong to a single group.

Furthermore, although it is assumed there that a close competition occurs only once during one race, a plurality of close competitions may occur during one race. In this case, for example, in the case where a close competition has occurred, a downtime in which the occurrence of the next close competition is prohibited should be provided.

Referring back to FIG. 50, in the case where the processing subject phase is not a specific phase (NO in S101-4) or the close competition process (S102) has been executed, the nurturing-game execution unit 1101a performs a skill invocation process (S103).

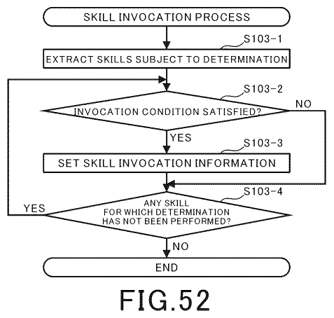

FIG. 52 is a flowchart for explaining a skill invocation process at the server 1000. The nurturing-game execution unit 1101a extracts skills for which whether or not to invoke is to be determined (S103-1) and determines whether or not the invocation condition is satisfied for each of the skills extracted (S103-2). Example invocation conditions include the position and strategy of the participating characters, as well as whether or not the participating character matches the race. For example, there are skills for which positions in a race are set as invocation conditions, such as the condition that the participating character is leading or the condition that the participating character is located forward or backward among all the participating characters. It is possible to invoke these skills only in the case where the participating character is located at a position matching the invocation condition.

Meanwhile, for example, skills for which one of the strategies “early speed”, “front running”, “stretch running”, and “closing” is set as an invocation condition can be invoked only in the case where the strategy matching the invocation condition is adopted. Note that a skill for which the strategy “early speed” is set as an invocation condition can be invoked in the case where the strategy “early speed” or “super early speed” is adopted. In other words, even in the case where the strategy is set to “super early speed”, as far as skill invocation is concerned, the skill can be invoked with the same invocation condition as in the case where the strategy “early speed” is adopted. That is, in the case where a strategy that belongs to a sub-attribute is set, it becomes possible to invoke the same skill as in the case where a strategy that belongs to a main attribute associated with the sub-attribute is set.

Meanwhile, for example, skills for which whether or not the participating character matches the race, e.g., the distance of the race in which the participating character participates, such as short distance or long distance, as well as the race track, is set as an invocation condition can be invoked only in races matching the invocation condition set for each skill.

Note that each skill has set therefor phases in which the skill can be invoked, and it is determined that the invocation condition is satisfied in the case where the current phase is a phase in which the skill can be invoked. Furthermore, for some skills, winning a lottery for determining whether or not to invoke (invocation lottery) is set as an invocation condition. Note that the probability of winning an invocation lottery becomes higher as the value of “wisdom” of the participating character becomes greater. As described above, one or more invocation conditions are set for each skill. In S103-2, it is determined whether or not all the invocation conditions set for each skill are satisfied, and YES is determined in the case where all the invocation conditions are satisfied.

When all the invocation conditions are satisfied (YES in S103-2), the nurturing-game execution unit 1101a sets invocation information for the skill determined to be invoked (S103-3). Then, in the case where there are skills for which it has not been determined whether or not the invocation conditions are satisfied (YES in S103-4), the nurturing-game execution unit 1101a repeats processing from S103-2 for all the skills for which determination is to be performed.

Note that although it is assumed here that invocation conditions are set for all skills, skills that do not have invocation conditions set therefor and that are necessarily invoked in prescribed phases in a race may be provided.

Referring back to FIG. 50, when the skill invocation process (S103) has been executed, the nurturing-game execution unit 1101a determines the speed, endurance, position, etc. in the phase for every participating character on the basis of prescribed formulas (S101-5). The nurturing-game execution unit 1101a repeats processing from S101-3 unless the current processing-subject phase No. is phase max set in S101-1 (NO in S101-6). Thus, the speed, endurance, position, whether or not to invoke each skill, etc. for each participating character is determined on a per-phase basis from start to goal. Then, if the current processing-subject phase No. is phase max (YES in S101-6), the nurturing-game execution unit 1101a derives all the information derived for the individual phases as race result information (S101-7).

Note that the simulation execution process described above is also applied to races in which nurtured characters participate, such as team competition races, without limitation to individual races.

Referring back to FIG. 48, upon the completion of the individual-race execution process, the nurturing-game execution unit 1101a executes a reward granting process for granting rewards to the player on the basis of the race result information of the individual race (S200).

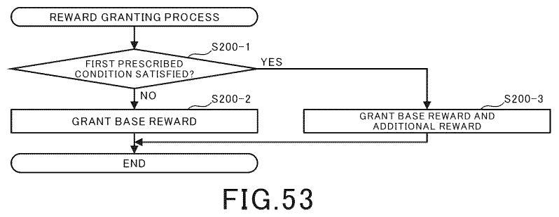

FIG. 53 is a flowchart for explaining the reward granting process at the server 1000. As shown in FIG. 53, the nurturing-game execution unit 1101a determines whether a first prescribed condition is satisfied in the individual race in which the main character has participated (S200-1). In the case where the first prescribed condition is not satisfied (NO in S200-1), the nurturing-game execution unit 1101a grants a base reward to the player (S200-2). The base reward is a reward that the player can obtain regardless of a victory or a defeat against the rival character.

Meanwhile, in the case where the first prescribed condition is satisfied (YES in S200-1), the nurturing-game execution unit 1101a grants an additional reward in addition to the base reward to the player (S200-3). That is, in the case where an individual race in which the first prescribed condition is satisfied has been executed, an additional reward is granted to the player on the basis of the game result of the individual race. The additional reward is a reward that can be acquired when the main character has participated in an individual race in which the main character competes with a rival character for victory or defeat. Note that an event such as a second event may occur as an additional reward irrespective of whether or not an item is granted.

Referring back to FIG. 48, in the case where the individual-race operating part 219 is not selected (NO in S20-2), the nurturing-game execution unit 1101a determines whether or not the command of the training operating part 216 is selected by the player (S20-3). In the case where the command of the training operating part 216 is selected (YES in S20-3), the nurturing-game execution unit 1101a performs training execution processing (S20-4).

Specifically, the nurturing-game execution unit 1101a determines whether or not one of the speed operating part 241, the stamina operating part 242, the power operating part 243, the spirit operating part 244, and the wisdom operating part 245 is selected. The nurturing-game execution unit 1101a determines whether or not training is successful for the selected training item. In the case where training is successful, for example, the nurturing-game execution unit 1101a performs processing for increasing the value of an ability parameter of the main character in accordance with the training item.

More specifically, in the case where training is successful, the nurturing-game execution unit 1101a executes processing for increasing the value of an ability parameter of the main character on the basis of the support card associated with the training item selected by the player, as well as whether or not a support event has been assigned. Meanwhile, in the case where training fails, for example, the nurturing-game execution unit 1101a performs processing for decreasing the value of an ability parameter of the main character in accordance with the training item. As described above, the nurturing-game execution unit 1101a changes a parameter of the main character in accordance with the training item and the determination as to whether the training item is successful.

Meanwhile, in the case where the training operating part 216 is not selected (NO in S20-3), the nurturing-game execution unit 1101a determines whether a command for using the character reassignment item is selected (S20-5). Here, the nurturing-game execution unit 1101a performs a second-prescribed-condition determination processing for determining whether or not the character reassignment item is used. The nurturing-game execution unit 701a determines that the second prescribed condition is satisfied in the case where it is determined that the character reassignment item is used, while determining that the second prescribed condition is not satisfied in the case where it is determined that the character reassignment item is not used.

In the case where a command for using the character reassignment item is selected (YES in S20-5), the nurturing-game execution unit 1101a performs re-lottery processing (S20-6). Specifically, in the case where the character reassignment item is used, the nurturing-game execution unit 1101a executes processing for performing a re-lottery for the association between support cards and training items, while maintaining whether or not to assign second events to the support cards.

Specifically, when the character reassignment item is used, one random number is obtained through a re-lottery, and the assignment of individual support characters to individual training items is re-determined on the basis of the random number obtained through the re-lottery and the assign/do-not-assign table shown in FIG. 27. At this time, a re-lottery for a random number is performed again in the case where how the support characters are assigned to the training items after the re-lottery is the same as how the support characters are assigned to the training items before the re-lottery (i.e., the assignment determined through the support-character lottery processing (S10-4)).

Then, the assignment of the individual support characters to the individual training items is re-determined on the basis of the random number obtained through the re-lottery and the assign/do-not-assign table shown in FIG. 27. This processing is repeated until the assignment of the support characters to the training items after the re-lottery becomes different from the assignment of the support characters to the training items before the re-lottery. Furthermore, when the character reassignment item is used, whether or not a second event is to occur is determined through a re-lottery on the basis of the random number selected through a lottery in the processing for determining whether or not a second event is to occur (S10-6), as well as the second event table. Here, since a re-lottery is performed by using the same random number used in the processing for determining whether or not a second event is to occur (S10-6), as well as the same second event table, the second event determined as a result of a re-lottery after the character reassignment item is used is the same as the second event determined to occur in the processing for determining whether or not a second event is to occur (S10-6).

Note that in the case where a command other than the individual-race operating part 219, the training operating part 216, or the command for using the character reassignment item is selected (NO in S20-5), although not described in detail, various kinds of processing corresponding to individual commands are executed.

Then, the nurturing-game execution unit 1101a saves game information in the game-information storage unit 1151 so that the player terminal 1 can receive the game information, the game information including information concerning the race result of the individual-race execution process executed in S100, information concerning the reward results of the reward granting process executed in S200, information concerning the result of training executed in S20-4, information concerning the result of the second-prescribed-condition determination processing executed in S20-5, and information concerning the re-lottery result of the re-lottery processing executed in S20-6 (S20-7).

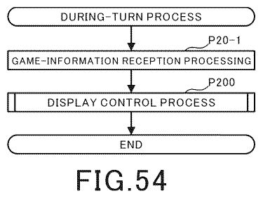

FIG. 54 is a flowchart for explaining the during-turn process at the player terminal 1. As shown in FIG. 54, first the nurturing-game execution unit 701a accesses the game-information storage unit 1151 of the server 1000 to receive game information from the server 1000, the game information including the race result, the reward result, the training result, the result of determination for the second prescribed condition, the result of re-lottery, etc. (P20-1).

Upon receiving the game information, the nurturing-game execution unit 701a executes a display control process (P200).

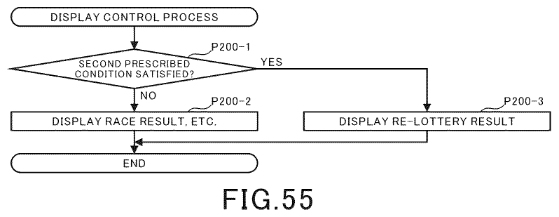

FIG. 55 is a flowchart for explaining the display control process at the player terminal 1. As shown in FIG. 55, the nurturing-game execution unit 701a determines whether or not the second prescribed condition is satisfied (P200-1). In the case where the second prescribed condition is not satisfied (NO in P200-1), the nurturing-game execution unit 701a displays the race result, the reward results, the training result, etc. on the display 26 on the basis of the results of various kinds of processing, including the individual-race execution process in S100, the training execution processing in S20-4, etc. executed at the server 1000 (P200-2).

In the case where an individual race has been executed, there are cases where the nurturing-game execution unit 701a plays a race video on the basis of an operation performed by the player. In the individual-race execution process (S100) at the server 1000, change information is set in the case where the strategy has been changed from “early speed” to “super early speed” (S100-9).

Upon the player terminal 1 receiving the abovementioned change information together with race result information from the server 1000, the nurturing-game execution unit 701a plays a race video and a live commentary on the basis of the change information. Specifically, in the case where change information has been received, the nurturing-game execution unit 701a indicates that the skill “super early speed” has been invoked. Furthermore, while the race video is being played, the nurturing-game execution unit 701a displays actions of the participating character performing “super early speed” and displays a message that the participating character is performing “super early speed”. Furthermore, while the race video is being played, the nurturing-game execution unit 701a reports that the participating character is performing “super early speed” by outputting the live commentary in the form of voice. Furthermore, the nurturing-game execution unit 701a displays text data associated with the skill “super early speed” in live-commentary text data generated on the basis of the game result.

Meanwhile, in the case where the second prescribed condition is satisfied (YES in P200-1), the nurturing-game execution unit 701a displays the result of re-lottery on the display 26 on the basis of the lottery result of the re-lottery processing in S20-6 executed at the server 1000 (P200-3). Specifically, the nurturing-game execution unit 701a displays, on the display 26, the support cards associated with the individual training items, as well as information concerning whether or not support events associated with the support cards are to occur.

Referring back to FIG. 42, when the nurturing stage process described above is finished, at the server 1000, the nurturing-game completion processing unit 1102a executes nurturing-game completion processing (S8). In the nurturing-game completion processing, the nurturing-game execution unit 1101a determines factors to be acquired by the nurtured character through lotteries. Then, the nurturing-game execution unit 1101a stores factor information in association with information concerning the nurtured character nurtured in the nurturing game in the game-information storage unit 1151. Here, in the case where the main character acquires a special skill in the nurturing game, specific information indicating the special skill is stored in association with the nurtured character.

Furthermore, the nurturing-game completion processing unit 1102a causes the player terminal 1 to receive the information concerning the nurtured character, stored in the game-information storage unit 1151. Furthermore, at the player terminal 1, the nurturing-game execution unit 701a executes nurturing-game completion processing (P8). In the nurturing-game completion processing, the nurturing-game execution unit 701a stores the information concerning the nurtured character nurtured in the nurturing game in the game-information storage unit 751.

The nurturing game described above is realized through the processes described above. Note that the above-described processes at the player terminal 1 and the server 1000 are merely examples. Furthermore, the individual processes described above may be executed only at the player terminal 1 or only at the server 1000.

Although an aspect of an embodiment has been described above with reference to the accompanying drawings, it goes without saying that the present invention is not limited to the embodiment described above. It would be obvious that a person skilled in the art could conceive of various kinds of modifications or improvements within the scope recited in the claims, and it would be understood that those modifications and improvements obviously fall within the technical scope of the present invention.

The above-described embodiment has been described in the context of the case where the strategy “super early speed” is associated as a sub-attribute strategy with the strategy “early speed” among the main-attribute strategies. That is, the embodiment has been described in the context of the case where a main-attribute strategy and a sub-attribute strategy correspond to each other one by one. Alternatively, a plurality of sub-attribute strategies may be associated with one main-attribute strategy. Furthermore, individually different sub-attribute strategies may be associated with a plurality of main-attribute strategies.

The essence of the game as well as the processes at the player terminal 1 and the server 1000 described in the context of the above embodiment are merely examples. In any case, it suffices for an information processing program to cause a computer (one of the player terminal 1 and the server 1000 or both in the embodiment) to carry out the following processing.

### (Processing to be Carried Out by a Computer)

Processing for determining whether or not a preset specific condition (e.g., the condition that a participating character possesses a special skill and that the strategy “early speed” is selected in the embodiment) is satisfied in a prescribed game (e.g., an individual race or a team competition race in the embodiment) (e.g., S100-4 to S100-6 in the embodiment).

Processing for setting a first action parameter (e.g., the strategy “early speed” in the embodiment) for a character (e.g., the main character or a nurtured character in the embodiment) among action parameters (e.g., “strategies” in the embodiment) in the case where the specific condition is not satisfied, the action parameters serving as parameters for determining autonomous operation of the character, and for setting a second action parameter (e.g., the strategy “super early speed” in the embodiment) associated with the first action parameter for the character in the case where the specific condition is satisfied (e.g., S100-1 and S100-7 in the embodiment).

Processing for controlling the operation of the character in the prescribed game on the basis of the action parameter set for the character (e.g., the simulation execution process in S101 in the embodiment).

Furthermore, the following processing may be carried out in addition to the above processing.

The character has set therefor a special operation pattern (e.g., a skill in the embodiment) that can be invoked in the prescribed game.

In the processing for controlling the operation of the character, the special operation pattern set for the character is invoked in the case where an invocation condition is satisfied (e.g., the skill invocation process in S103 in the embodiment).

Processing for making it possible to identify the set second action pattern in the prescribed game in the case where the second action parameter is set for the character (e.g., P200-2 in the embodiment).

Processing for displaying selecting parts individually corresponding to a plurality of first action parameters so as to allow a player to select one of the selecting parts (e.g., the turn start process in P10 in the embodiment).

Processing for setting the action parameter for the character includes processing for setting, for the character, the first action parameter corresponding to the selecting part selected by the player (e.g., S100-1 in the embodiment).

In the processing for allowing the player to select the selecting parts, the selecting part corresponding to the first action parameter is changed to the selecting part corresponding to the second action parameter in the case where the specific condition is satisfied (FIG. 39B).

Processing for executing a nurturing game of nurturing a nurturing subject character (e.g., the main character in the embodiment) while changing an ability parameter of the nurturing subject character on the basis of an operation by a player (e.g., the nurturing stage processes in P7 and S7 in the embodiment).

Processing for storing the nurturing subject character that has been nurtured in the nurturing game as a nurturing-complete character (e.g., a nurtured character in the embodiment) (e.g., the nurturing-game completion processing in S8 in the embodiment).

The processing for storing the nurturing-complete character includes processing for associating specific information (e.g., information indicating the acquisition of a special skill in the embodiment) with the nurturing-complete character in the case where a prescribed acquisition condition (e.g., a possessed special skill is acquired by consuming skill points in the embodiment) is satisfied in the nurturing game.

In the processing for determining whether or not the specific condition is satisfied, it is determined that the specific condition is satisfied in the case where the specific information is associated with the nurturing-complete character.

The processing for storing the nurturing-complete character includes processing for associating factor information with the nurturing-complete character, the factor information being different from the specific information (e.g., the nurturing-game completion processing in P8 and S8 in the embodiment).

The processing for executing the nurturing game includes processing for setting the nurturing-complete character as a character to inherit (e.g., the preparation stage processes in P6 and S6 in the embodiment).

Processing for changing the ability parameter of the nurturing subject character in the nurturing game on the basis of the factor information associated with the character to inherit (e.g., S10-8 in the embodiment).

Note that information processing programs for executing the processes in the embodiment described above and the various kinds of modifications may be stored in a computer-readable, non-transitory storage medium and may be provided in the form of the storage medium. Furthermore, a game terminal device including the storage medium may be provided. Alternatively, the embodiment described above and the various kinds of modifications may be embodied in the form of an information processing method for realizing the individual functions and the steps shown in the flowcharts.

What is claimed is:

1. A non-transitory computer readable medium storing a program causing a computer to execute:
processing for determining whether or not a preset specific condition is satisfied in a prescribed game;
processing for setting an action parameter for a character among a plurality of action parameters, each of the plurality of action parameters serving as a parameter for determining autonomous operation of the character, a first action parameter being set for the character among the plurality of action parameters in the case where the specific condition is not satisfied, and a second action parameter associated with the first action parameter being set for the character among the plurality of action parameters in the case where the specific condition is satisfied; and
processing for controlling the operation of the character in the prescribed game on the basis of the action parameter set for the character.

2. The non-transitory computer readable medium according to claim 1, wherein:
the second action parameter is managed in association with the first action parameter.

3. The non-transitory computer readable medium according to claim 1, wherein:
a special operation pattern that can be invoked in the prescribed game is set for the character; and
in the processing for controlling the operation of the character,
the special operation pattern set for the character is invoked in the case where an invocation condition is satisfied, and
the special operation pattern can be used both in the case where the second action parameter is set for the character, and in the case where the first action parameter is set for the character.

4. The non-transitory computer readable medium according to claim 1, wherein the program further causes the computer to execute:
processing for making it possible to identify the set second action pattern in the prescribed game in the case where the second action parameter is set for the character.

5. The non-transitory computer readable medium according to claim 1, wherein:
the program further causes the computer to execute
processing for displaying a plurality of selecting parts each of which corresponding to one of the plurality of action parameters including the first action parameter, so that a player can select one of the plurality of selecting parts;
the processing for setting the action parameter for the character includes
processing for setting, for the character, a action parameter corresponding to a selecting part selected by the player among the plurality of selecting parts; and
in the processing for displaying the plurality of selecting parts,
a selecting part corresponding to the first action parameter is changed to a selecting part corresponding to the second action parameter in the case where the specific condition is satisfied.

6. The non-transitory computer readable medium according to claim 1, wherein:
the program further causes the computer to execute
processing for executing a nurturing game of nurturing a nurturing subject character while changing an ability parameter of the nurturing subject character on the basis of an operation by a player, and
processing for storing the nurturing subject character that has been nurtured in the nurturing game as a nurturing-complete character;
the processing for storing the nurturing-complete character includes processing for associating specific information with the nurturing-complete character in the case where a prescribed acquisition condition is satisfied in the nurturing game;
the character that operates in the prescribed game includes the nurturing-complete character; and
in the processing for determining whether or not the specific condition is satisfied,
it is determined that the specific condition is satisfied in the case where the specific information is associated with the nurturing-complete character.

7. The non-transitory computer readable medium according to claim 6, wherein:
the processing for storing the nurturing-complete character includes
processing for associating factor information with the nurturing-complete character, the factor information being different from the specific information; and
the processing for executing the nurturing game includes
processing for setting the nurturing-complete character as a character to inherit, and
processing for changing the ability parameter of the nurturing subject character in the nurturing game on the basis of the factor information associated with the character to inherit.

8. An information processing method that is executed by at least one computer,
wherein the at least one computer execute:
processing for determining whether or not a preset specific condition is satisfied in a prescribed game;
processing for setting an action parameter for a character among a plurality of action parameters, each of the plurality of action parameters serving as a parameter for determining autonomous operation of the character, a first action parameter being set for the character among the plurality of action parameters in the case where the specific condition is not satisfied, and a second action parameter associated with the first action parameter being set for the character among the plurality of action parameters in the case where the specific condition is satisfied; and
processing for controlling the operation of the character in the prescribed game on the basis of the action parameter set for the character.

9. A game device wherein at least one computer executes:
processing for determining whether or not a preset specific condition is satisfied in a prescribed game;
processing for setting an action parameter for a character among a plurality of action parameters, each of the plurality of action parameters serving as a parameter for determining autonomous operation of the character, a first action parameter being set for the character among the plurality of action parameters in the case where the specific condition is not satisfied, and a second action parameter associated with the first action parameter being set for the character among the plurality of action parameters in the case where the specific condition is satisfied; and
processing for controlling the operation of the character in the prescribed game on the basis of the action parameter set for the character.

10. An information processing system wherein at least one computer execute:
processing for determining whether or not a preset specific condition is satisfied in a prescribed game;
processing for setting an action parameter for a character among a plurality of action parameters, each of the plurality of action parameters serving as a parameter for determining autonomous operation of the character, a first action parameter being set for the character among the plurality of action parameters in the case where the specific condition is not satisfied, and a second action parameter associated with the first action parameter being set for the character among the plurality of action parameters in the case where the specific condition is satisfied; and
processing for controlling the operation of the character in the prescribed game on the basis of the action parameter set for the character.
